(19) United States
(12) Patent Application Publication
(10) Pub. No.: US 2024/0267820 A1
(43) Pub. Date: Aug. 8, 2024

(54) Early Channel State Information Reporting

(71) Applicant: Comcast Cable Communications, LLC, Philadelphia, PA (US)

(72) Inventors: Hua Zhou, Vienna, VA (US); Ali Cagatay Cirik, Chantilly, VA (US); Esmael Hejazi Dinan, McLean, VA (US); Taehun Kim, Fairfax, VA (US); Hyoungsuk Jeon, Centreville, VA (US)

(21) Appl. No.: 18/436,397

(22) Filed: Feb. 8, 2024

Related U.S. Application Data
(60) Provisional application No. 63/444,047, filed on Feb. 8, 2023.

(51) Int. Cl. H04W 36/30; H04W 36/00; H04W 36/08

(52) U.S. Cl. CPC H04W 36/302; H04W 36/0085; H04W 36/08

(57) ABSTRACT

A wireless device may perform a handover from one cell to another. The wireless device may perform channel state information measurement and/or reporting for one or more candidate cells. Reference signal configuration information indicating synchronization signal blocks associated with candidate cells, for example, for a reference signal received power measurement, may be received by the wireless device. A reference signal received power report may be transmitted by the wireless device, and based on the reference signal received power measurement, the wireless device may switch to a candidate cell as the primary cell.

### CROSS-REFERENCE TO RELATED APPLICATIONS

This application claims the benefit of U.S. Provisional Application No. 63/444,047 filed on Feb. 8, 2023. The above referenced application is hereby incorporated by reference in its entirety.

### BACKGROUND

Wireless devices communicate with a base station via cells. The wireless devices switch between different serving cells for the communications.

### SUMMARY

The following summary presents a simplified summary of certain features. The summary is not an extensive overview and is not intended to identify key or critical elements.

A wireless device may perform a handover from one cell to another. The wireless device may perform channel state information (e.g., early channel state information) measurement and/or reporting for one or more candidate cells prior to switching to a candidate cell. Instead of configuring each candidate cell with a (potentially) different reference signal configuration, reference signal resource configuration(s) may be jointly configured and may be separated from serving cell and/or candidate cell configuration(s). The reference signal resource configurations may comprise a plurality of portions (e.g., synchronization signal blocks), each of which may be associated with an index, a cell indication of a candidate cell, and/or one or more time and/or frequency resources.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein.

FIG. 16A, FIG. 16B, FIG. 16C, and FIG. 16D show examples of uplink and downlink signal transmission.

FIG. 17A, FIG. 17B, and FIG. 17C show example MAC subheaders.

FIG. 18A and FIG. 18B show example MAC PDUs.

FIG. 19 shows example logical channel identifier (LCID) values.

FIG. 20 shows example LCID values.

FIG. 21A and FIG. 21B show example secondary cell (SCell) Activation/Deactivation MAC control elements (CEs).

FIG. 22 shows an example of BWP activation/deactivation.

FIG. 23 shows examples of various downlink control information (DCI) formats.

FIG. 24A shows an example master information block (MIB) message.

FIG. 24B shows an example configuration of a CORESET.

FIG. 24C shows an example of configuration of a search space.

FIG. 25 shows an example of a system information block (SIB).

FIG. 26 shows example RRC configuration parameters.

FIG. 27 shows an example configuration of a search space.

FIG. 28 shows an example of synchronization signal block (SSB) configurations.

FIG. 29 shows an example of SSB transmissions of a base station.

FIG. 30 shows an example of SSB transmissions of a base station.

FIG. 31A and FIG. 31B show examples of multiple transmission and reception point (TRP) configurations.

FIG. 32 shows an example of layer 3 based handover procedure.

FIG. 33 shows an example of a radio resource control (RRC) message for layer 3 based handover.

FIG. 34 shows an example of an RRC message for layer 3 based handover.

FIG. 35 shows an example of layer 3 based conditional handover procedure.

FIG. 36 shows an example of an RRC message for layer based conditional handover procedure.

FIG. 37 shows an example of layer 1 or layer 2 based handover.

FIG. 38 shows an example of inter-cell beam management.

FIG. 39 shows an example of a layer 1 or layer 2 triggered mobility with early CSI reporting.

FIG. 40 shows an example RRC message for CSI reporting.

FIG. 41 shows an example RRC message for CSI reporting.

FIG. 42 shows an example RRC message for CSI reporting.

FIG. 43 shows an example of early CSI reporting with a measurement gap.

FIG. 44 shows an example of an initial LTM procedure and a subsequent LTM procedure.

FIG. 45 shows an example of early CSI reporting with a measurement gap.

FIG. 46 shows an example of dynamic indication of a measurement gap for early CSI reporting.

FIG. 47A and FIG. 47B show examples of dynamic indication of a measurement gap for early CSI reporting.

FIG. 48A, FIG. 48B, and FIG. 48C show examples of CSI resource configurations for early CSI reporting.

FIG. 49A and FIG. 49B show examples of CSI resource configurations for early CSI reporting.

FIG. 50 shows an example of early CSI report for an LTM procedure.

FIG. 51 shows an example of CSI resource configuration for an LTM procedure.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems, which may be used in the technical field of multicarrier communication systems.

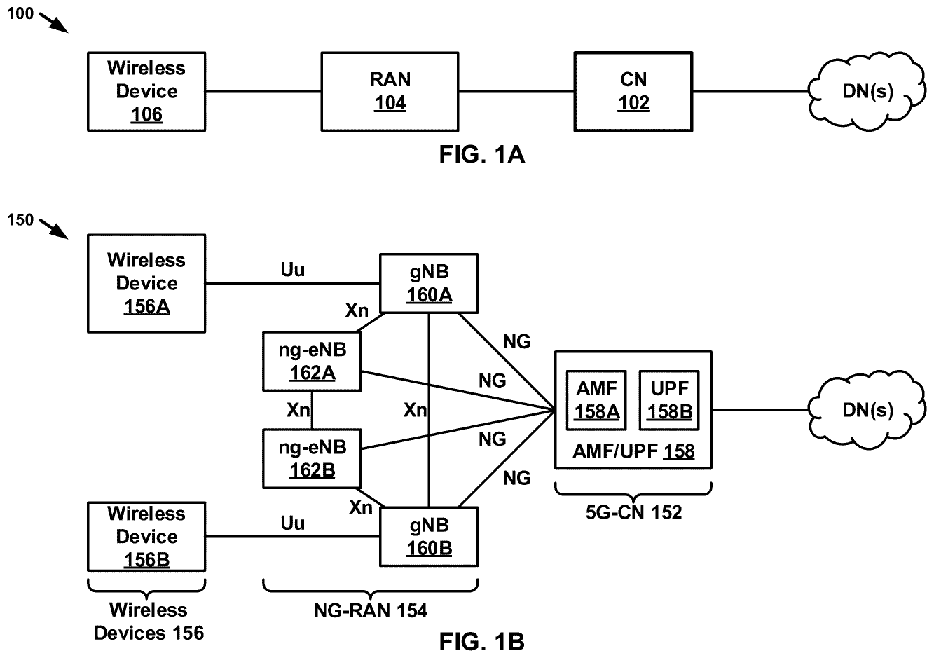

FIG. 1A shows an example communication network 100. The communication network 100 may comprise a mobile communication network. The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with the one or more DNs 108, such as public DNs (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over/via an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a Generation Node B (gNB), an Next Generation Evolved Node B (ng-eNB), a relay node (e.g., an integrated access and backhaul (IAB) node), a donor node (e.g., a donor eNB, a donor gNB, etc.), an access point (AP) (e.g., a Wi-Fi access point), a transmission and reception point (TRP), a computing device, a device capable of wirelessly communicating, or any other device capable of sending and/or receiving signals. A base station may comprise one or more of the elements listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an eNB (e.g., associated with Evolved-Universal Terrestrial Radio Access (E-UTRA) and/or fourth-generation (4G) standards), a remote radio head (RRH), a baseband processing unit coupled to one or more RRHs, a repeater node or relay node used to extend the coverage area of a donor node, a ng-eNB, a gNB (e.g., associated with New Radio (NR) and/or fifth-generation (5G) standards), an AP (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an AP, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to the one or more DNs 170. The wireless device(s) 156 may communicate with the one or more DNs 170, such as public DNs (e.g., the Internet), private DNs, and/or intra-operator DNs. As part of the interface functionality, the CN 152 (e.g., 5G-CN) may set up end-to-end connections between the wireless device(s) 156 and the one or more DNs 170, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G-CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between the RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QoS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs 170, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng-eNBs comprising an ng-eNB 162A and an ng-eNB 162B (collectively ng-eNBs 162)). The RAN 154 may comprise one or more of any quantity of types of base station. The gNBs 160 and/or ng-eNBs 162 may be referred to as base stations. The base stations (e.g., the gNBs 160 and/or ng-eNBs 162) may comprise one or more sets of antennas for communicating with the wireless device(s) 156 wirelessly (e.g., an over an air interface). One or more base stations (e.g., the gNBs 160 and/or the ng-eNBs 162) may comprise multiple sets of antennas to respectively control multiple cells (or sectors). The cells of the base stations (e.g., the gNBs 160 and/or the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G-CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide E-UTRA user plane and control plane protocol terminations towards the wireless device(s) 156 via a Uu interface (e.g., where E-UTRA may refer to the 3GPP 4G radio-access technology). A base station (e.g., the ng-eNB 162B) may provide E-UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, IoT devices, hotspots, cellular repeaters, computing devices, and/or, more generally, UE. Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a 6G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

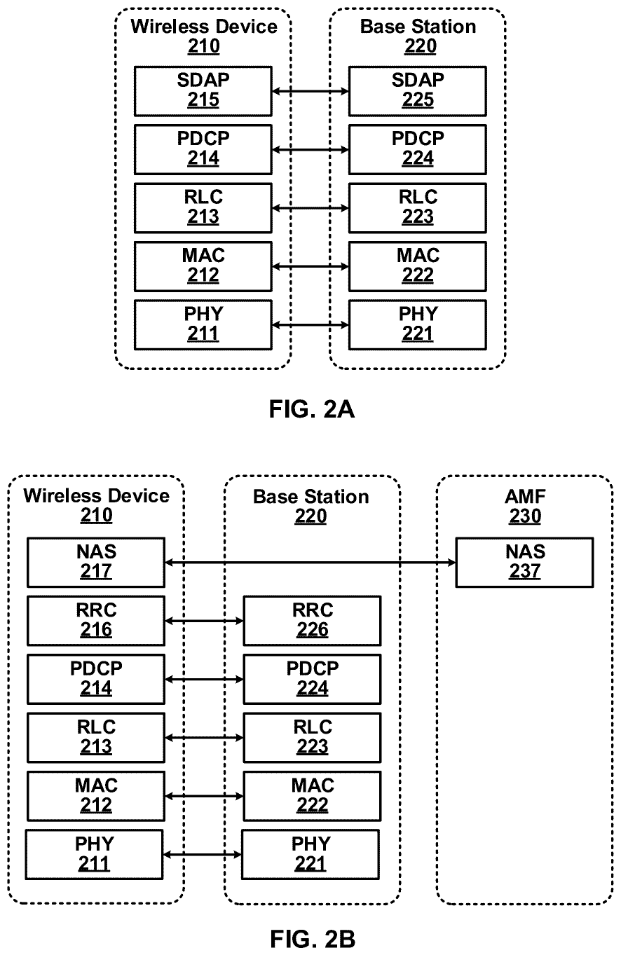

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configurations and/or the control plane configurations may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

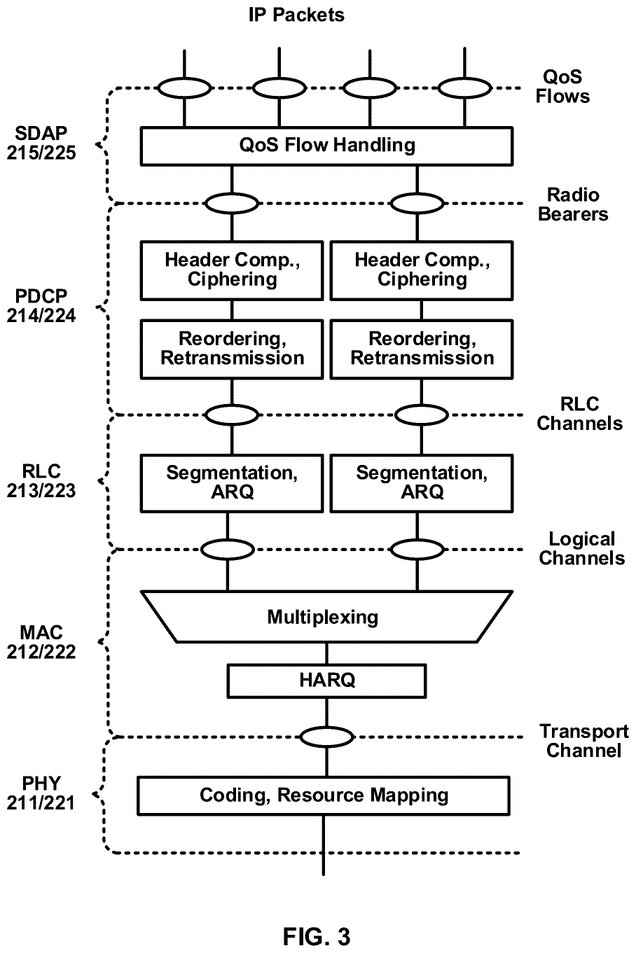

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform QoS flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows 310 of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers (e.g., RLCs 213 and 223) may perform one or more of the noted functions, for example, based on the transmission mode the RLC layer (e.g., RLCs 213 and 223) is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels 330 as a service to the PDCP layers (e.g., PDCPs 214 and 224, respectively), such as shown in FIG. 3.

The MAC layers (e.g., MACs 212 and 222) may perform multiplexing/demultiplexing of logical channels 340 and/or mapping between logical channels 340 and transport channels 350. The multiplexing/demultiplexing may comprise multiplexing/demultiplexing of data units/data portions, belonging to the one or more logical channels 340, into/from Transport Blocks (TBs) delivered to/from PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels 340 of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels 350 to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

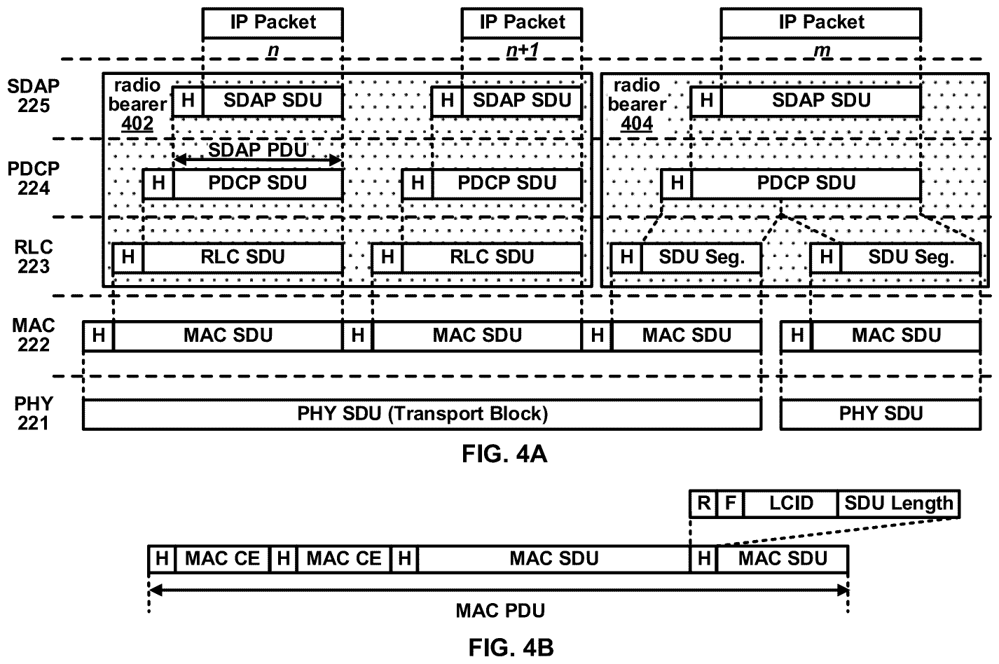

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 212 or MAC 222. As shown in FIG. 4B, two MAC CEs may be inserted into/added to the MAC PDU. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

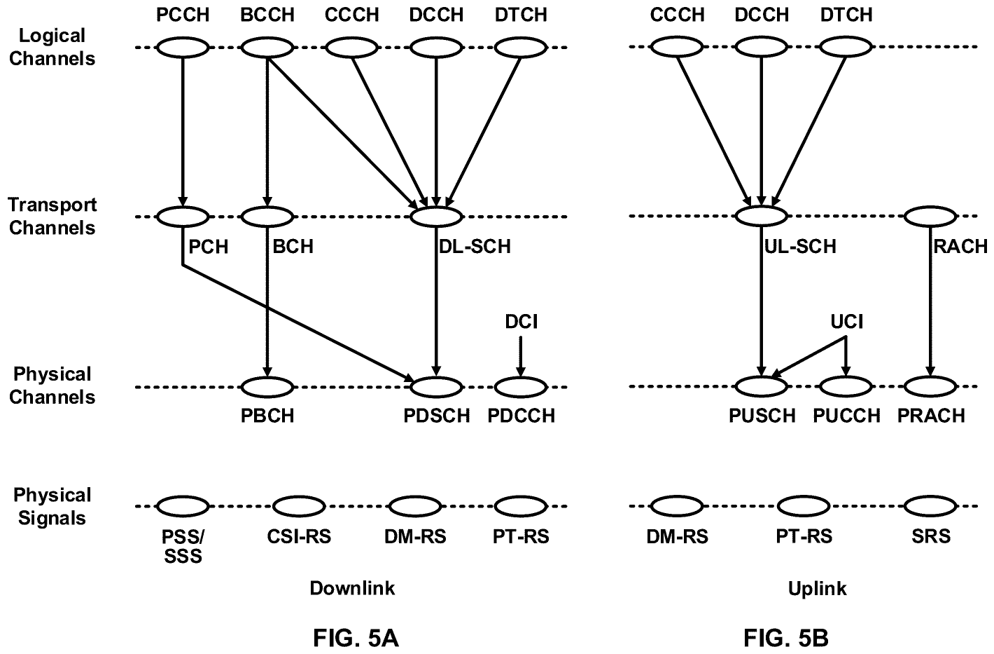

FIG. 5A shows an example mapping for downlink channels. The mapping for downlink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may comprise an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as layer 1 or layer 2 (e.g., L1 or L2, Layer 1/Layer 2, L1/L2, Layer 1 or layer 2, Layer 1 or Layer 2, L1/2, Layer 1/2, layer 1/2, etc.) control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The PHY layer may generate physical signals to support the low-level operation of the PHY layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), SRS, phase-tracking reference signals (PT RS), and/or any other signals.

One or more of the channels (e.g., logical channels, transport channels, physical channels, etc.) may be used to carry out functions associated with the control plane protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHYs 211 and 221, MACs 212 and 222, RLCs 213 and 223, and PDCPs 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane protocol stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and substantially the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting and control of the reporting; detection of and recovery from radio link failure (RLF); and/or NAS message transfer. As part of establishing an RRC connection, the RRC layers 216 and 226 may establish an RRC context, which may involve configuring parameters for communication between the wireless device 210 and the RAN (e.g., the base station 220).

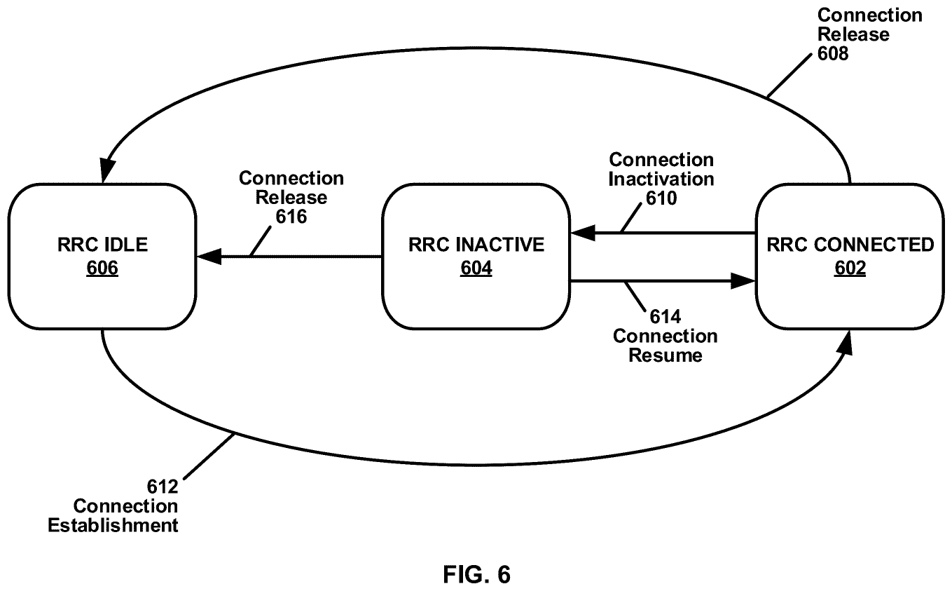

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104, the RAN 154, or any other RAN). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., the RRC connected 602) to an RRC idle state (e.g., the RRC idle 606) via a connection release procedure 608. The RRC state may transition from the RRC connected state (e.g., the RRC connected 602) to the RRC inactive state (e.g., the RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., once in every DRX cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be substantially the same as or similar to connection release procedure 608.

An RRC state may be associated with a mobility management mechanism. During the RRC idle state (e.g., the RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC inactive state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the wireless device registration area, for example, if the wireless device moves (e.g., via a cell reselection) to a cell associated with a TAI that may not be included in the list of TAIs associated with the wireless device registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., the RRC inactive 604).

A base station (e.g., the gNBs 160 in FIG. 1B or any other base station) may be split in two parts: a central unit (e.g., a base station central unit, such as a gNB-CU) and one or more distributed units (e.g., a base station distributed unit, such as a gNB-DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM may be a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbol streams may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

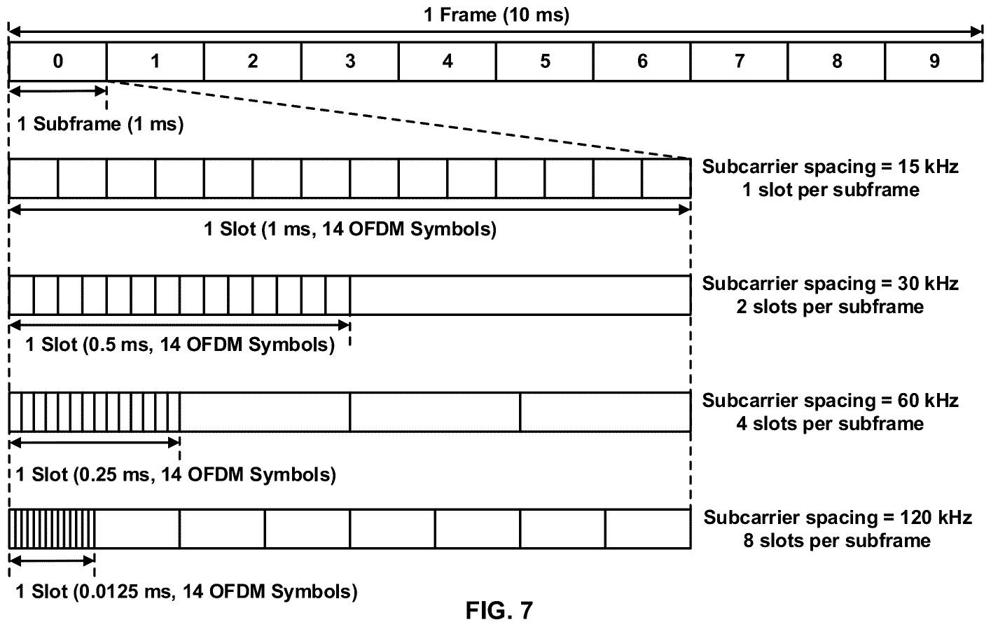

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR radio frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

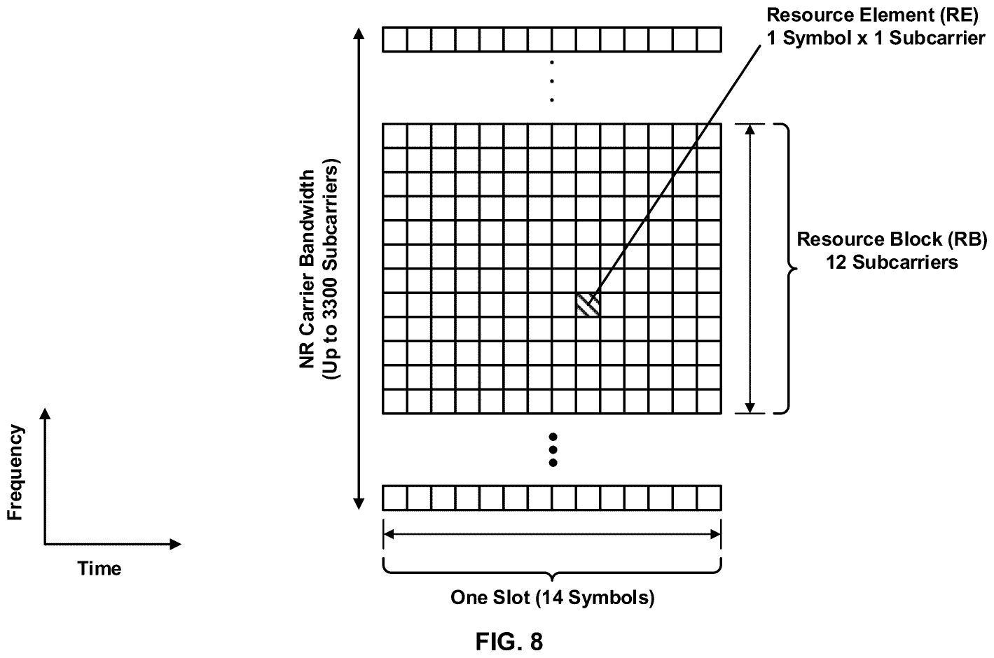

FIG. 8 shows an example resource configuration of one or more carriers. The resource configuration may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR carrier such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in DCI. A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

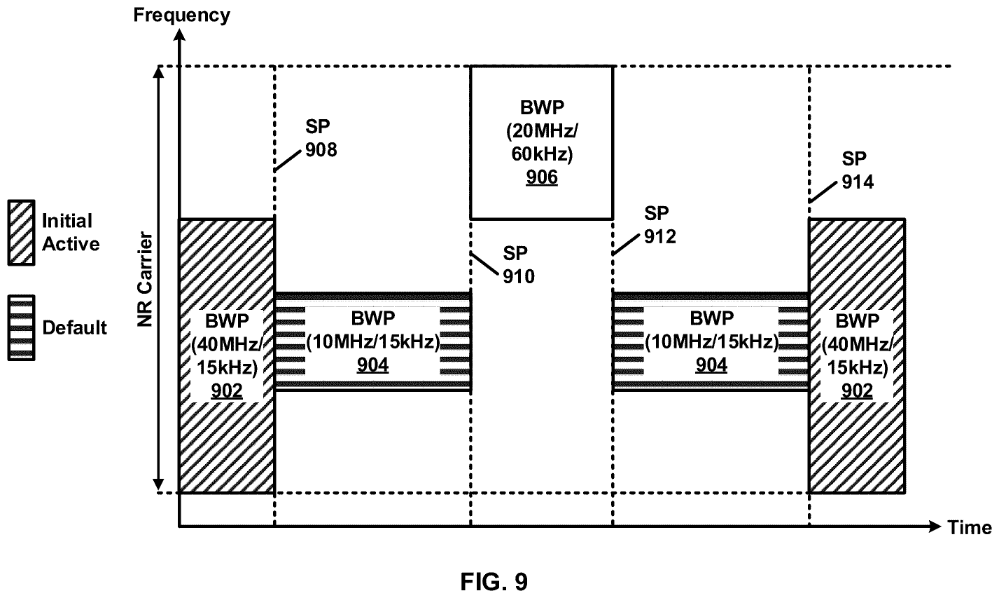

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at the switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating the BWP 904 as the active BWP. The wireless device may switch at a switching point 910 from the active BWP (e.g., the BWP 904) to the BWP 906, for example, after or in response receiving DCI indicating the BWP 906 as a new active BWP. The wireless device may switch at a switching point 912 from the active BWP (e.g., the BWP 906) to the BWP 904, for example, a based on (e.g., after or in response to) an expiry of a BWP inactivity timer. The wireless device may switch at the switching point 912 from the active BWP (e.g., the BWP 906) to the BWP 904, for example, after or in response to receiving DCI indicating the BWP 904 as a new active BWP. The wireless device may switch at a switching point 914 from the active BWP (e.g., the BWP 904) to the BWP 902, for example, after or in response receiving DCI indicating the BWP 902 as a new active BWP.

Wireless device procedures for switching BWPs on a secondary cell may be substantially the same/similar as those on a primary cell, for example, if the wireless device is configured for a secondary cell with a default downlink BWP in a set of configured downlink BWPs and a timer value. The wireless device may use the timer value and the default downlink BWP for the secondary cell in substantially the same/similar manner as the wireless device uses the timer value and/or default downlink BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

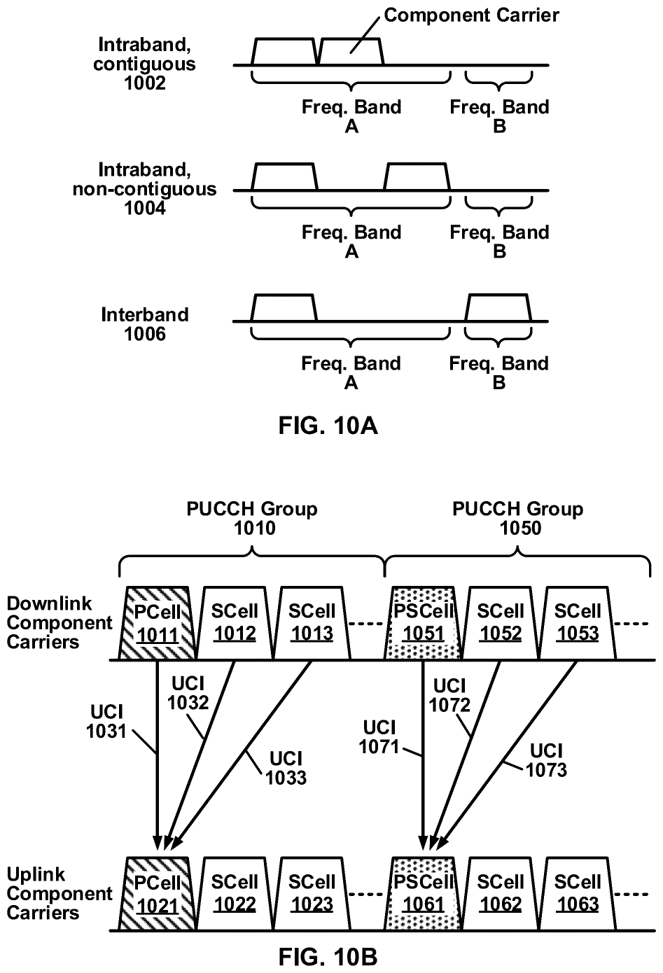

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless devices may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information for the downlink, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. UCI may comprise control information for the uplink, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may use/apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

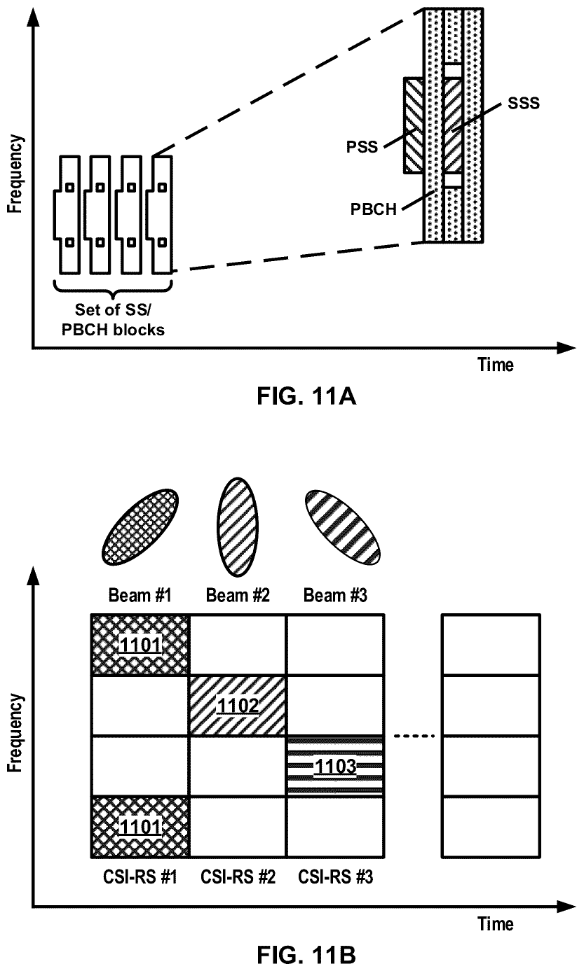

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial receiving (Rx) parameters). The wireless device may not assume QCL for SS/PBCH block transmissions having different SS/PBCH block indices. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine CSI. The base station may configure the wireless device with one or more CSI-RSs for channel estimation or any other suitable purpose. The base station may configure a wireless device with one or more of substantially the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports (or any other quantity of orthogonal downlink DM-RS ports) per wireless device (e.g., for single user-MIMO). A DM-RS configuration may support up to 4 orthogonal downlink DM-RS ports (or any other quantity of orthogonal downlink DM-RS ports) per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be substantially the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI.A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in a SRS resource set of the one or more SRS resource sets (e.g., with substantially the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as QCLed, for example, if one or more large-scale properties of the channel over which a first symbol on the first antenna port is conveyed may be inferred/determined from the channel over which a second symbol on a second antenna port is conveyed. The one or more large-scale properties may comprise at least one of: a delay spread; a Doppler spread; a Doppler shift; an average gain; an average delay; and/or spatial Rx parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a RB within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and RE locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, QCL parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams may be shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure a reference signal received power (RSRP) of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more SRS resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a PMI, a CQI, and/or a RI.

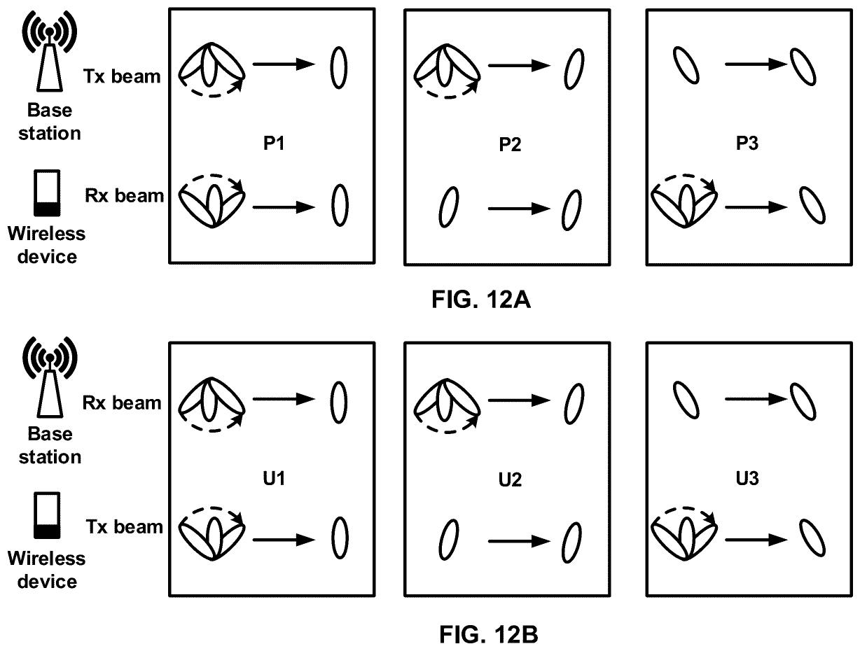

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the bottom row of U1 and top row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more RSs comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are substantially the same or similar as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more SIBs (e.g., or any other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

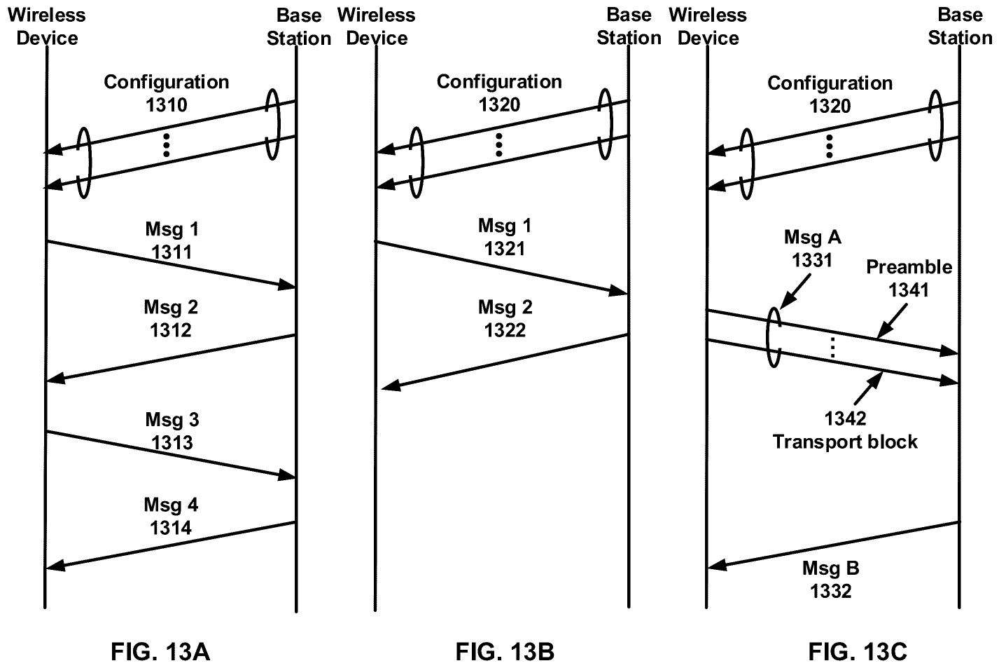

FIG. 13A shows an example four-step random access procedure. The four-step random access procedure may comprise a four-step contention-based random access procedure. A base station may send/transmit a configuration message 1310 to a wireless device, for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more RACH parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more PRACH occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate at least one of: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. RNTIs may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA ‐ RNTI = 1 + s\_id + 14 \times t\_id + 14 \times 80 \times f\_id + 14 \times 80 \times 8 \times ul\_carrier \_id ,$$

where s_id may be an index of a first OFDM symbol of the PRACH occasion (e.g., 0<s_id<14), t_id may be an index of a first slot of the PRACH occasion in a system frame (e.g., 0<t_id<80), f_id may be an index of the PRACH occasion in the frequency domain (e.g., 0<f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless device on the PDCCH (e.g., the base station may send the PDCCH to the wireless device) using a C-RNTI, for example, if the C-RNTI was included in the third message (e.g., Msg 3 1313). The random access procedure may be determined to be successfully completed, for example, if the unique C-RNTI of the wireless device is detected on the PDCCH (e.g., the PDCCH is scrambled by the C-RNTI). The fourth message (e.g., Msg 4 1314) may be received using a DL-SCH associated with a TC-RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., for the first message (e.g., Msg 1 1311) and/or the third message (e.g., Msg 3 1313)). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 11321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, based on (e.g., after or in response to) sending/transmitting first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

The first message (e.g., Msg A 1331) may be sent/transmitted in an uplink transmission by the wireless device. The first message (e.g., Msg A 1331) may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIG. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as layer 1 or layer 2 (e.g., L1 or L2, Layer 1/Layer 2, L1/L2, Layer 1 or layer 2, Layer 1 or Layer 2, L1/2, Layer 1/2, layer 1/2 etc.)) control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as DCI. The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 00 may be used for scheduling of a PUSCH in a cell. DCI format 00 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 11 may be used for scheduling of a PDSCH in a cell (e.g., with more DCI payloads than DCI format 1_0). DCI format 2_0 may be used for providing a slot format indication to a group of wireless devices. DCI format 21 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

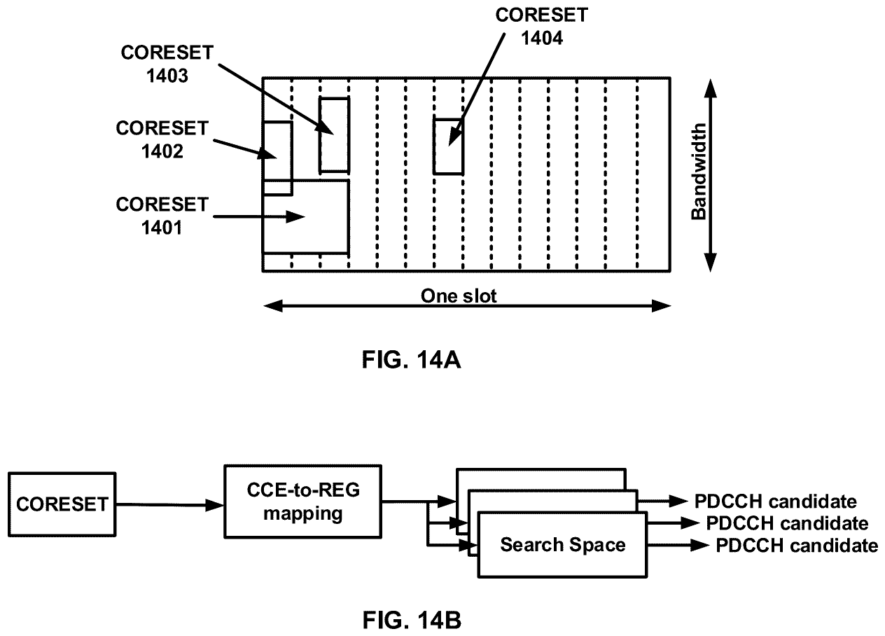

FIG. 14A shows an example of CORESET configurations. The CORESET configurations may be for a bandwidth part or any other frequency bands. The base station may send/transmit DCI via a PDCCH on one or more CORESETs. A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a quantity/number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the quantity/number of CCEs, the quantity/number of PDCCH candidates in common search spaces, and/or the quantity/number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The wireless device may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise SR. The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a quantity/number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a quantity/number of OFDM symbols (e.g., between four and fourteen OFDM symbols) and may comprise two or fewer bits. The wireless device may use PUCCH format 1, for example, if the transmission is over/via four or more symbols and the quantity/number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a quantity/number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a quantity/number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a quantity/number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from a PUCCH resource set for UCI (HARQ-ACK, CSI, and/or SR) transmission, for example, after determining the PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

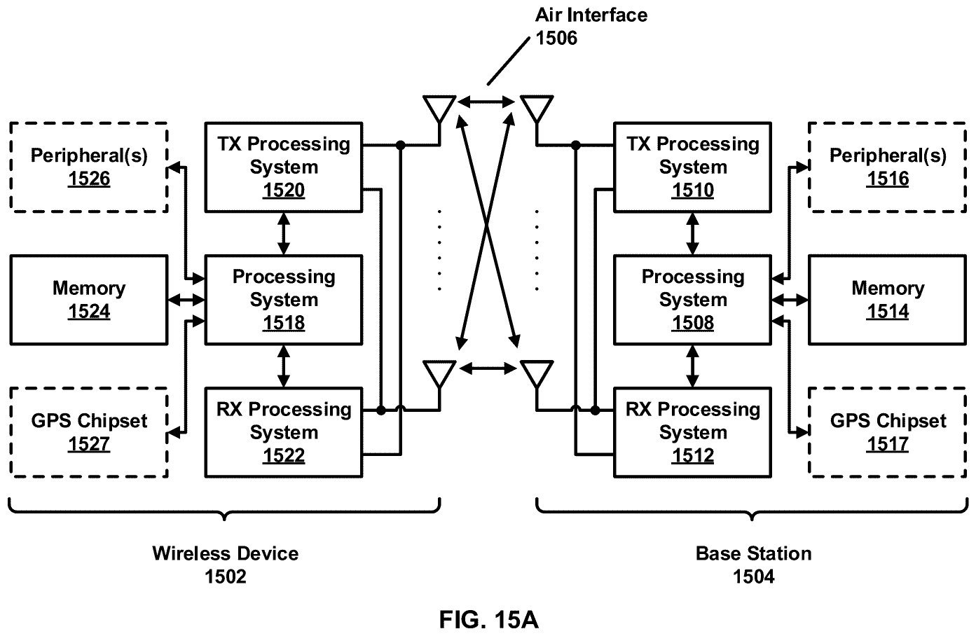

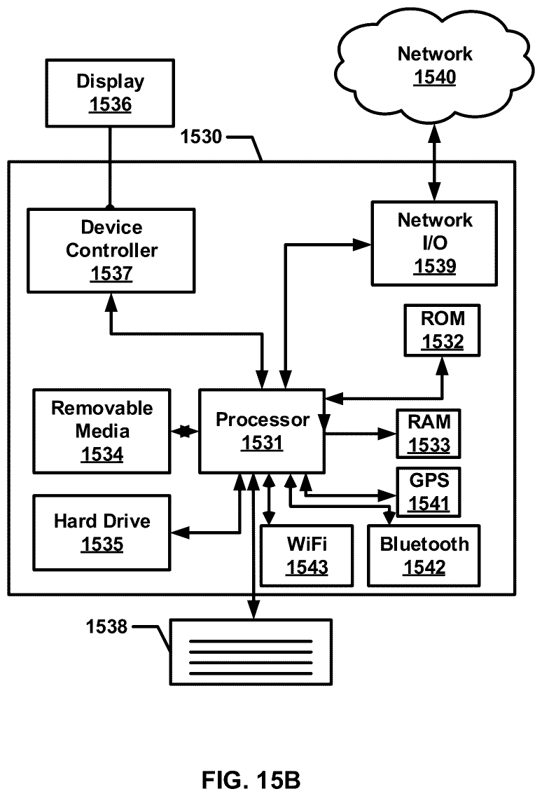

FIG. 15A shows an example of communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a USB drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a GPS microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

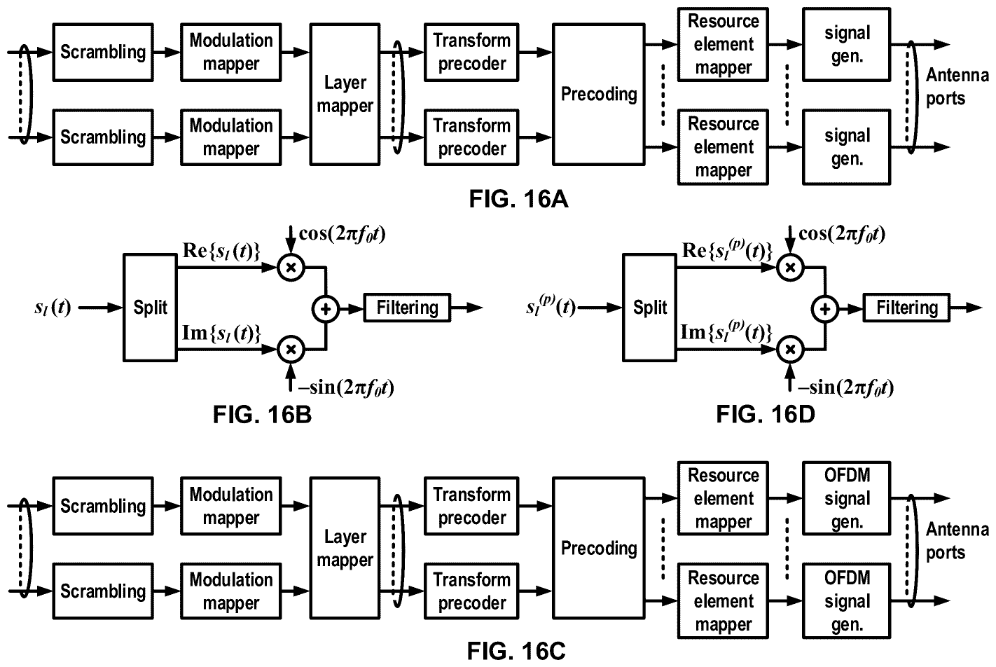

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, once it is started and continue running until it is stopped or until it expires. A timer may be started, for example, if it is not running or restarted if it is running. A timer may be associated with a value (e.g., the timer may be started or restarted from a value or may be started from zero and expire once it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

A base station may communicate with a wireless device via a wireless network (e.g., a communication network). The communications may use/employ one or more radio technologies (e.g., new radio technologies, legacy radio technologies, and/or a combination thereof). The one or more radio technologies may comprise at least one of: one or multiple technologies related to a physical layer; one or multiple technologies related to a medium access control layer; and/or one or multiple technologies related to a radio resource control layer. One or more enhanced radio technologies described herein may improve performance of a wireless network. System throughput, transmission efficiencies of a wireless network, and/or data rate of transmission may be improved, for example, based on one or more configurations described herein. Battery consumption of a wireless device may be reduced, for example, based on one or more configurations described herein. Latency of data transmission between a base station and a wireless device may be improved, for example, based on one or more configurations described herein. A network coverage of a wireless network may increase, for example, based on one or more configurations described herein.

A base station may send/transmit one or more MAC PDUs to a wireless device. A MAC PDU may be a bit string that is byte aligned (e.g., aligned to a multiple of eight bits) in length. Bit strings may be represented by one or more tables in which the most significant bit may be the leftmost bit of the first line of a table, and the least significant bit may be the rightmost bit on the last line of the table. The bit string may be read from left to right and then in the reading order of the lines (e.g., from the topmost line of the table to the bottommost line of the table). The bit order of a parameter field within a MAC PDU may be represented with the first and most significant bit in the leftmost bit and the last and least significant bit in the rightmost bit.

A MAC SDU may be a bit string that is byte aligned (e.g., aligned to a multiple of eight bits) in length. A MAC SDU may be comprised in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. A MAC subheader may be placed immediately in front of a corresponding MAC SDU, MAC CE, or padding. A wireless device (e.g., the MAC entity of the wireless device) may ignore a value of reserved bits in a downlink (DL) MAC PDU.

A MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, and/or a combination thereof. The MAC SDU may be of variable size. A MAC subheader may correspond to a MAC SDU, a MAC CE, or padding.

A MAC subheader may comprise: an R field with a one-bit length; an F field with a one-bit length; an LCID field with a multi-bit length; an L field with a multi-bit length; and/or a combination thereof, for example, if the MAC subheader corresponds to a MAC SDU, a variable-sized MAC CE, or padding.

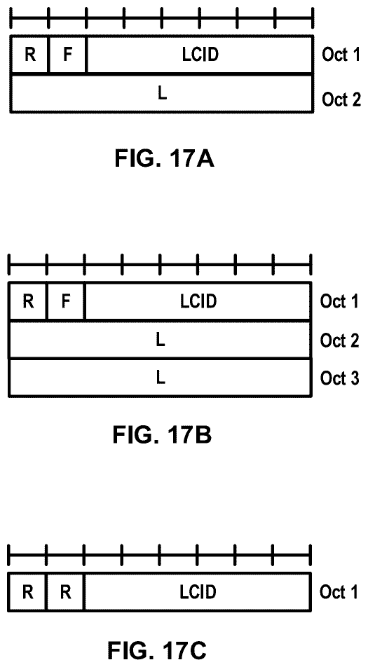

FIG. 17A shows an example of a MAC subheader. The MAC subheader may comprise an R field, an F field, an LCID field, and/or an L field. The LCID field may be six bits in length (or any other quantity of bits). The L field may be eight bits in length (or any other quantity of bits). Each of the R field and the F field may be one bit in length (or any other quantity of bits). FIG. 17B shows an example of a MAC subheader. The MAC subheader may comprise an R field, an F field, an LCID field, and/or an L field. Similar to the MAC subheader shown in FIG. 17A, the LCID field may be six bits in length (or any other quantity of bits), the R field may be one bit in length (or any other quantity of bits), and the F field may be one bit in length (or any other quantity of bits). The L field may be sixteen bits in length (or any other quantity of bits, such as greater than sixteen bits in length). A MAC subheader may comprise: an R field with a two-bit length (or any other quantity of bits) and/or an LCID field with a multi-bit length (or single bit length), for example, if the MAC subheader corresponds to a fixed sized MAC CE or padding. FIG. 17C shows an example of a MAC subheader. In the example MAC subheader shown in FIG. 17C, the LCID field may be six bits in length (or any other quantity of bits), and the R field may be two bits in length (or any other quantity of bits).

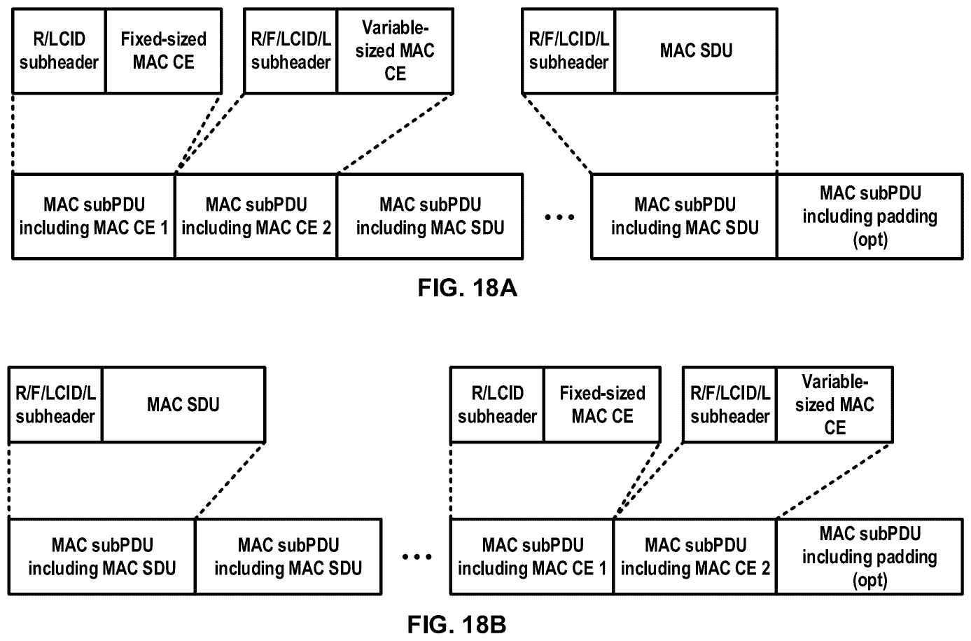

FIG. 18A shows an example of a MAC PDU (e.g., a DL MAC PDU). Multiple MAC CEs, such as MAC CE 1 and 2 shown in FIG. 18A, may be placed together (e.g., located within the same MAC PDU). A MAC subPDU comprising a MAC CE may be placed (e.g., located within a MAC PDU) before any MAC subPDU comprising a MAC SDU or a MAC subPDU comprising padding. MAC CE 1 may be a fixed-sized MAC CE that follows a first-type MAC subheader. The first-type MAC subheader may comprise an R field and an LCID field (e.g., similar to the MAC CE shown in FIG. 17C). MAC CE 2 may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

FIG. 18B shows an example of a MAC PDU (e.g., a UL MAC PDU). Multiple MAC CEs, such as MAC CE 1 and 2 shown in FIG. 18B, may be placed together (e.g., located within the same MAC PDU). A MAC subPDU comprising a MAC CE may be placed (e.g., located within a MAC PDU) after all MAC subPDUs comprising a MAC SDU. The MAC subPDU and/or the MAC subPDU comprising a MAC CE may be placed (e.g., located within a MAC PDU) before a MAC subPDU comprising padding. Similar to the MAC CEs shown in FIG. 18A, MAC CE 1 shown in FIG. 18B may be a fixed-sized MAC CE that follows a first-type MAC subheader. The first-type MAC subheader may comprise an R field and an LCID field (e.g., similar to the MAC CE shown in FIG. 17C). Similar to the MAC CEs shown in FIG. 18A, MAC CE 2 shown in FIG. 18B may be a variable-sized MAC CE that follows a second-type MAC subheader. The second-type MAC subheader may comprise an R field, an F field, an LCID field and an L field (e.g., similar to the MAC CEs shown in FIG. 17A or FIG. 17B). The size of a MAC SDU that follows the second-type MAC subheader may vary.

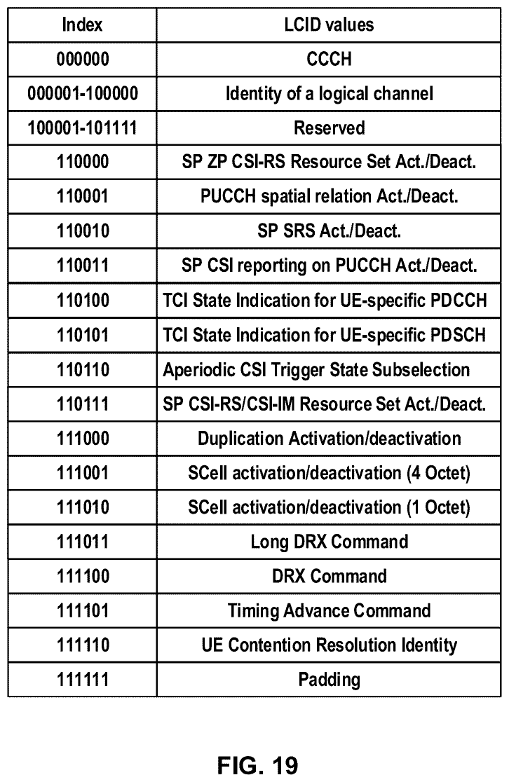

A base station (e.g., the MAC entity of a base station) may send/transmit one or more MAC CEs to a wireless device (e.g., a MAC entity of a wireless device). FIG. 19 shows example LCID values. The LCID values may be associated with one or more MAC CEs. The LCID values may be associated with a downlink channel, such as a DL-SCH. The one or more MAC CEs may comprise at least one of: an semi-persistent zero power CSI-RS (SP ZP CSI-RS) Resource Set Activation/Deactivation MAC CE, a PUCCH spatial relation Activation/Deactivation MAC CE, an SP SRS Activation/Deactivation MAC CE, an SP CSI reporting on PUCCH Activation/Deactivation MAC CE, a TCI State Indication for wireless device-specific (e.g., UE-specific) PDCCH MAC CE, a TCI State Indication for wireless device-specific (e.g., UE-specific) PDSCH MAC CE, an Aperiodic CSI Trigger State Subselection MAC CE, an SP CSI-RS/CSI interference measurement (CSI-IM) Resource Set Activation/Deactivation MAC CE, a wireless device (e.g., UE) contention resolution identity MAC CE, a timing advance command MAC CE, a DRX command MAC CE, a Long DRX command MAC CE, an SCell activation/deactivation MAC CE (e.g., 1 Octet), an SCell activation/deactivation MAC CE (e.g., 4 Octet), and/or a duplication activation/deactivation MAC CE. A MAC CE, such as a MAC CE sent/transmitted by a base station (e.g., a MAC entity of a base station) to a wireless device (e.g., a MAC entity of a wireless device), may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a long DRX command MAC CE, for example, for a MAC CE associated with the downlink.

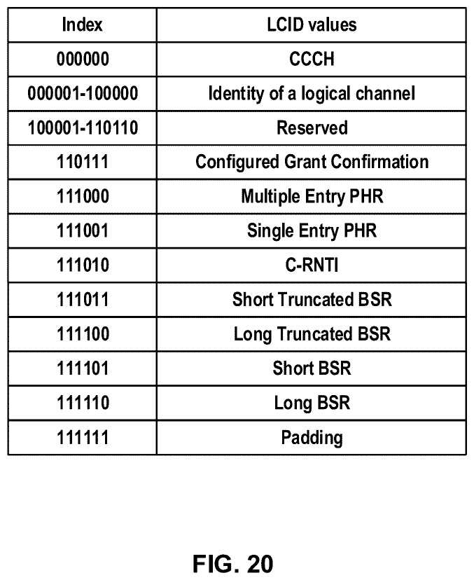

A wireless device (e.g., a MAC entity of a wireless device) may send/transmit to a base station (e.g., a MAC entity of a base station) one or more MAC CEs. FIG. 20 shows an example LCID values that may be associated with the one or more MAC CEs. The LCID values may be associated with an uplink channel, such as a UL-SCH. The one or more MAC CEs may comprise at least one of: a short buffer status report (BSR) MAC CE, a long BSR MAC CE, a C-RNTI MAC CE, a configured grant confirmation MAC CE, a single entry power headroom report (PHR) MAC CE, a multiple entry PHR MAC CE, a short truncated BSR, and/or a long truncated BSR. A MAC CE may be associated with (e.g., correspond to) an LCID in the MAC subheader corresponding to the MAC CE. Different MAC CEs may correspond to a different LCID in the MAC subheader corresponding to the MAC CE. An LCID having an index value “111011” in a MAC subheader may indicate that a MAC CE associated with the MAC subheader is a short-truncated command MAC CE, for example, for a MAC CE associated with the uplink.

Two or more CCs may be aggregated, such as in carrier aggregation (CA). A wireless device may simultaneously receive and/or transmit data via one or more CCs, for example, depending on capabilities of the wireless device (e.g., using the technique of CA). A wireless device may support CA for contiguous CCs and/or for non-contiguous CCs. CCs may be organized into cells. CCs may be organized into one PCell and one or more SCells.

A wireless device may have an RRC connection (e.g., one RRC connection) with a network, for example, if the wireless device is configured with CA. During an RRC connection establishment/re-establishment/handover, a cell providing/sending/configuring NAS mobility information may be a serving cell. During an RRC connection re-establishment/handover procedure, a cell providing/sending/configuring a security input may be a serving cell. The serving cell may be a PCell. A base station may send/transmit, to a wireless device, one or more messages comprising configuration parameters of a plurality of SCells, for example, depending on capabilities of the wireless device.

A base station and/or a wireless device may use/employ an activation/deactivation mechanism of an SCell, for example, if configured with CA. The base station and/or the wireless device may use/employ an activation/deactivation mechanism of an SCell, for example, to improve battery use and/or power consumption of the wireless device. A base station may activate or deactivate at least one of one or more SCells, for example, if a wireless device is configured with the one or more SCells. An SCell may be deactivated unless an SCell state associated with the SCell is set to an activated state (e.g., “activated”) or a dormant state (e.g., “dormant”), for example, after configuring the SCell.

A wireless device may activate/deactivate an SCell. A wireless device may activate/deactivate a cell, for example, based on (e.g., after or in response to) receiving an SCell Activation/Deactivation MAC CE. The SCell Activation/Deactivation MAC CE may comprise one or more fields associated with one or more SCells, respectively, to indicate activation or deactivation of the one or more SCells. The SCell Activation/Deactivation MAC CE may correspond to one octet comprising seven fields associated with up to seven SCells, respectively, for example, if the aggregated cell has less than eight SCells. The SCell Activation/Deactivation MAC CE may comprise an R field. The SCell Activation/Deactivation MAC CE may comprise a plurality of octets comprising more than seven fields associated with more than seven SCells, for example, if the aggregated cell has more than seven SCells.

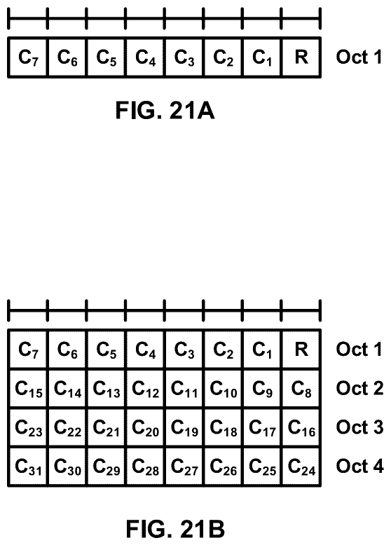

FIG. 21A shows an example SCell Activation/Deactivation MAC CE of one octet. A first MAC PDU subheader comprising a first LCID (e.g., ‘111010’ as shown in FIG. 19) may indicate/identify the SCell Activation/Deactivation MAC CE of one octet. The SCell Activation/Deactivation MAC CE of one octet may have a fixed size. The SCell Activation/Deactivation MAC CE of one octet may comprise a single octet. The single octet may comprise a first quantity/number of C-fields (e.g., seven or any other quantity/number) and a second quantity/number of R-fields (e.g., one or any other quantity/number).

FIG. 21B shows an example SCell Activation/Deactivation MAC CE of four octets. A second MAC PDU subheader comprising a second LCID (e.g., ‘111001’ as shown in FIG. 19) may indicate/identify the SCell Activation/Deactivation MAC CE of four octets. The SCell Activation/Deactivation MAC CE of four octets may have a fixed size. The SCell Activation/Deactivation MAC CE of four octets may comprise four octets. The four octets may comprise a third quantity/number of C-fields (e.g., 31 or any other quantity/number) and a fourth quantity/number of R-fields (e.g., 1 or any other quantity/number).

As shown in FIG. 21A and/or FIG. 21B, a Ci field may indicate an activation/deactivation status of an SCell with/corresponding to an SCell index i, for example, if an SCell with/corresponding to SCell index i is configured. An SCell with an SCell index i may be activated, for example, if the Ci field is set to one. An SCell with an SCell index i may be deactivated, for example, if the Ci field is set to zero. The wireless device may ignore the Ci field, for example, if there is no SCell configured with SCell index i. An R field may indicate a reserved bit. The R field may be set to zero or any other value (e.g., for other purposes).

A base station may configure a wireless device with uplink (UL) BWPs and downlink (DL) BWPs to enable bandwidth adaptation (BA) on a PCell. The base station may further configure the wireless device with at least DL BWP(s) (i.e., there may be no UL BWPs in the UL) to enable BA on an SCell, for example, if carrier aggregation is configured. An initial active BWP may be a first BWP used for initial access, for example, for a PCell. A first active BWP may be a second BWP configured for the wireless device to operate on a SCell upon the SCell being activated. A base station and/or a wireless device may independently switch a DL BWP and an UL BWP, for example, in paired spectrum (e.g., FDD). A base station and/or a wireless device may simultaneously switch a DL BWP and an UL BWP, for example, in unpaired spectrum (e.g., TDD).

A base station and/or a wireless device may switch a BWP between configured BWPs using a DCI message or a BWP inactivity timer. The base station and/or the wireless device may switch an active BWP to a default BWP based on (e.g., after or in response to) an expiry of the BWP inactivity timer associated with the serving cell, for example, if the BWP inactivity timer is configured for a serving cell. The default BWP may be configured by the network. One UL BWP for an uplink carrier (e.g., each uplink carrier) and one DL BWP may be active at a time in an active serving cell, for example, if FDD systems are configured with BA. One DL/UL BWP pair may be active at a time in an active serving cell, for example, for TDD systems. Operating on the one UL BWP and the one DL BWP (or the one DL/UL pair) may improve wireless device battery consumption. BWPs other than the one active UL BWP and the one active DL BWP that the wireless device may work on may be deactivated. The wireless device may not monitor PDCCH transmission, for example, on deactivated BWPs. The wireless device may not send (e.g., transmit) on PUCCH, PRACH, and UL-SCH, for example, on deactivated BWPs.

A serving cell may be configured with at most a first number/quantity (e.g., four) of BWPs. There may be one active BWP at any point in time, for example, for an activated serving cell. A BWP switching for a serving cell may be used to activate an inactive BWP and deactivate an active BWP at a time. The BWP switching may be controlled by a PDCCH transmission indicating a downlink assignment or an uplink grant. The BWP switching may be controlled by a BWP inactivity timer (e.g., bwp-InactivityTimer). The BWP switching may be controlled by a wireless device (e.g., a MAC entity of the wireless device) based on (e.g., after or in response to) initiating a Random Access procedure. One BWP may be initially active without receiving a PDCCH transmission indicating a downlink assignment or an uplink grant, for example, upon addition of an SpCell or activation of an SCell. The active BWP for a serving cell may be indicated by configuration parameter(s) (e.g., parameters of RRC message) and/or PDCCH transmission. A DL BWP may be paired with a UL BWP for unpaired spectrum, and BWP switching may be common for both UL and DL.

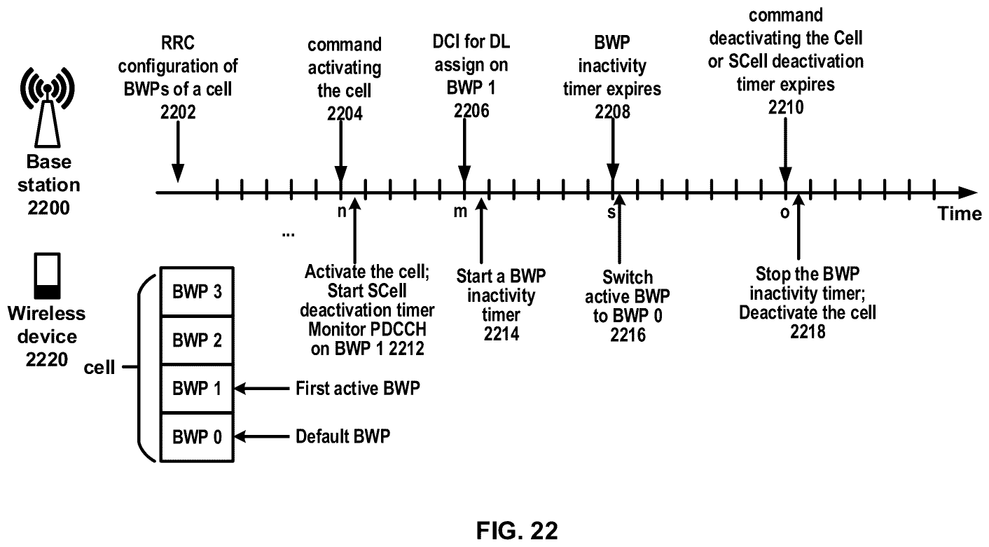

FIG. 22 shows an example of BWP activation/deactivation. The BWP activation/deactivation may be on a cell (e.g., PCell or SCell). The BWP activation/deactivation may be associated with BWP switching (e.g., BWP switching may comprise the BWP activation/deactivation). A wireless device 2220 may receive (e.g., detect) at step 2202, (e.g., from a base station 2200), at least one message (e.g., RRC message) comprising parameters of a cell and one or more BWPs associated with the cell. The RRC message may comprise at least one of: RRC connection reconfiguration message (e.g., RRCReconfiguration), RRC connection reestablishment message (e.g., RRCRestablishment), and/or RRC connection setup message (e.g., RRCSetup). Among the one or more BWPs, at least one BWP may be configured as the first active BWP (e.g., BWP 1), one BWP as the default BWP (e.g., BWP 0). The wireless device 2220 may receive (e.g., detect) a command at step 2204 (e.g., RRC message, MAC CE or DCI message) to activate the cell at an nth slot. The wireless device 2220 may not receive (e.g., detect) a command activating a cell, for example, a PCell. The wireless device 2220 may activate the PCell at step 2212, for example, after the wireless device 2220 receives/detects RRC message comprising configuration parameters of the PCell. The wireless device 2220 may start monitoring a PDCCH transmission on BWP 1 based on (e.g., after or in response to) activating the PCell at step 2212.

The wireless device 2220 may start (or restart) at step 2214, a BWP inactivity timer (e.g., bwp-InactivityTimer) at an mth slot based on (e.g., after or in response to) receiving a DCI message 2206 indicating DL assignment on BWP 1. The wireless device 2220 may switch back at step 2216 to the default BWP (e.g., BWP 0) as an active BWP, for example, if the BWP inactivity timer expires at step 2208, at sth slot. At step 2210, the wireless device 2220 may deactivate the cell and/or stop the BWP inactivity timer, for example, if a secondary cell deactivation timer (e.g., sCellDeactivationTimer) expires at step 2210 (e.g., if the cell is a SCell). The wireless device 2220 may not deactivate the cell and may not apply or use a secondary cell deactivation timer (e.g., sCellDeactivationTimer) on the PCell, for example, based on the cell being a PCell.

A wireless device (e.g., a MAC entity of the wireless device) may apply or use various operations on an active BWP for an activated serving cell configured with a BWP. The various operations may comprise at least one of: sending (e.g., transmitting) on UL-SCH, sending (e.g., transmitting) on RACH, monitoring a PDCCH transmission, sending (e.g., transmitting) PUCCH, receiving DL-SCH, and/or (re-) initializing any suspended configured uplink grants of configured grant Type 1 according to a stored configuration, if any.

A wireless device (e.g., a MAC entity of the wireless device) may not perform certain operations, for example, on an inactive BWP for an activated serving cell (e.g., each activated serving cell) configured with a BWP. The certain operations may include at least one of sending (e.g., transmit) on UL-SCH, sending (e.g., transmit) on RACH, monitoring a PDCCH transmission, sending (e.g., transmit) PUCCH, sending (e.g., transmit) SRS, or receiving DL-SCH. The wireless device (e.g., the MAC entity of the wireless device) may clear any configured downlink assignment and configured uplink grant of configured grant Type 2, and/or suspend any configured uplink grant of configured Type 1, for example, on the inactive BWP for the activated serving cell (e.g., each activated serving cell) configured with the BWP.

A wireless device may perform a BWP switching of a serving cell to a BWP indicated by a PDCCH transmission, for example, if a wireless device (e.g., a MAC entity of the wireless device) receives/detects the PDCCH transmission for the BWP switching and a random access procedure associated with the serving cell is not ongoing. A bandwidth part indicator field value may indicate the active DL BWP, from the configured DL BWP set, for DL receptions, for example, if the bandwidth part indicator field is configured in DCI format 1_1. A bandwidth part indicator field value may indicate the active UL BWP, from the configured UL BWP set, for UL transmissions, for example, if the bandwidth part indicator field is configured in DCI format 0_1.

A wireless device may be provided by a higher layer parameter such as a default DL BWP (e.g., Default-DL-BWP) among the configured DL BWPs, for example, for a primary cell. A default DL BWP may be the initial active DL BWP, for example, if a wireless device is not provided with the default DL BWP by the higher layer parameter (e.g., Default-DL-BWP). A wireless device may be provided with a higher layer parameter such as a value of a timer for the primary cell (e.g., bwp-InactivityTimer). The wireless device may increment the timer, if running, every interval of 1 millisecond for frequency range 1 or every 0.5 milliseconds for frequency range 2, for example, if the wireless device may not detect a DCI format 1_1 for paired spectrum operation or if the wireless device may not detect a DCI format 1_1 or DCI format 0_1 for unpaired spectrum operation during the interval.

Procedures of a wireless device on the secondary cell may be substantially the same as on the primary cell using a timer value for a secondary cell and the default DL BWP for the secondary cell, for example, if the wireless device is configured for the secondary cell with a higher layer parameter (e.g., Default-DL-BWP) indicating a default DL BWP among the configured DL BWPs and the wireless device is configured with a higher layer parameter (e.g., bwp-InactivityTimer) indicating the timer value. A wireless device may use an indicated DL BWP and an indicated UL BWP on a secondary cell respectively as a first active DL BWP and a first active UL BWP on the secondary cell or carrier, for example, if the wireless device is configured by a higher layer parameter (e.g., Active-BWP-DL-SCell) associated with the first active DL BWP and by a higher layer parameter (e.g., Active-BWP-UL-SCell) associated with the first active UL BWP on the secondary cell or carrier.

A set of PDCCH candidates for a wireless device to monitor may be referred to as PDCCH search space sets. A search space set may comprise a CSS set or a USS set. A wireless device may monitor PDCCH transmission candidates in one or more of the following search spaces sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by a SI-RNTI on the primary cell of the MCG, a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, for the primary cell, C-RNTI, MCS-C-RNTI, or CS-RNTI(s), and a USS set configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

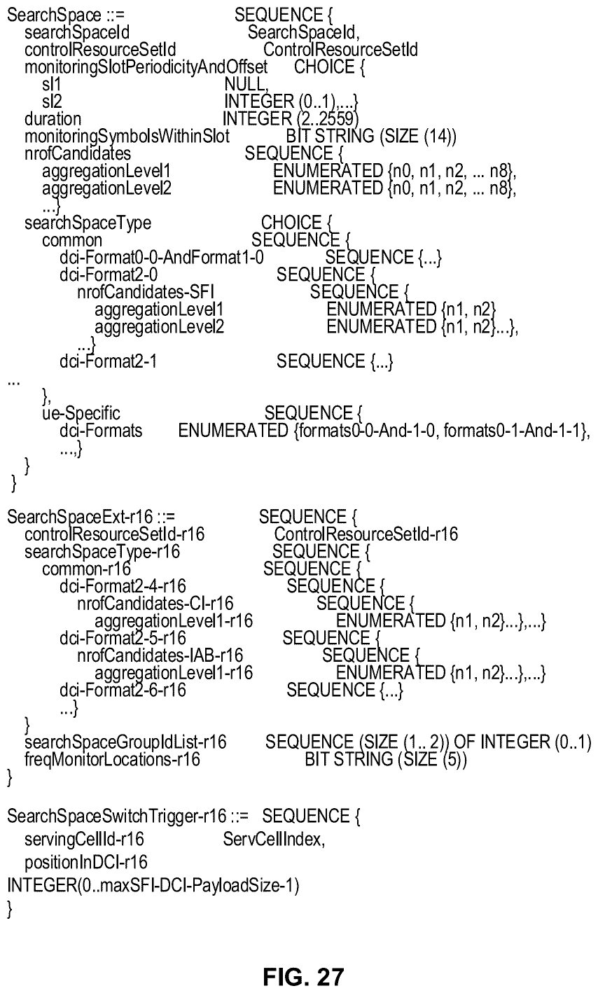

A wireless device may determine a PDCCH transmission monitoring occasion on an active DL BWP based on one or more PDCCH transmission configuration parameters (e.g., as described with respect to FIG. 27) comprising at least one of: a PDCCH transmission monitoring periodicity, a PDCCH transmission monitoring offset, or a PDCCH transmission monitoring pattern within a slot. For a search space set (SS s), the wireless device may determine that a PDCCH transmission monitoring occasion(s) exists in a slot with number/quantity n_{s,f}^{μ} in a frame with number/quantity n_{f} if (n_{f}·Nₛₗₒₜ^{frame,μ}+n_{s,f}^{μ}−oₛ) mod kₛ=0. Nₛₗₒₜ^{frame,μ} may be a number/quantity of slots in a frame if numerology p is configured. oₛ may be a slot offset indicated in the PDCCH transmission configuration parameters. kₛ may be a PDCCH transmission monitoring periodicity indicated in the PDCCH transmission configuration parameters. The wireless device may monitor PDCCH transmission candidates for the search space set for Tₛ consecutive slots, starting from slot n_{s,f}^{μ}, and may not monitor PDCCH transmission candidates for search space set s for the next kₛ−Tₛ consecutive slots. A USS at CCE aggregation level L∈{1, 2, 4, 8, 16} may be defined by a set of PDCCH transmission candidates for CCE aggregation level L.

A wireless device may decide, for a search space set s associated with CORESET p, CCE indexes for aggregation level L corresponding to PDCCH transmission candidate m_{s,n}_{_{Cl}} of the search space set in slot n_{s,f}^{μ} for an active DL BWP of a serving cell corresponding to carrier indicator field value n_{Cl} as

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , ma x}^{( L )}} ⌋ + {n}_{CI} ) mod ⌊ {N}_{CCE , p} / L ⌋ \} + i ,$$

where, Y_{p,n}_{_{s,f}}_{^{μ}}=0 for any CSS; Y_{p,n}_{_{s,f}}_{^{μ}}=(Aₚ·Y_{p,n}_{_{s,f}}_{^{μ}}₋₁) mod D for a USS, Y_{p,-1}=n_{RNTI}≠0, Aₚ=39827 for p mod 3=0, Aₚ=39829 for p mod 3=1, Aₚ=39839 for p mod 3=2, and D=65537; i=0, . . . , L−1; N_{CCE,p} is the number/quantity of CCEs, numbered/quantified from 0 to N_{CCE,p}−1, in CORESET p; n_{Cl} is the carrier indicator field value if the wireless device is configured with a carrier indicator field by CrossCarrierSchedulingConfig for the serving cell on which PDCCH transmission is monitored; otherwise, including for any CSS, n_{Cl}=0; m_{s,n}_{_{Cl}}=0, . . . , M_{s,n}_{_{Cl}}−1, where M_{s,n}_{_{Cl}}^{(L)} is the number/quantity of PDCCH transmission candidates the wireless device is configured to monitor for aggregation level L of a search space set s for a serving cell corresponding to n_{Cl}; for any CSS, M_{s,max}^{(L)}=M_{s,0}^{(L)}; for a USS, M_{s,max}^{(L)} is the maximum of M_{s,n}_{_{Cl}}^{(L)} over configured n_{Cl} values for a CCE aggregation level L of search space set s; and the RNTI value used for n_{RNTI} is the C-RNTI.

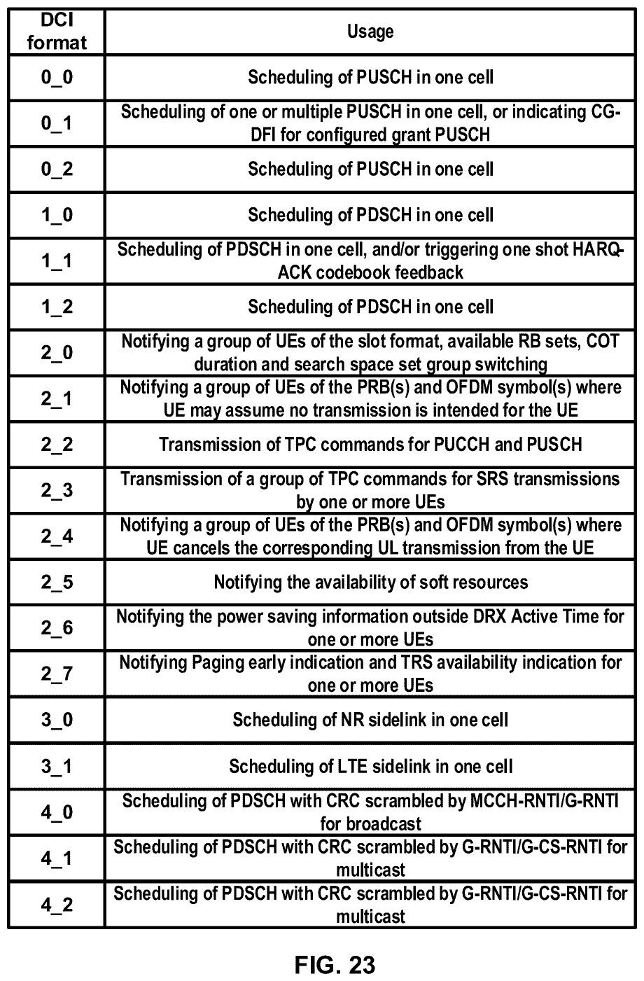

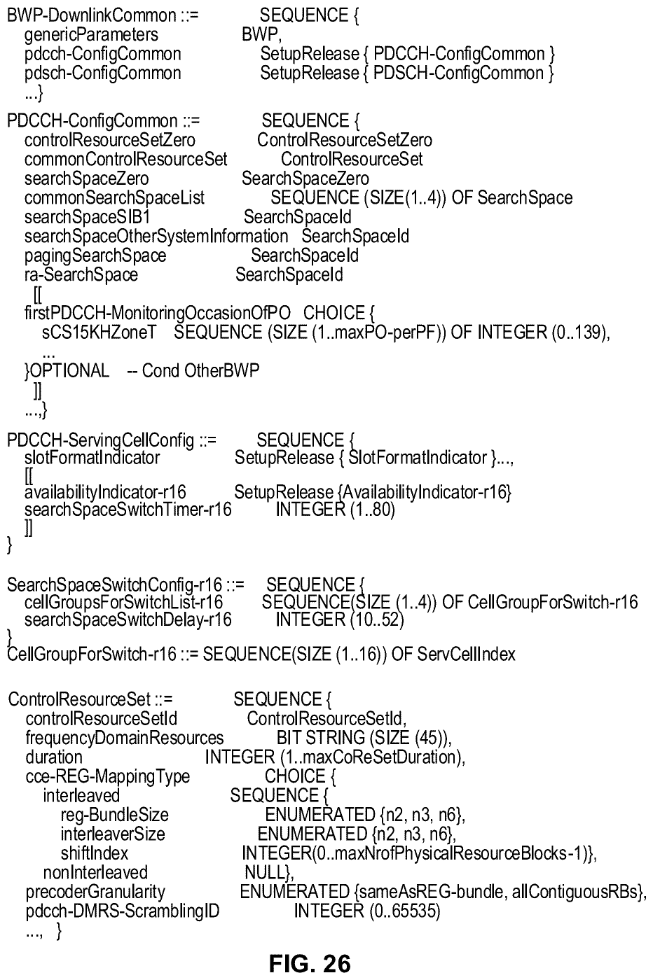

A wireless device may monitor a set of PDCCH transmission candidates according to configuration parameters of a search space set comprising a plurality of search spaces. The wireless device may monitor a set of PDCCH transmission candidates in one or more CORESETs for detecting one or more DCI messages. A CORESET may be configured, for example, as described with respect to FIG. 26. Monitoring may comprise decoding one or more PDCCH transmission candidates of the set of the PDCCH transmission candidates according to the monitored DCI formats. Monitoring may comprise decoding DCI content of one or more PDCCH transmission candidates with possible (or configured) PDCCH transmission locations, possible (or configured) PDCCH transmission formats (e.g., number/quantity of CCEs, number/quantity of PDCCH transmission candidates in common search spaces, and/or number/quantity of PDCCH transmission candidates in the wireless device-specific search spaces (e.g., the UE-specific search spaces)) and possible (or configured) DCI formats. The decoding may be referred to as blind decoding. The possible DCI formats may be based on examples of FIG. 23.

FIG. 23 shows examples of various DCI formats. The various DCI formats may be used, for example, by a base station to send (e.g., transmit) control information (e.g., to a wireless device and/or to be used by the wireless device) for PDCCH transmission monitoring. Different DCI formats may comprise different DCI fields and/or have different DCI payload sizes. Different DCI formats may have different signaling purposes. DCI format 0_0 may be used to schedule PUSCH transmission in one cell. DCI format 0_1 may be used to schedule one or multiple PUSCH transmissions in one cell or indicate CG-DFI (configured grant-Downlink Feedback Information) for configured grant PUSCH transmission, etc. The DCI format(s), that the wireless device may monitor for reception via a search space, may be configured.

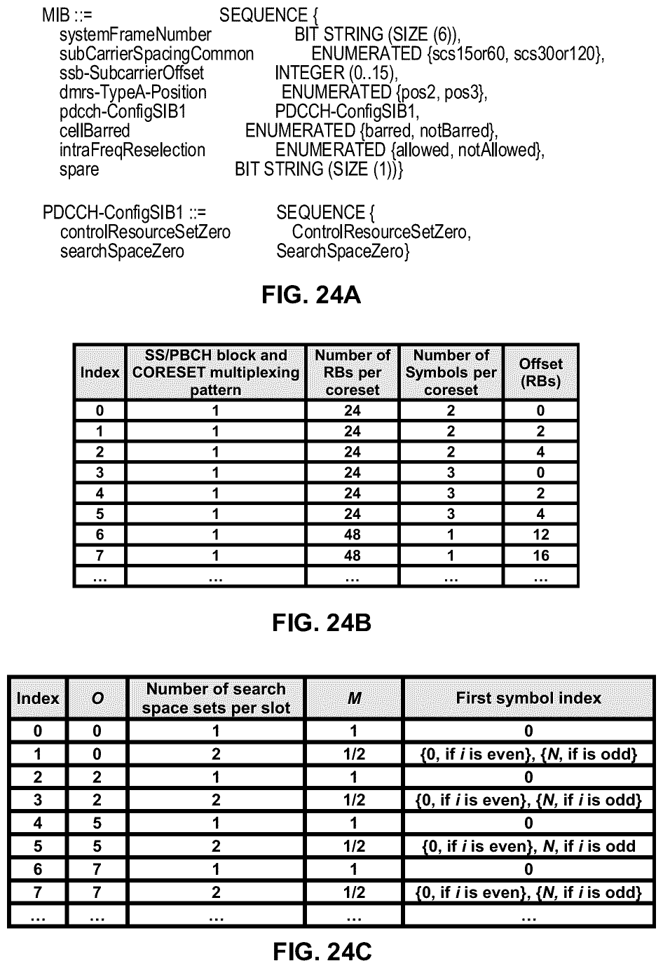

FIG. 24A shows an example MIB message. FIG. 24A shows example configuration parameters of a MIB of a cell. The cell may be a PCell (or any other cell). A wireless device may receive a MIB via a PBCH. The wireless device may receive the MIB, for example, based on receiving a PSS and/or an SSS. The configuration parameters of a MIB may comprise/indicate a SFN (e.g., indicated via a higher layer parameter systemFrameNumber), subcarrier spacing indication (e.g., indicated via a higher layer parameter subCarrierSpacingCommon), a frequency domain offset (e.g., indicated via a higher layer parameter ssb-SubcarrierOffset) between SSB and overall resource block grid in number of subcarriers, a parameter indicating whether the cell is barred (e.g., indicated via a higher layer parameter cellBarred), a DMRS position indication (e.g., indicated via a higher layer parameter dmrs-TypeA-Position) indicating position of DMRS, parameters of a CORESET and a search space of a PDCCH (e.g., indicated via a higher layer parameter pdcch-ConfigSIB1) comprising a common CORESET, a common search space and necessary PDCCH parameters, etc. Each of the higher layer parameters may be indicated via one or bits. For example, the SFN may be indicated using 6 bits (or any other quantity of bits).

A configuration parameter (e.g., pdcch-ConfigSIB1) may comprise a first parameter (e.g., controlResourceSetZero) indicating a common CORESET of an initial BWP of the cell. The common CORESET may be associated with an indicator/index (e.g., 0, or any other indicator). For example, the common CORESET may be CORESET 0. The first parameter may be an integer between 0 and 15 (or any other integer). Each integer (e.g., between 0 and 15, or any other integer) may indicate/identify a configuration of CORESET 0.

FIG. 24B shows an example configuration of a CORESET. The CORESET may be CORESET 0 (or any other CORESET). A wireless device may determine an SSB and CORESET 0 multiplexing pattern, a quantity/number of RBs for CORESET 0, a quantity/number of symbols for CORESET 0, an RB offset for CORESET 0, for example, based on a value of the first parameter (e.g., controlResourceSetZero).

A higher layer parameter (e.g., pdcch-ConfigSIB1) may comprise a second parameter (e.g., searchSpaceZero). The second parameter may indicate a common search space of the initial BWP of the cell. The common search space may be associated with an indicator/index (e.g., 0, or any other indicator). For example, the common search space may be search space 0. The second parameter may be an integer between 0 and 15 (or any other integer). Each integer (e.g., between 0 and 15, or any other integer) may identify a configuration of search space 0.

FIG. 24C shows an example configuration of a search space. The search space may be search space 0 (or any other search space). A wireless device may determine one or more parameters (e.g., O, M) for slot determination for PDCCH monitoring, a first symbol indicator/index for PDCCH monitoring, and/or a quantity/number of search spaces per slot, for example, based on a value of the second parameter (e.g., searchSpaceZero). For example, for operation without shared spectrum channel access and for the SS/PBCH block and CORESET multiplexing pattern 1, the wireless device may monitor PDCCH (e.g., in the Type0-PDCCH CSS set) over two slots. For SS/PBCH block with index i, the wireless device may determine an index of slot n₀ as n₀=(0·2+└i·M┘)mod Nₛₗₒₜ^{frame,μ}. Slot n₀ is may be in a frame with a SFN SFN_{C} that satisfies the condition SFN_{c} mod 2=0 (e.g., if └(O·2^{μ}+└i·M┘)/Nₛₗₒₜ^{frame,μ}┘ mod 2=0), or in a frame with a SFN that SFN_{C} satisfies the condition SFN_{c} mod 2=1 (e.g., if └(O·2μ+└i·M┘)/Nₛₗₒₜ^{frame,μ}┘ mod 2=1), where y∈{0, 1, 2, 3, 5, 6} based on the SCS for PDCCH receptions in the CORESET.

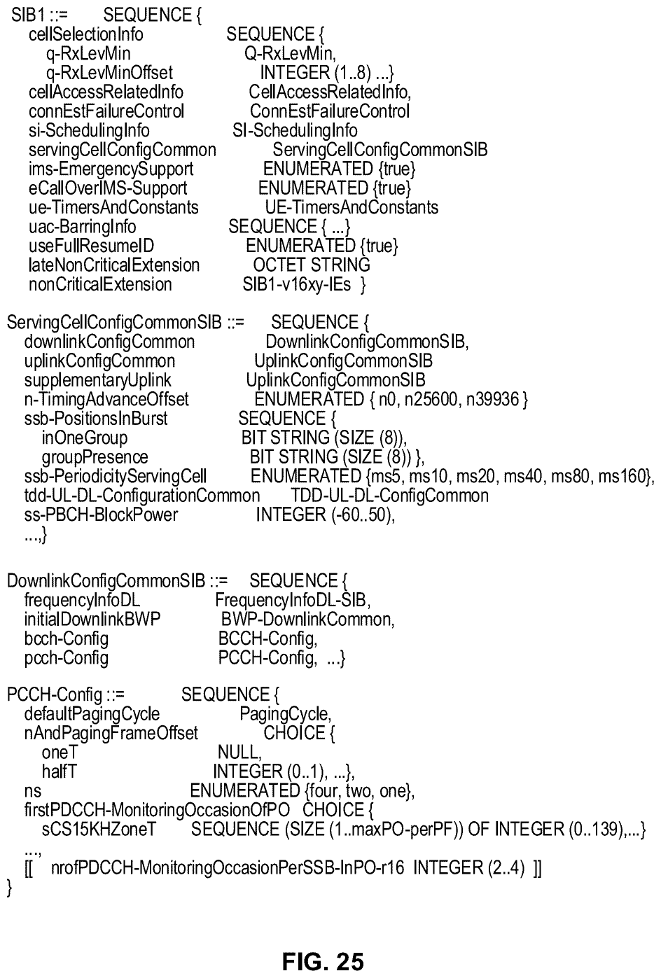

A wireless device may monitor a PDCCH for receiving DCI. The wireless device may monitor a search space 0 of a CORESET 0 for receiving the DCI. The DCI may schedule a SIB1. For example, a SIB1 message may be similar to as described with respect to FIG. 25. The wireless device may receive the DCI with CRC scrambled with a SI-RNTI dedicated for receiving the SIB1.

FIG. 25 shows an example SIB. The SIB may comprise one or more configuration parameters (e.g., RRC configuration parameters). A SIB (e.g., SIB1) may be sent/transmitted to one or more wireless devices. For example, the SIB may be broadcasted to multiple wireless devices. The SIB may contain information for evaluating/determining whether a wireless device is allowed to access a cell, information of paging configuration, and/or scheduling configuration of other system information. A SIB may comprise radio resource configuration information that may be common for multiple wireless devices and barring information used/applied to a unified access control. A base station may send/transmit, to a wireless device (or a plurality of wireless devices), one or more SIB information messages. As shown in FIG. 25, parameters of the one or more SIB information messages may comprise: one or more parameters for cell selection related to a serving cell (e.g., cellSelectionInfo), one or more configuration parameters of a serving cell (e.g., in ServingCellConfigCommonSIB information element (IE)), and/or one or more other parameters. The ServingCellConfigCommonSIB IE may comprise at least one of: common downlink parameters (e.g., in DownlinkConfigCommonSIB IE) of the serving cell, common uplink parameters (e.g., in UplinkConfigCommonSIB IE) of the serving cell, and/or other parameters.

A DownlinkConfigCommonSIB IE may comprise parameters of an initial downlink BWP (e.g., indicated via initialDownlinkBWP IE) of the serving cell (e.g., SpCell). The parameters of the initial downlink BWP may be comprised in a BWP-DownlinkCommon IE (e.g., as shown in FIG. 26). The BWP-DownlinkCommon IE may be used to configure common parameters of a downlink BWP of the serving cell. The base station may configure a parameter (e.g., locationAndBandwidth) such that the initial downlink BWP may comprise an entire CORESET (e.g., CORESET 0) of the serving cell in the frequency domain. The wireless device may use/apply the parameter locationAndBandwidth based on reception of the parameter. The wireless device may use/apply the parameter locationAndBandwidth to determine the frequency position of signals in relation to the frequency as indicated via locationAndBandwidth. The wireless device may keep CORESET 0, for example, until after reception of an RRC setup message (e.g., RRCSetup), RRC resume message (e.g., RRCResume) and/or an RRC re-establishment message (e.g., RRCReestablishment).

The DownlinkConfigCommonSIB IE may comprise parameters of a paging channel configuration. The parameters may comprise a paging cycle value (T, e.g., indicated by defaultPagingCycle IE), a parameter indicating total quantity/number (N) of paging frames (PFs) (e.g., indicated by nAndPagingFrameOffset IE) and paging frame offset in a paging DRX cycle (e.g., indicated by parameter PF_offset), a quantity/number (Ns) for total paging occasions (POs) per PF, a first PDCCH monitoring occasion indication parameter (e.g., firstPDCCH-MonitoringOccasionofPO IE) indicating a first PDCCH monitoring occasion for paging of each PO of a PF. The wireless device may monitor a PDCCH for receiving a paging message, for example, based on parameters of a PCCH configuration.

A parameter (e.g., first-PDCCH-MonitoringOccasionOfPO) may be signaled in SIB1 for paging in initial DL BWP. The parameter first-PDCCH-MonitoringOccasionOfPO may be signaled in the corresponding BWP configuration, for example, for paging in a DL BWP other than the initial DL BWP.

FIG. 26 shows example RRC configuration parameters. The configuration parameters may be RRC configuration parameters for a downlink BWP of a serving cell. The configuration parameters may be indicated via a higher layer parameter BWP-DownlinkCommon IE. A base station may send/transmit to a wireless device (or a plurality of wireless devices) one or more configuration parameters of a downlink BWP (e.g., initial downlink BWP) of a serving cell. The one or more configuration parameters of the downlink BWP may comprise: one or more generic BWP parameters of the downlink BWP, one or more cell-specific parameters for PDCCH of the downlink BWP (e.g., in pdcch-ConfigCommon IE), one or more cell specific parameters for the PDSCH of the BWP (e.g., in pdsch-ConfigCommon IE), and/or one or more other parameters. A pdcch-ConfigCommon IE may comprise parameters of CORESET 0 (e.g., indicated via parameter controlResourceSetZero) which may be used in any common or wireless device-specific search spaces. A value of the controlResourceSetZero may be interpreted in the same manner as the corresponding bits in MIB parameter pdcch-ConfigSIB1. A pdcch-ConfigCommon IE may comprise parameters (e.g., in commonControlResourceSet) of an additional common control resource set which may be configured and used for any common or wireless device-specific search space. The network may use a parameter ControlResourceSetId other than 0 for this ControlResourceSet, for example, if the network configures commonControlResourceSet. The network may configure the commonControlResourceSet in SIB1 such that the SIB1 is contained within the bandwidth of CORESET 0. A pdcch-ConfigCommon IE may comprise parameters (e.g., in commonSearchSpaceList) of a list of additional common search spaces. Parameters of a search space may be implemented based on example of FIG. 27. A pdcch-ConfigCommon IE may indicate, from a list of search spaces, a search space for paging (e.g., via parameter pagingSearchSpace), a search space for random access procedure (e.g., via parameter ra-SearchSpace), a search space for SIB1 message (e.g., via parameter searchSpaceSIB1), a common search space 0 (e.g., via parameter searchSpaceZero), and/or one or more other search spaces.

A CORESET may be associated with a CORESET indicator/index (e.g., indicated via parameter ControlResourceSetId). A CORESET may be implemented based on examples described with respect to FIG. 14A and/or FIG. 14B. The CORESET index 0 may identify a common CORESET configured in MIB and in ServingCellConfigCommon (e.g., indicated via controlResourceSetZero). The CORESET index 0 may not be used in the ControlResourceSet IE. The CORESET index with other values may identify CORESETs configured by dedicated signaling or in SIB1. The controlResourceSetId may be unique among the BWPs of a serving cell. A CORESET may be associated with coresetPoolIndex indicating an index of a CORESET pool for the CORESET. A CORESET may be associated with a time duration parameter (e.g., duration) indicating contiguous time duration of the CORESET (e.g., in terms of a quantity/number of symbols). Configuration parameters of a CORESET may comprise at least one of: frequency resource indication (e.g., frequencyDomainResources), a CCE-REG mapping type indicator (e.g., cce-REG-MappingType), a plurality of TCI states, and/or an indicator indicating whether a TCI is present in DCI, etc. The frequency resource indication (e.g., comprising a quantity/number of bits, such as 45 bits, or any other quantity of bits) may indicate frequency domain resources. Each bit of the frequency resource indication may correspond to a group of RBs (e.g., 6 RBs, or any other quantity of RBs), with the grouping starting from the first RB group in a BWP of a cell (e.g., SpCell, SCell). For example, the first (e.g., left-most, most significant) bit may correspond to the first RB group in the BWP, with the other bits sequentially corresponding to other RB groups. A bit that is set to 1 may indicate that an RB group, corresponding to the bit, is contained in the frequency domain resource of the CORESET. Bits corresponding to a group of RBs not fully contained in the BWP within which the CORESET is configured may be set to zero.

FIG. 27 shows an example configuration of a search space. The configuration of the search space may be within a SearchSpace IE. One or more search space configuration parameters of a search space may comprise at least one of: a search space ID (e.g., searchSpaceId), a CORESET indicator (ID) (e.g., controlResourceSetId), a monitoring slot periodicity and offset parameter (e.g., monitoringSlotPeriodicityAndOffset), a search space time duration value (e.g., duration), a monitoring symbol indication (e.g., monitoringSymbolsWithinSlot), a quantity/number of candidates for an aggregation level (e.g., nrofCandidates), and/or a search space type indicating a common search space type or a wireless device-specific search space type (e.g., searchSpaceType). The monitoring slot periodicity and offset parameter may indicate slots (e.g., in a radio frame) and slot offset (e.g., related to a starting of a radio frame) for PDCCH monitoring. The monitoring symbol indication may indicate symbol(s), of a slot, in which a wireless device may monitor a PDCCH on the search space. The control resource set ID may indicate/identify a CORESET on which a search space may be located.

A wireless device, in an RRC idle state (e.g., RRC_IDLE) or in an RRC inactive state (e.g., RRC_INACTIVE), may periodically monitor POs for receiving paging message(s) for the wireless device. The wireless device, in an RRC idle state or an RRC inactive state and before monitoring the POs, may wake up at a time before each PO for preparation and/or to activate (e.g., turn on) all components in preparation of data reception (e.g., warm up stage). The gap between the waking up and the PO may be set to be sufficient to accommodate all the processing requirements. The wireless device may perform, after the warming up, timing acquisition from SSB and coarse synchronization, frequency and time tracking, time and frequency offset compensation, and/or calibration of local oscillator. The wireless device, after warm up, may monitor a PDCCH for a paging DCI via one or more PDCCH monitoring occasions. The wireless device may monitor the PDCCH, for example, based on configuration parameters of the PCCH configuration (e.g., as configured in SIB1). The configuration parameters of the PCCH configuration may be as described with respect to FIG. 25.

A base station may send/transmit one or more SSBs (e.g., periodically) to a wireless device or a plurality of wireless devices. The wireless device (in RRC idle state, RRC inactive state, or RRC connected state) may use the one or more SSBs for time and frequency synchronization with a cell of the base station. An SSB, comprising a PSS, a SSS, a PBCH, and/or a PBCH DM-RS, may be sent/transmitted (e.g., as described with respect to FIG. 11A). An SSB may occupy a quantity/number (e.g., 4, or any other quantity) of OFDM symbols. The base station may send/transmit one or more SSBs in an SSB burst (e.g., to enable beam-sweeping for PSS/SSS and PBCH). An SSB burst may comprise a set of SSBs, with each SSB potentially being transmitted via a corresponding different beam. SSBs, in the SSB burst, may be transmitted using time-division multiplexing. An SSB burst may be within a time window (e.g., a 5 ms window, or a window of any other duration) and may be either located in first-half or in the second-half of a radio frame (e.g., with a duration of 10 ms, or any other duration). An SSB burst may be equivalently referred to as a transmission window (e.g., 5 ms, or any other time duration) in which the set of SSBs are transmitted.

The base station may indicate a transmission periodicity of SSB via an RRC message (e.g., a SIB1 message). For example, the transmission periodicity may be indicated using parameter ssb-PeriodicityServingCell as present in ServingCellConfigCommonSIB of a SIB1 message (e.g., as shown in FIG. 25). A candidate value of the transmission periodicity may be in a range of {5 ms, 10 ms, 20 ms, 40 ms, 80 ms, 160 ms}. The transmission periodicity may have any other value. A maximum quantity/number of candidate SSBs (Lₘₐₓ) within an SSB burst may depend on a carrier frequency/band of the cell. For example, Lₘₐₓ=⁴ if f_{c}<=3 GHz. Lₘₐₓ=⁸ if 3 GHz<f_{c}<=6 GHz. Lₘₐₓ=64 if f_{c}>=6 GHz, etc., wherein f_{c} may be the carrier frequency of the cell. A starting OFDM symbol indicator/index, of a candidate SSB (e.g., occupying 4 OFDM symbols) within an SSB burst (e.g., comprised in a 5 ms time window), may depend on an SCS and a carrier frequency band of the cell.

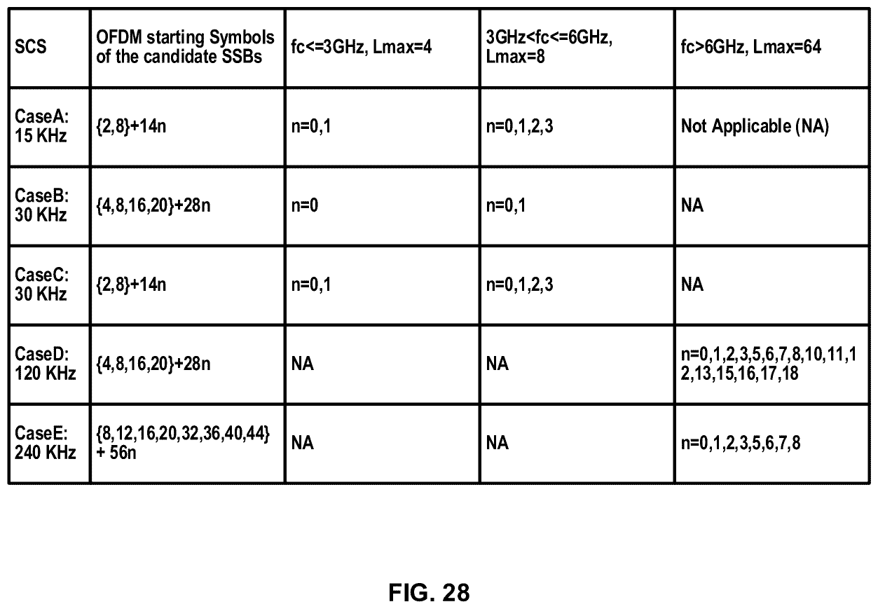

FIG. 28 shows an example of SSB configurations. FIG. 28 shows an example table for determination of a starting OFDM symbol index of candidate SSBs. OFDM starting symbols may be determined as a function of a SCS and carrier frequency. For example, starting OFDM symbol indexes of SSBs in an SSB burst, for a cell configured with 15 kHz SCS and carrier frequency fc<3 GHz (e.g., Lₘₐₓ=4), may be 2, 8, 16, and 22. OFDM symbols in a half-frame may be indexed with the first symbol of the first slot being indexed as 0. Starting OFDM symbol indexes of SSBs in an SSB burst, for a cell configured with 15 kHz and carrier frequency 3 GHz<fc<6 GHz (Lₘₐₓ=8) may be 2, 8, 16, 22, 30, 36, 44 and 50. Starting OFDM symbol indexes for other SCSs and carrier frequencies may be similarly determined in accordance with the table shown in FIG. 28. The base station may send/transmit only one SSB by using the first SSB starting position, for example, if the base station is not transmitting the SSBs with beam forming.

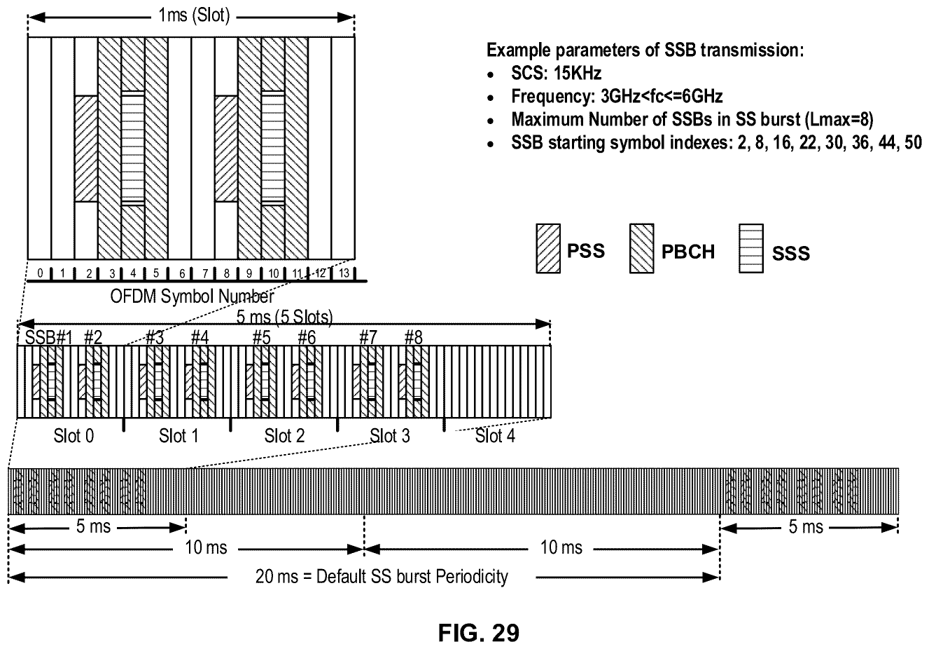

FIG. 29 shows an example of SSB transmissions of a base station. An SCS of the cell may be 15 kHz, and the cell may be configured with carrier frequency fₑ, such that 3 GHz<fc<=6 GHz. A maximum quantity of candidate SSBs in an SSB burst may be 8 (Lₘₐₓ=8), for example, based on the value of f_{c}. Starting symbols for SSB transmission may be determined in accordance with the table shown in FIG. 28. SSB #1 may start at symbol 2 (of 70 symbols included in 5 ms half-frame), SSB #2 may start at symbol #8, SSB #3 may start at symbol #16, SSB #4 may start at symbol #22, SSB #5 may start at symbol #30, SSB #6 may start at symbol #36, SSB #7 may start at symbol #44, and SSB #8 may start at symbol 50. The SSB burst may be transmitted in the first half (and not the second half) of a radio frame (with 10 ms duration).

The SSB burst (and each SSB of the SSB burst) may be sent/transmitted with a periodicity. A default periodicity of an SSB burst may be 20 ms (e.g., as shown in FIG. 29, or any other duration of time). The default transmission periodicity may be a periodicity, for example, before a wireless device may receive a SIB1 message for initial access of the cell. For example, the base station, with 20 ms transmission periodicity of SSB (or SSB burst), may send/transmit the SSB burst in the first 5 ms of each 20 ms period. The base station may not send/transmit the SSB burst in the rest 15 ms of the each 20 ms period.

A base station may send/transmit RRC messages (e.g., SIB1 messages) indicating cell specific configuration parameters of SSB transmission. The cell specific configuration parameters may comprise a value for a transmission periodicity (e.g., parameter ssb-PeriodicityServingCell) of an SSB burst and locations (e.g., presence) of SSBs (e.g., active SSBs), of a plurality of candidate SSBs, in the SSB burst. The plurality of candidate SSBs (e.g., starting symbols of candidate SSBs) may be determined as described with respect to FIG. 28. The cell specific configuration parameters may comprise a position indication of an SSB in an SSB burst (e.g., parameter ssb-PositionsInBurst). The position indication may comprise a first bitmap (e.g., groupPresence) and a second bitmap (e.g., inOneGroup) indicating locations/presence of SSBs in an SSB burst.

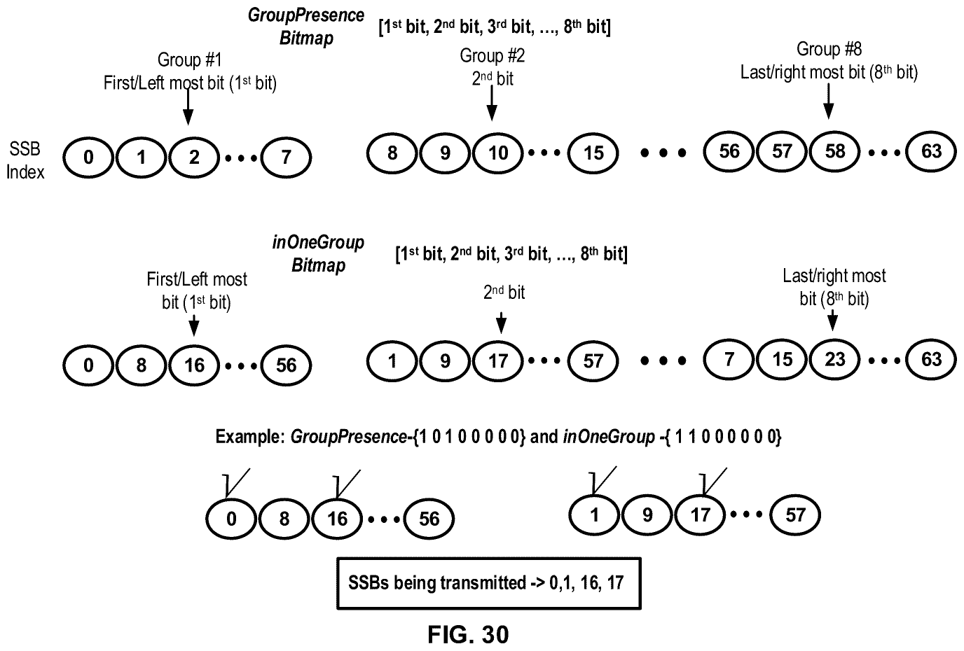

Carrier frequency f_{c} and SCS may determine a maximum quantity of candidate SSBs in an SSB burst (e.g., as described with respect to FIG. 28). The position indication (e.g., parameter ssb-PositionsInBurst) may indicate SSBs (e.g., active SSBs, positions of the active SSBs), of a plurality of candidate SSBs, that are sent/transmitted in the SSB burst (e.g., as further described with respect to FIG. 30). A base station may indicate the transmitted active SSBs and/or a quantity of the active SSBs, in an SSB burst, using the position indication (e.g., parameter ssb-PositionsInBurst). The position indication may be transmitted by the base station, for example, via an RRC message and/or DCI.

FIG. 30 shows an example of SSB transmissions of a base station. Indication of SSB location may be in form of an indication of a presence of an SSB group among a plurality of SSB groups. Each group may comprise a subset of a plurality of candidate SSBs (e.g., maximum possible quantity of candidate SSBs) in an SSB burst. For example, a maximum possible quantity of candidate SSBs in an SSB burst may be equal to 64 (e.g., for SCS=120 kHz or 240 kHz, and f_{c}>6 GHz). The candidate SSBs in the SSB burst may comprise SSBs with indexes from 0 to 63. The candidate SSBs in an SSB burst may be divided into SSB groups.

A first bitmap (e.g., parameter groupPresence) may comprise a quantity of bits (e.g., 8, or any other quantity). The first bitmap may be configured/indicated by the SIB1 message. Each bit of the first bitmap may correspond to a respective group of SSB groups. As shown in FIG. 30, a first bit (e.g., left most bit of the first bitmap) may correspond to a first SSB group comprising first SSB (with SSB index 0), second SSB (with SSB index 1), . . . and 8^{th} SSB (with SSB index 7). A second bit (e.g., the second bit of the first bitmap) may correspond to a second SSB group comprising 9^{th} SSB (with SSB index 8), 10^{th} SSB (with SSB index 9), . . . and 16th SSB (with SSB index 15). A last bit (e.g., right most bit of the first bitmap) may correspond to an 8^{th} SSB group comprising 57^{th} SSB (with SSB index 56), 58^{th} SSB (with SSB index 57), . . . and 6 fourth SSB (with SSB index 63), etc. An SSB may belong/correspond to at most one SSB group of the first SSB groups. A bit, of the first bitmap, may indicate whether the base station may send/transmit an SSB group, corresponding to the bit, in an SSB burst. The bit being set to a first value (e.g., 1) may indicate that the corresponding SSB group may be sent/transmitted in the SSB burst by the base station. The bit being set to a second value (e.g., 0) may indicate that the corresponding SSB group is not sent/transmitted in the SSB burst by the base station, or vice versa.

A second bitmap (e.g., parameter inOneGroup) may comprise a quantity of bits (e.g., 8, or any other quantity). Each bit of the second bitmap may correspond to a respective group of SSB groups. A first bit (e.g., left most bit of the second bitmap) may correspond to a first SSB group comprising first SSB (with SSB index 0), second SSB (with SSB index 8), . . . and 8^{th} SSB (with SSB index 56). A second bit (e.g., the second bit of the second bitmap) may correspond to a second SSB group comprising first SSB (with SSB index 1), second SSB (with SSB index 9), . . . and 8^{th} SSB (with SSB index 57). A last bit (e.g., right most bit of the second bitmap) may correspond to an 8^{th} SSB group comprising first SSB (with SSB index 7), second SSB (with SSB index 15), . . . and 8^{th} SSB (with SSB index 63), etc. An SSB may belong/correspond to at most one SSB group of the second SSB groups. A bit, of the second bitmap, may indicate whether the base station may send/transmit an SSB group, corresponding to the bit, in an SSB burst. The bit being set to a first value (e.g., 1) may indicate that the corresponding SSB group is sent/transmitted in the SSB burst by the base station. The bit being set to a second value (e.g., 0) may indicate that the corresponding SSB group is not sent/transmitted in the SSB burst by the base station, or vice versa.

The plurality of SSBs (e.g., with SSB index from 0 to 63) may be grouped, for the first bitmap, into first SSB groups. Each of the first SSB groups may comprise SSBs with continuous SSB indexes. A first SSB group of the first SSB groups may comprise SSBs with SSB indexes from 0 to 7, a second SSB group may comprise SSB indexes from 8 to 15, etc. The plurality of SSBs may be also grouped, for the second bitmap, into second SSB groups. Each of the second SSB groups may comprise SSBs with discontinuous SSB indexes. A first SSB group of the second SSB groups may comprise SSBs with SSB indexes {0, 8, 16, . . . 56}. A second SSB group of the second SSB groups comprises SSBs with SSB indexes {1, 9, 17, . . . 57}, etc. SSB index gap between two neighboring SSB indexes in a second SSB group may be equal to 8 (or any other value).

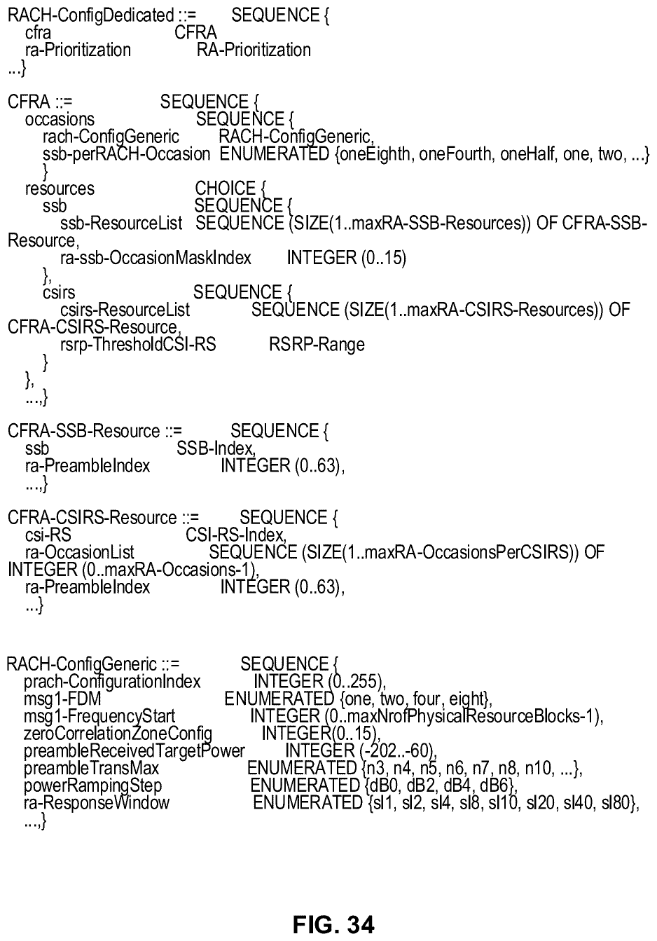

Not all bits of the first and the second bitmap may be considered for determining an SSB group is sent/transmitted or not. A maximum quantity of SSBs within an SSB burst may be equal to four if fc≤3 GHz (e.g., in accordance with FIG. 34). A wireless device may determine that the four leftmost bits of a bitmap (e.g., the first bitmap and/or the second bitmap) are valid. The wireless device may ignore the four rightmost bits of the first bitmap and/or the second bitmap.

As shown in FIG. 30, the first bitmap may be indicated, by the base station, as {1 0 1 0 0 0 0 0} and the second bitmap may be indicated as {1 0 0 0 0 0 0}. The base station may send/transmit SSBs with indexes {0 1 16 17} in an SSB burst, for example, based on the grouping configuration of the first SSB groups and the second SSB groups and further based on the first bitmap and the second bitmap.

A base station may send/transmit a MIB via PBCH. The MIB may indicate configuration parameters (e.g., for CORESET 0), for a wireless device monitoring a PDCCH, for scheduling a SIB1 message. The base station may send/transmit a MIB message with a transmission periodicity of 80 ms (or with any other first periodicity). The same MIB message may be repeated (according to SSB periodicity) within the 80 ms. Contents of the MIB message may be the same over the 80 ms period. The same MIB may be sent/transmitted over all SSBs within an SSB burst. The PBCH transmission (e.g., MIB) may indicate that there is no associated SIB1. A wireless device may be pointed to/indicated another frequency from where to search for an SSB that is associated with a SIB1 as well as a frequency range where the wireless device may assume no SSB associated with SIB1 is present, for example, if the PBCH transmission indicates that there is no associated SIB1. The indicated frequency range may be confined within a contiguous spectrum allocation of the same operator in which SSB is detected.

A base station may send/transmit a SIB1 message with a periodicity of 160 ms (or with any other second periodicity). The base station may transmit the same SIB1 message with variable transmission repetition periodicity within 160 ms. A default transmission repetition periodicity of SIB1 may be 20 ms (or any other third periodicity). The base station may determine an actual transmission repetition periodicity based on network implementation. SIB1 repetition transmission period may be 20 ms, for example, for SSB and CORESET multiplexing pattern 1. SIB1 transmission repetition period may be the same as the SSB period, for example, for SSB and CORESET multiplexing patterns 2 or 3. SIB1 may comprise information regarding availability and scheduling (e.g., mapping of SIBs to system information (SI) message, periodicity, SI window size) of other SIBs and/or an indication whether one or more SIBs are only provided on demand. Configuration parameters needed by a wireless device to perform an SI request may be indicated in the SIB1 if the one or more SIBs are only provided on demand.

A base station may be equipped with multiple transmission reception points (TRPs) to improve spectrum efficiency and/or transmission robustness. The base station may transmit DL signals/channels via intra-cell multiple TRPs and/or via inter-cell multiple TRPs. A base station may be equipped with more than one TRP. A first TRP may be physically located at a different place from a second TRP. The first TRP may be connected with the second TRP via a backhaul link (e.g., wired link or wireless link), the backhaul link being ideal backhaul link with zero or neglectable transmission latency, or the backhaul link being non-ideal backhaul link. A first TRP may be implemented with antenna elements, RF chain and/or baseband processor independently configured/managed from a second TRP.

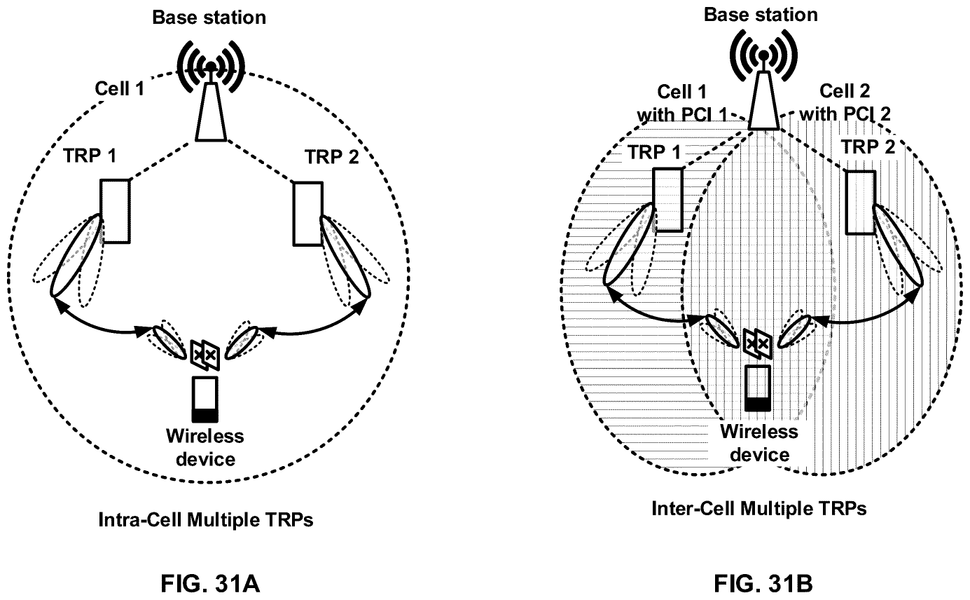

FIG. 31A and FIG. 31B show examples of multiple transmission and reception point (TRP) configurations. FIG. 31A shows an example of a communication between a base station (equipped with multiple TRPs) and a wireless device (equipped with single panel or multiple panels) based on intra-cell TRPs. Transmission and reception with multiple TRPs may improve system throughput and/or transmission robustness for a wireless communication in a high frequency (e.g., above 6 GHz). The multiple TRPs may be associated with a same physical cell identifier (PCI). Multiple TRPs on which PDCCH/PDSCH/PUCCH/PUSCH resources of a cell are shared may be referred to as intra-cell TRPs (or intra-PCI TRPs).

A TRP of multiple TRPs of the base station may be indicated/identified by at least one of: a TRP identifier (ID), a virtual cell index, or a reference signal index (or group index). In an example, in a cell, a TRP may be identified by a control resource set (coreset) group (or pool) index (e.g., CORESETPoolIndex as shown in FIG. 26) of a coreset group from which DCI is transmitted from the base station on a coreset. A TRP ID of a TRP may comprise a TRP index indicated in the DCI. A TRP ID of a TRP may comprise a TCI state group index of a TCI state group. A TCI state group may comprise at least one TCI state with which the wireless device receives the downlink TBs, or with which the base station transmits the downlink TBs.

A base station may transmit to a wireless device one or more RRC messages comprising configuration parameters of a plurality of CORESETs on a cell (or a BWP of the cell). One of the plurality of CORESETs (e.g., each of the plurality of CORESETs) may be identified with a CORESET index and may be associated with (or configured with) a CORESET pool (or group) index. One or more CORESETs, of the plurality of CORESETs, having a same CORESET pool index may indicate that DCIs received on the one or more CORESETs are transmitted from a same TRP of a plurality of TRPs of the base station. The wireless device may determine receiving beams (or spatial domain filters) for PDCCHs/PDSCHs based on a TCI indication (e.g., DCI) and a CORESET pool index associated with a CORESET for the DCI.

A wireless device may receive multiple PDCCHs scheduling fully/partially/non-overlapped PDSCHs in time and frequency domain, for example, if the wireless device receives one or more RRC messages (e.g., PDCCH-Config IE) comprising a first CORESET pool index (e.g., CORESETPoolIndex) value and a second CORESET pool index in ControlResourceSet IE. The wireless device may determine the reception of full/partially overlapped PDSCHs in time domain only when PDCCHs that schedule two PDSCHs are associated to different ControlResourceSets having different values of CORESETPoolIndex.

A wireless device may assume (or determine) that the ControlResourceSet is assigned with CORESETPoolIndex as 0 for a ControlResourceSet without CORESETPoolIndex. Scheduling information for receiving a PDSCH is indicated and carried only by the corresponding PDCCH, for example, if the wireless device is scheduled with full/partially/non-overlapped PDSCHs in time and frequency domain. The wireless device may be expected to be scheduled with the same active BWP and the same SCS. A wireless device can be scheduled with at most two codewords simultaneously when the wireless device is scheduled with full/partially overlapped PDSCHs in time and frequency domain.

The wireless device may be allowed to the following operations, for example, if PDCCHs that schedule two PDSCHs are associated to different ControlResourceSets having different values of CORESETPoolIndex: for any two HARQ process IDs in a given scheduled cell, if the wireless device is scheduled to start receiving a first PDSCH starting in symbol j by a PDCCH associated with a value of CORESETpoolIndex ending in symbol i, the wireless device can be scheduled to receive a PDSCH starting earlier than the end of the first PDSCH with a PDCCH associated with a different value of CORESETpoolIndex that ends later than symbol i; in a given scheduled cell, the wireless device can receive a first PDSCH in slot i, with the corresponding HARQ-ACK assigned to be transmitted in slot j, and a second PDSCH associated with a value of CORESETpoolIndex different from that of the first PDSCH starting later than the first PDSCH with its corresponding HARQ-ACK assigned to be transmitted in a slot before slot j.

For example, if a wireless device configured by higher layer parameter PDCCH-Config that contains two different values of CORESETPoolIndex in ControlResourceSet, for both cases, when tci-PresentInDCI is set to ‘enabled’ and tci-PresentInDCI is not configured in RRC connected mode, for example, if the offset between the reception of the DL DCI and the corresponding PDSCH is less than the threshold timeDurationForQCL, the wireless device may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the wireless device. For example, if the offset between the reception of the DL DCI and the corresponding PDSCH is less than the threshold timeDurationForQCL and at least one configured TCI states for the serving cell of scheduled PDSCH contains the ‘QCL-TypeD’, and at least one TCI codepoint indicates two TCI states, the wireless device may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states.

FIG. 31B shows an example of a communication between a base station (equipped with multiple TRPs) and a wireless device (equipped with single panel or multiple panels) based on inter-cell TRPs (or inter-PCI TRPs). In this case, the multiple TRPs may be associated with different PCIs. The multiple TRPs may be associated with (or belong to) different physical cells (Cell 1 with PCI 1 and Cell 2 with PCI 2), which may be referred to as inter-cell TRPs (or inter-PCI TRPs). A cell may be a serving cell or a non-serving (neighbor) cell of the wireless device. A base station may configure Cell 2 with PCI 2 as a part of Cell 1 with PCI 1 (e.g., a second TRP with a second PCI different from a first PCI of a first TRP), in which case, the wireless device may receive first SSBs from Cell lwith PCI 1 and receive second SSBs from Cell 2 with PCI 2, for example, if operating the inter-cell TRPs for a wireless device. The first SSBs and the second SSBs may have different configuration parameters, wherein the configuration parameters may be implemented such as described herein with respect to FIG. 28, FIG. 29 and/or FIG. 30. With the inter-cell TRPs, the wireless device may receive PDCCHs/PDSCHs and/or transmit PUCCH/PUSCHs on Cell 1 with PCI1 and Cell 2 with PCI 2 with different TCI states (e.g., one being associated with one of the first SSBs, another being associated with one of the second SSBs, etc.).

A serving cell may be a cell (e.g., PCell, SCell, PSCell, etc.) on which the wireless device receives SSB/CSI-RS/PDCCH/PDSCH and/or transmits PUCCH/PUSCH/SRS etc. The serving cell may be identified by a serving cell index (e.g., ServCellIndex or SCellIndex configured in RRC message). For a wireless device in RRC_CONNECTED not configured with CA/DC, there may only be one serving cell comprising of the primary cell. For a wireless device in RRC_CONNECTED configured with CA/DC the term ‘serving cells’ may be used to denote the set of cells comprising of the Special Cell(s) and all secondary cells. For a wireless device configured with CA, a cell providing additional radio resources on top of Special Cell may be referred to as a secondary cell. A non-serving (or neighbor) cell may be a cell on which the wireless device does not receive MIBs/SIBs/PDCCH/PDSCH and/or does not transmit PUCCH/PUSCH/SRS etc. The non-serving cell may have a physical cell identifier (PCI) different from a PCI of a serving cell. The non-serving cell may not be identified by (or associated with) a serving cell index (e.g., ServCellIndex or SCellIndex). The wireless device may rely on a SSB of a non-serving cell for Tx/Rx beam (or spatial domain filter) determination (for PDCCH/PDSCH/PUCCH/PUSCH/CSI-RS/SRS for a serving cell, etc.), for example, if a TCI state of the serving cell is associated with (e.g., in TCI-state IE of TS 38.331) a SSB of the non-serving cell. The base station may not transmit RRC messages configuring resources of PDCCH/PDSCH/PUCCH/PUSCH/SRS of a non-serving cell for the wireless device.

For a specific wireless device, Cell 1 may be a serving cell and may be associated with a first TRP (TRP 1). Cell 2 may be a non-serving (or neighbor) cell and may be associated with a second TRP. A base station may transmit to a wireless device one or more RRC messages comprising configuration parameters of Cell 1. The configuration parameters of Cell 1 may indicate a plurality of additional PCI configurations (e.g., SSB-MTC-AdditionalPCI IE) for a plurality of (non-serving or neighbor) cells for cell 1, each additional PCI configuration corresponding to a (non-serving or neighbor) cell having a PCI different from the PCI value of the serving cell, and comprising: an additional PCI index (AdditionalPCIIndex) identifying the additional PCI configuration, a PCI of the non-serving cell, a SSB periodicity indication, position indications of (candidate) SSBs in a SSB burst, a transmission power indication of SSBs, etc. The configuration parameter of Cell 1 may further indicate a plurality of TCI states. A TCI state (e.g., each TCI state) of the plurality of TCI states may be associated with one or more TCI parameters comprising a TCI state identifier identifying the TCI state, one or more QCL information parameters comprising a SSB index identifying the SSB and a QCL type indicator indicating a QCL type of a plurality of QCL types, for example, if the SSB is transmitted via Cell 1 (or in another serving cell). For example, if a SSB of a TCI state is transmitted via a non-serving (neighbor) cell, the TCI state may be further associated with an additional PCI index (AdditionalPCIIndex) indicating a (non-serving or neighbor) cell configured in the SSB-MTC-AdditionalPCI IE. Similar to intra-cell multiple TRPs, the wireless device may receive downlink signals and/or transmit uplink signals based on a TCI state (activated/indicated) associated with a TRP. A difference between intra-cell multiple TRPs and inter-cell multiple TRPs may be that a reference RS of a TCI state for a serving cell may come from (or be transmitted via) a (non-serving or neighbor) cell for the latter cases. A SSB may be implemented based on examples described herein with respect to FIG. 28, FIG. 29 and/or FIG. 30.

Cell 1 may be a serving cell for a wireless device. Cell 2 may be a (non-serving or neighbor) cell associated with Cell 1 for the wireless device. Cell 2 may be a serving cell for a second wireless device. Cell 1 may be a (non-serving or neighbor) cell for the second wireless device. Different wireless devices may have different serving cells and non-serving/neighbor cells.

The base station may use both TRPs for transmissions via Cell 1 to a wireless device. The base station may indicate (by DCI/MAC CE) a first TCI state associated with an SSB/CSI-RS transmitted via Cell 1 (or another serving cell) for a first transmission (via PDCCH/PDSCH/PUSCH/PUCCH/SRS resources of Cell 1) to the wireless device. The base station may indicate (by the same DCI/MAC CE or another DCI/MAC CE) a second TCI state associated with a second SSB transmitted via Cell 2 (which is the non-serving/neighbor) cell indicated by AdditionalPCIIndex in TCI configuration parameters) for a second transmission (via PDCCH/PDSCH/PUSCH/PUCCH/SRS resources of Cell 1) to the wireless device. The second SSB transmitted via Cell 2 may be different from the first SSB transmitted via Cell 1. Using two TCI states from two TRPs (one may be from a serving cell and another may be from a non-serving/neighbor cell) may avoid executing time-consuming handover (HO) between Cell 1 to Cell 2 and improve coverage if the wireless device is moving at the edge of Cell 1 and Cell 2.

A wireless device may be provided two TCI states, each TCI state corresponding to a TRP of multiple TRPs (e.g., such as described with respect to FIGS. 31A and 31B). A TCI state may be referred to as a channel-specific TCI state, when the TCI state is used for a specific channel (e.g., PDSCH/PDCCH/PUCCH/PUSCH), where different channels may be associated with different channel-specific TCI states. A TCI state may be referred to as a unified TCI state, when the TCI state is used for multiple channels (e.g., PDSCH/PDCCH/PUCCH/PUSCH), where different channels may be associated with the same unified TCI state. The base station may transmit RRC messages indicating whether a TCI state is a unified TCI state for the wireless device.

A base station may perform data/signaling transmissions based on intra-cell multiple TRPs (e.g., which may be referred to as Intra-cell M-TRP or Intra-PCI M-TRP) for a wireless device, for example, if the wireless device is close to the center of a cell, has more data to deliver and/or requires high reliability (e.g., for URLLC service), for example, such as described with respect to FIGS. 31 and 31B. The base station may perform data/signaling transmissions based on inter-cell multiple TRPs (e.g., which may be referred to as Inter-cell M-TRP or Inter-PCI M-TRP) for a wireless device, for example, when the wireless device is at the edge of a cell and is (moving or located) in the coverage of another cell (which may be or may not be a serving cell of the wireless device).

In at least some technologies, a base station may enable a power saving operation for a wireless device due to limited battery capacity of the wireless device, for example, based on BWP management (e.g., such as described with respect to FIG. 22), SCell dormancy mechanism, wake-up/go-to-sleep indication, SSSG switching on an active BWP, and/or PDCCH skipping.

A base station may not be able to save energy from the viewpoint of the base station, (e.g., if the base station is required to send/transmit some always-on downlink signals periodically (e.g., SSB, MIB, SIB1, SIB2, periodic CSI-RS, etc.) in some time period even for which there is no active wireless device sending/transmitting to and/or receiving from the base station), for example, if indicating a power saving operation for a wireless device. The base station may be required to send/transmit some always-on downlink signals periodically (e.g., SSB, MIB, SIB1, SIB2, periodic CSI-RS, etc.), for example, if the base station transitions a cell into a dormant state by switching an active BWP to a dormant BWP of the cell.

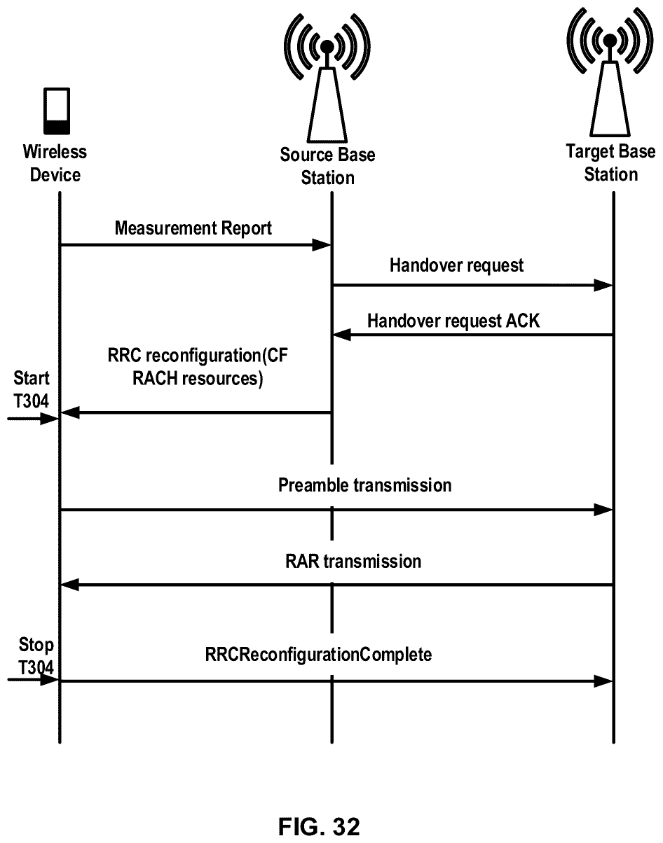

A base station may send/transmit an RRC message (e.g., SIB1) indicating a longer periodicity for the always-on downlink signal transmission, for example, if the base station needs to reduce periodicity of the always-on downlink signal transmission. A base station may send/transmit RRC reconfiguration messages to a wireless device in a source cell (e.g., each wireless device in a source cell) to indicate a handover to a neighbor cell, for example, before determining to power off (e.g., both RF modules and base band units (BBUs)) for energy saving. A handover (HO) procedure may be implemented (e.g., such as described herein with respect to FIG. 32).

FIG. 32 shows an example of layer 3 based handover procedure. FIG. 32 shows an example of executing HO procedure from a source base station (e.g., gNB) to a target base station for a wireless device.

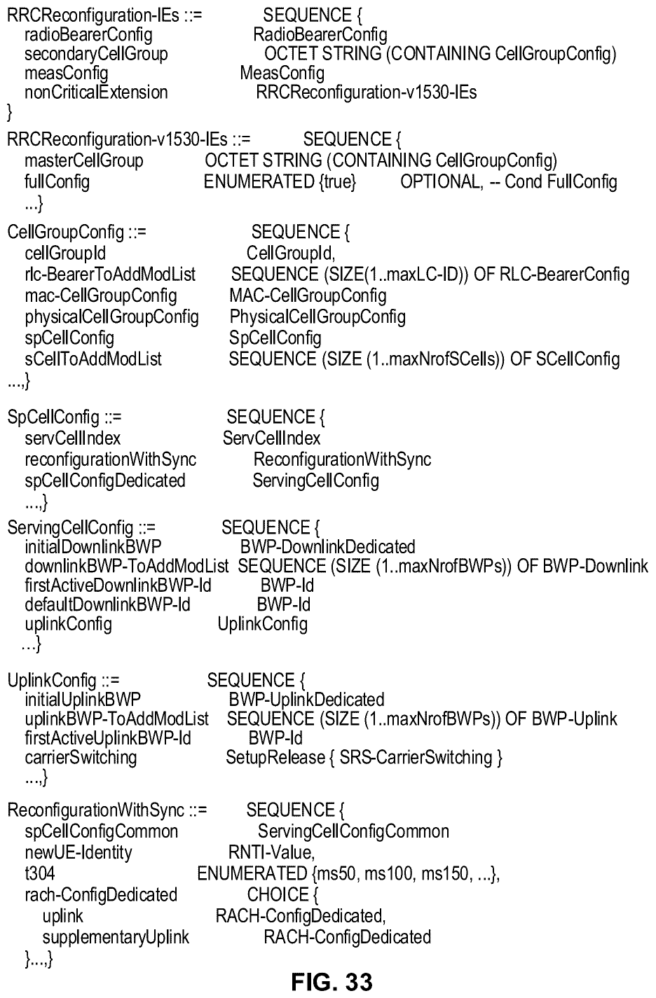

For network-controlled mobility in RRC_CONNECTED, the PCell may be changed using an RRC connection reconfiguration message (e.g., RRCReconfiguration) including reconfigurationWithSync (in NR specifications) or mobilityControllnfo in LTE specifications (handover). The SCell(s) may be changed using the RRC connection reconfiguration message either with or without the reconfigurationWithSync or mobilityControllnfo. The network may trigger the HO procedure, for example, based on radio conditions, load, QoS, UE category, and/or the like. The RRC connection reconfiguration message may be implemented such as described herein with respect to FIG. 33 and FIG. 34.

The network may configure the wireless device to perform measurement reporting (possibly including the configuration of measurement gaps (MG)). The measurement reporting is a layer 3 reporting, different from layer 1 CSI reporting. The wireless device may transmit one or more measurement reports to the source base station (e.g., gNB) (and/or source PCell). The network may initiate HO blindly, for example without having received measurement reports from the wireless device. The source base station (e.g., gNB) may prepare one or more target cells, for example, before sending the HO message to the wireless device. The source base station (e.g., gNB) may select a target PCell.

The source base station (e.g., gNB) may provide the target base station with a list of best cells on each frequency for which measurement information is available (e.g., in order of decreasing RSRP values), for example, based on the one or more measurement reports from the wireless device. The source base station may also include available measurement information for the cells provided in the list. The target base station may decide which cells are configured for use after HO, which may include cells other than the ones indicated by the source base station. The source base station may transmit a HO request to the target base station. The target base station may response with a HO message. In the HO message, the target base station may indicate access stratum configuration to be used in the target cell(s) for the wireless device.

The source base station (e.g., gNB) may transparently (e.g., by not altering values/content) forward the HO message/information received from the target base station to the wireless device. In the HO message, RACH resource configuration may be configured for the wireless device to access a cell in the target base station. When appropriate, the source base station may initiate data forwarding for (a subset of) the dedicated radio bearers.

The wireless device may start a HO timer (e.g., T304) with an initial timer value, for example, after receiving the HO message. The HO timer may be configured in the HO message. Based on the HO message, the wireless device may apply the RRC parameters of a target PCell and/or a cell group (MCG/SCG) associated with the target PCell of the target base station and perform downlink synchronization to the target base station. After or in response to performing downlink synchronization (e.g., searching a suitable/detectable SSB from candidate SSBs configured on the target base station, such as described with respect to FIG. 29 and/or FIG. 30) to the target base station, the wireless device may initiate a random access (e.g., contention-free, or contention-based, such as described with respect to FIG. 13A, FIG. 13B and/or FIG. 13C) procedure attempting to access the target gNB at the available RACH occasion according to a RACH resource selection, where the available RACH occasion may be configured in the RACH resource configuration (e.g., such as described herein with respect to FIG. 34). RAN may ensure the preamble is available from the first RACH occasion the wireless device may use, for example, if allocating a dedicated preamble for the random access in the target gNB.

The wireless device may activate the uplink BWP configured with firstActiveUplinkBWP-id and/or the downlink BWP configured with firstActiveDownlinkBWP-id on the target PCell upon performing HO to the target PCell. The wireless device may perform UL synchronization by conducting RACH procedure, for example, based on applying the RRC parameters of a target PCell and/or completing the downlink synchronization with the target PCell (e.g., such as described with respect to FIG. 13A, FIG. 13B and/or FIG. 13C). The performing UL synchronization may comprise transmitting a preamble via an active uplink BWP (e.g., a BWP configured as firstActiveUplinkBWP-id such as described with respect to FIG. 33) of uplink BWPs of the target PCell, monitoring PDCCH on an active downlink BWP (e.g., a BWP configured as firstActiveDownlinkBWP-id such as described with respect to FIG. 33) for receiving a RAR comprising a TA which is used for PUSCH/PUCCH transmission via the target PCell, receiving the RAR and/or obtaining the TA. The wireless device may obtain the TA to be used for PUSCH/PUCCH transmission via the target PCell, for example, based on (e.g., after) completing the UL synchronization. The wireless device, for example, by using the TA to adjust uplink transmission timing, may transmit PUSCH/PUCCH via the target PCell. The adjusting uplink transmission timing may comprise advancing or delaying the transmissions by an amount indicated by a value of the TA, for example, to ensure the uplink signals received at the target PCell are aligned (in time domain) with uplink signals transmitted from other wireless devices.

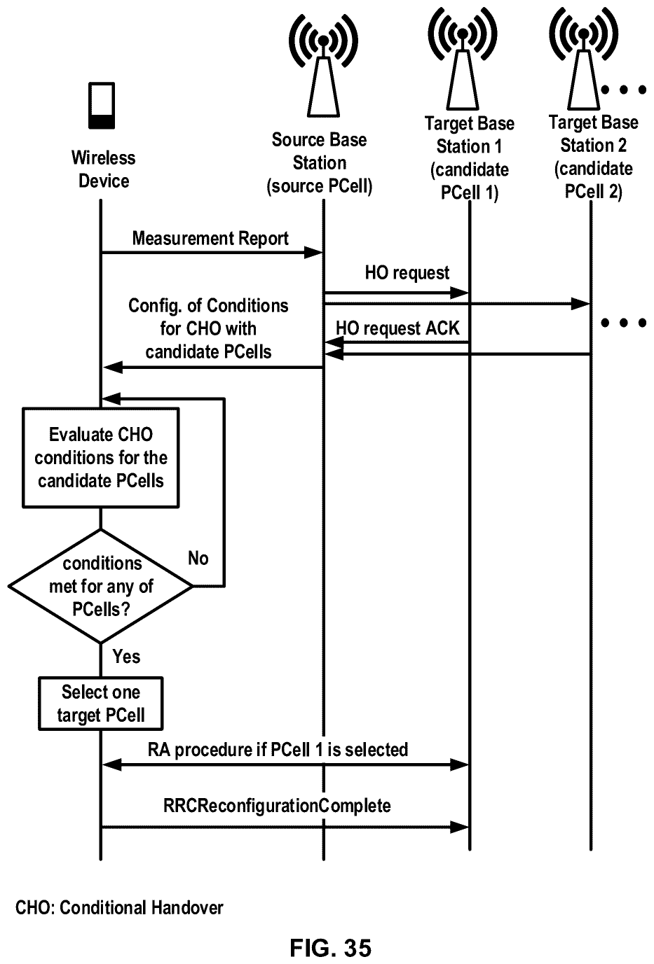

The wireless device may release RRC configuration parameters of the source PCell and an MCG/SCG associated with the source PCell. A HO triggered by receiving a RRC reconfiguration message (e.g., RRCReconfiguration) comprising the HO command/message (e.g., by including reconfigurationWithSync (in NR specifications) or mobilityControllnfo in LTE specifications (handover)) is referred to as a normal HO, an unconditional HO, which is in contrast with a conditional HO (CHO) which is described herein with respect to FIG. 35.

The wireless device may transmit a preamble to the target base station (e.g., gNB) via a RACH resource. The RACH resource may be selected from a plurality of RACH resources (e.g., configured in rach-ConfigDedicated IE such as descried with respect to FIG. 33 and FIG. 34) based on SSBs/CSI-RSs measurements of the target base station. The wireless device may select a (best) SSB/CSI-RS of the configured SSBs/CSI-RSs of the target gNB. The wireless device may select a SSB/CSI-RS, from the configured SSBs/CSI-RSs of the target base station (e.g., gNB), with a RSRP value greater than a RSRP threshold configured for the RA procedure. The wireless device then determines a RACH occasion (e.g., time domain resources, etc.) associated with the selected SSB/CSI-RS and determines the preamble associated with the selected SSB/CSI-RS.

The target base station (e.g., gNB) may receive the preamble transmitted from the wireless device. The target base station may transmit a random access response (RAR) to the wireless device, where the RAR comprises the preamble transmitted by the wireless device. The RAR may further comprise a TAC to be used for uplink transmission via the target PCell. The wireless device may complete the random access procedure, for example, based on (e.g., in response to) receiving the RAR comprising the preamble. The wireless device may stop the HO timer (T304), for example, based on (e.g., in response to) completing the random access procedure. The wireless device may transmit an RRC reconfiguration complete message to the target base station, after completing the random access procedure, or before completing the random access procedure. The wireless device, after completing the random access procedure towards the target base station, may apply first parts of CQI reporting configuration, SR configuration and SRS configuration that do not require the wireless device to know a system frame number (SFN) of the target base station. The wireless device may apply second parts of measurement and radio resource configuration that require the wireless device to know the SFN of the target base station (e.g., MGs, periodic CQI reporting, SR configuration, SRS configuration), upon acquiring the SFN of the target base station, for example, based on (e.g., after or in response to) completing the random access procedure towards the target PCell.

For network energy saving purposes, a base station may instruct each wireless device in a source cell to perform a 4-step or 2-step RACH-based (contention free) HO to a neighbor cell, for example, based on HO procedure. After the wireless devices complete the HO procedure to neighbor cells, the base station may turn off (RF parts and BBUs, etc.) for energy saving.

FIG. 33 shows an example of a radio resource control (RRC) message for layer 3 based handover. FIG. 33 shows an example of RRC message for HO. A base station may transmit, and/or a wireless device may receive, an RRC reconfiguration message (e.g., RRCReconfiguration-IEs) indicating an RRC connection modification. It may convey information for measurement configuration, mobility control, radio resource configuration (including RBs, MAC main configuration and physical channel configuration) and AS security configuration. The RRC reconfiguration message may comprise a configuration of a master cell group (masterCellGroup). The master cell group may be associated with a SpCell (SpCellConfig). When the SpCellConfig comprises a reconfiguration with Sync (reconfigurationWithSync), the wireless device determines that the SpCell is a target PCell for the HO. The reconfiguration with sync (reconfigurationWithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. In an example, a dedicated RACH resource may comprise one or more RACH occasions, one or more SSBs, one or more CSI-RSs, one or more RA preamble indexes, etc.

FIG. 34 shows an example of an RRC message for layer 3 based handover. FIG. 34 shows an example of RRC messages for RACH resource configuration for HO procedure. The reconfigurationWithSync IE comprises a dedicated RACH resource indicated by a rach-ConfigDedicated IE (e.g., such as described with respect to FIG. 33).

An IE such as a rach-ConfigDedicated IE may comprise a contention free RA resource indicated by a CFRA IE. The cfra IE may comprise a plurality of occasions indicated by a rach-ConfigGeneric IE, a ssb-perRACH-Occasion IE, a plurality of resources associated with SSB (indicated by a ssb IE) and/or CSI-RS (indicated by a csirs IE). An IE such as a ssb-perRACH-Occasion IE may indicate a number of SSBs per RACH occasion. An IE such as a rach-ConfigGeneric IE may indicate configuration of CFRA occasions. The wireless device may ignore preambleReceivedTargetPower, preambleTransMax, powerRampingStep, ra-ResponseWindow signaled within this field and use the corresponding values provided in RACH-ConfigCommon.

The resources (resources IE) comprise the ssb IE, for example, if the plurality of resources for the CFRA configured in the reconfigurationWithSync IE are associated with SSBs. The ssb IE may comprise a list of CFRA SSB resources (ssb-ResourceList) and an indication of PRACH occasion mask index (ra-ssb-OccasionMaskIndex). One or more of the list of CFRA SSB resources (e.g., each of the list of CFRA SSB resources) may comprise a SSB index, a RA preamble index, etc. The ra-ssb-OccasionMaskIndex may indicate a PRACH mask index for RA resource selection. The mask may be valid for all SSB resources signaled in ssb-ResourceList.

The resources (resources IE) may comprise the csirs IE, for example, if the plurality of resources for the CFRA configured in the reconfigurationWithSync IE are associated with CSI-RSs. The csirs IE may comprise a list of CFRA CSI-RS resources (csirs-ResourceList) and a RSRP threshold (rsrp-ThresholdCSI-RS). One or more of the list of CFRA CSI-RS resources (e.g., each of the list of CFRA CSI-RS resources) may comprise a CSI-RS index, a list of RA occasions (ra-OccasionList), a RA preamble index, etc.

Executing the HO triggered by receiving a RRC reconfiguration message comprising a reconfigurationWithSync IE may introduce HO latency (e.g., too-late HO), for example, if a wireless device is moving in a network deployed with multiple small cells (e.g., with hundreds of meters of cell coverage of a cell). An improved HO mechanism, based on measurement event triggering, is proposed to reduce the HO latency such as described herein with respect to FIG. 35.

FIG. 35 shows an example of layer 3 based conditional handover procedure. FIG. 35 shows an example of a conditional handover (CHO) procedure. In an example the network (e.g., a base station, a source gNB) may configure the wireless device to perform measurement reporting (possibly including the configuration of MGs) for a plurality of neighbor cells (e.g., cells from a candidate target base station 1, a candidate target base station 2, etc.). The measurement reporting may be a layer 3 reporting, different from layer 1 CSI reporting. The wireless device may transmit one or more measurement reports 4105 to the source base station (e.g., gNB) (or source PCell).

The source base station (e.g., gNB) may provide the target base station with a list of best cells on each frequency for which measurement information is available, for example, in order of decreasing RSRP, for example, based on the one or more measurement reports from the wireless device. The source base station may also include available measurement information for the cells provided in the list. The target base station may decide which cells are configured for use after the CHO, which may include cells other than the ones indicated by the source base station. In an example the source base station may transmit a HO 4110 request to the target base station. The target base station may respond with a HO message 4115. In the HO message, for example, the target base station may indicate access stratum configuration (e.g., RRC configurations of the target cells) to be used in the target cell(s) for the wireless device.

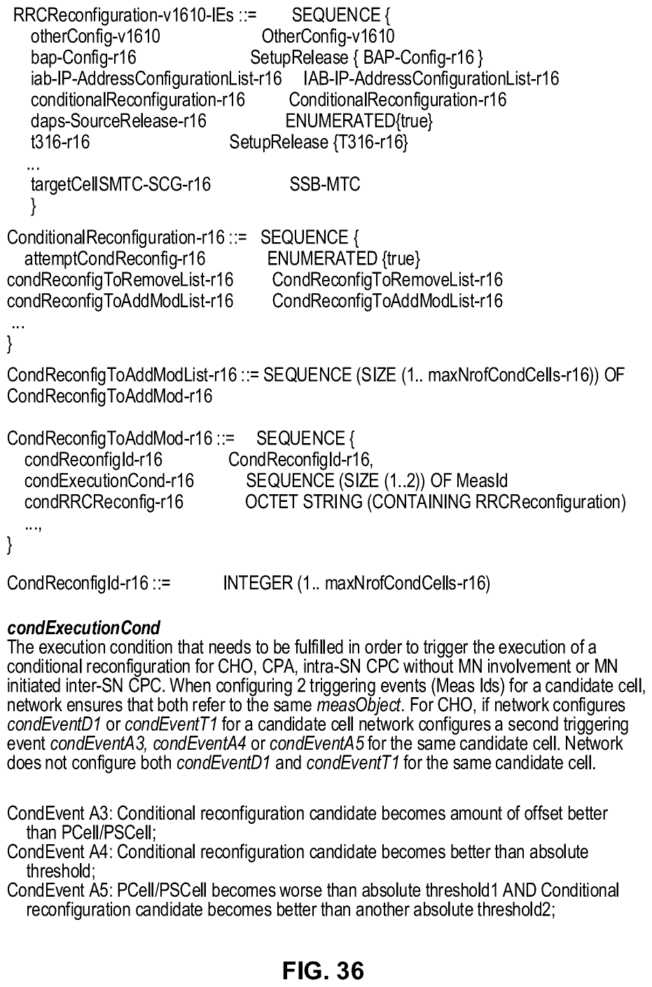

The source base station (e.g., gNB) may transparently (e.g., by not altering values/content) forward the handover (e.g., contained in RRC reconfiguration messages of the target base station) message/information received from the target base station to the wireless device. The source base station may configure a CHO procedure different from a normal HO procedure 4120 (e.g., such as described with respect to FIG. 32, FIG. 33 and/or FIG. 34), by comprising a conditional reconfiguration message (e.g., conditionalReconfiguration IE in RRC reconfiguration message, which will be described later in FIG. 36). The conditional reconfiguration message may comprise a list of candidate target PCells, each candidate target PCell being associated with dedicated RACH resources for the RA procedure in case a CHO is executed to the candidate target PCell. A CHO execution condition (or RRC reconfiguration condition) may also be configured for each of the candidate target PCells, etc. A CHO execution condition may comprise a measurement event A3 where a candidate target PCell becomes amount of offset better than the current PCell (e.g., the PCell of the source gNB), a measurement event A4 where a candidate target PCell becomes better than absolute threshold configured in the RRC reconfiguration message, a measurement event A5 where the current PCell becomes worse than a first absolute threshold, and a candidate target PCell becomes better than a second absolute threshold, etc.

The wireless device, according to the received RRC reconfiguration messages comprising parameters of a CHO procedure, may evaluate 4125 the (RRC) reconfiguration conditions for the list of candidate target PCells and/or the current/source PCell. The wireless device may measure RSRP/RSRQ of SSBs/CSI-RSs of each candidate target PCell of the list of candidate target PCells. Different from the normal HO procedure described with respect to FIG. 32, the wireless device may not execute the HO to the target PCell in response to receiving the RRC reconfiguration messages comprising the parameters of the CHO procedure. The wireless device may execute the HO to a target PCell for the CHO, for example, if the (RRC) reconfiguration condition(s) of the target PCell are met (or satisfied) 4130. The wireless device may keep evaluating the reconfiguration conditions for the list of the candidate target PCells 4125, for example, until an expiry of a HO timer, or receiving a RRC reconfiguration indicating an abort of the CHO procedure.

The wireless device may execute the CHO procedure towards the first candidate target PCell, for example, based on (e.g., in response to) a reconfiguration condition of a first candidate target PCell (e.g., PCell 1) being met or satisfied. The wireless device may select one of multiple candidate target PCells 4135 by its implementation when the multiple candidate target PCells have reconfiguration conditions satisfied or met.

Executing the CHO procedure towards the first candidate target PCell may be the same as or similar to executing the HO procedure such as described with respect to FIG. 32. By executing the CHO procedure, the wireless device may release RRC configuration parameters of the source PCell and the MCG associated with the source PCell, apply the RRC configuration parameters of the PCell 1, reset MAC, perform cell group configuration for the received MCG comprised in the RRC reconfiguration message of the PCell 1, and/or perform RA procedure to the PCell 1 4140, etc.

The MCG of the RRC reconfiguration message of the PCell 1 may be associated with a SpCell (SpCellConfig) on the target base station 1. The wireless device may determine that the SpCell is a target PCell (PCell 1) for the HO, for example, if the sPCellConfig comprises a reconfiguration with Sync (reconfigurationWithSync). The reconfiguration with sync (reconfigurationWithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. A dedicated RACH resource may comprise one or more RACH occasions, one or more SSBs, one or more CSI-RSs, one or more RA preamble indexes, etc. The wireless device may perform cell group configuration for the received master cell group comprised in the RRC reconfiguration message 4145 (e.g., RRCReconfigurationComplete) of the PCell 1 on the target base station 1 such as described with respect to FIG. 32.

FIG. 36 shows an example of an RRC message for layer based conditional handover procedure. FIG. 36 shows an example of RRC message for CHO. A base station may transmit, and/or a wireless device may receive, a RRC reconfiguration message (e.g., RRCReconfiguration-V1610-IEs) indicating an RRC connection modification. The RRC reconfiguration message may be comprised in a (parent) RRC reconfiguration message (e.g., RRCReconfiguration-IEs) such as described with respect to FIG. 33, where the (parent) RRC reconfiguration message may comprise (L3 beam/cell) measurement configuration (e.g., measConfig IE).

The RRC reconfiguration message (e.g., RRCReconfiguration-V1610-IEs) may comprise a conditional reconfiguration IE (conditionalReconfiguration IE). The conditional reconfiguration IE may comprise a list of conditional reconfigurations (condReconfigToAddModList). Each conditional reconfiguration corresponds to a respective candidate target cell (PCell) of a list of candidate target cells. For each conditional reconfiguration of the list of conditional reconfigurations, the base station may indicate one or more measurement events (condExecutionCond) for triggering the CHO on the candidate target PCell, a RRC reconfiguration message (condRRCReconfig) of a candidate target cell (PCell) which is received by the source base station (e.g., gNB) from the target base station via X2/Xn interface. The RRC reconfiguration message of the candidate target cell may be implemented such as described with respect to FIG. 33 and/or FIG. 34. The RRC reconfiguration message may comprise a configuration of a master cell group (masterCellGroup) for the target base station. The master cell group may be associated with a SpCell (SpCellConfig). The SpCell may be a target PCell for executing the CHO, for example, if the sPCellConfig comprises a reconfiguration with Sync (reconfigurationWithSync). The reconfiguration with sync (reconfigurationWithSync) may comprise cell common parameters (spCellConfigCommon) of the target PCell, a RNTI (newUE-Identity) identifying the wireless device in the target PCell, a value of T304, a dedicated RACH resource (rach-ConfigDedicated), etc. A dedicated RACH resource may comprise one or more RACH occasions, one or more SSBs, one or more CSI-RSs, one or more RA preamble indexes, etc.

A measurement event (condExecutionCond) for triggering the CHO on the candidate target PCell may be an execution condition that needs to be fulfilled (at the wireless device) in order to trigger the execution of a conditional reconfiguration for CHO. The indication of the measurement event may point to a measurement ID (MeasId) which identifies a measurement configuration of a plurality of measurement configurations (e.g., comprised in measConfig IE) configured by the source base station. The measurement configuration may be associated with a measurement event (or a conditional event) of a plurality of measurements. A conditional event may comprise a conditional event A3, conditional event A4, and/or conditional event A5, etc. A conditional event A3 is that a candidate target PCell becomes amount of offset better than the current PCell (e.g., the PCell of the source gNB). A conditional event A4 is that a candidate target PCell becomes better than an absolute threshold configured in the RRC reconfiguration message. A conditional event A5 is that the current PCell becomes worse than a first absolute threshold and a candidate target PCell becomes better than a second absolute threshold, etc.

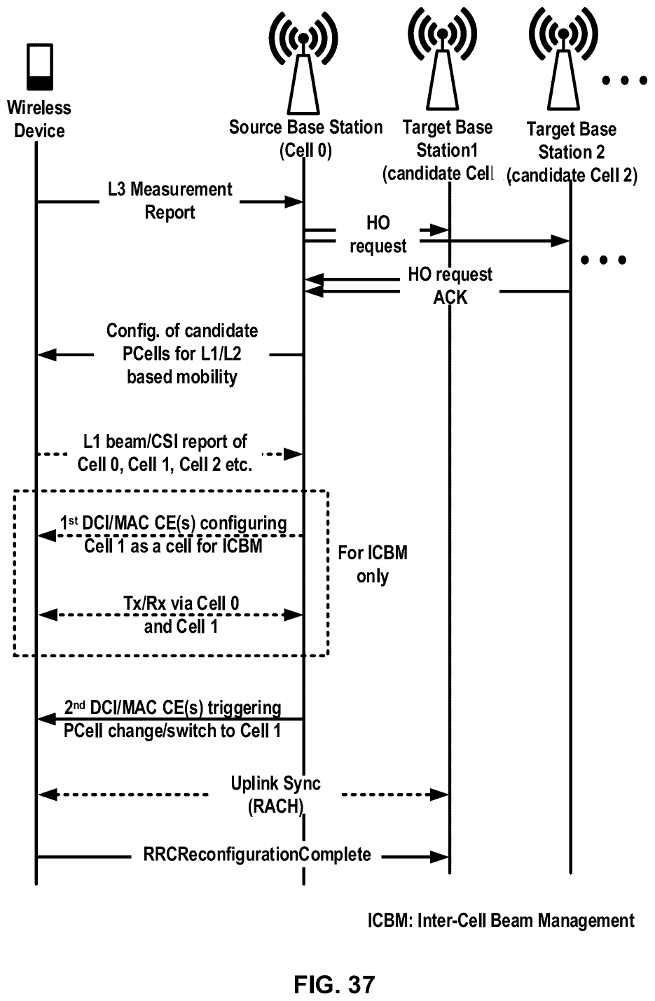

Executing CHO by the wireless device's decision based on evaluating reconfiguration conditions (long-term and/or layer 3 beam/cell measurements against one or more configured thresholds) on a plurality of candidate target cells may cause load unbalanced on cells, and/or lead to CHO failure in case that the target cell changes its configuration (e.g., for network energy saving) during the CHO condition evaluation, etc. An improved handover based on layer 1 or layer 2 signaling triggering is described herein with respect to FIG. 37. A layer 1 or layer 2 triggered handover may be referred to a layer 1 or layer 2 triggered mobility (LTM) procedure. A layer 1 signaling may comprise DCI transmitted via a PDCCH. A layer 2 signaling may comprise a MAC CE scheduled by DCI. Layer 1 or layer 2 signaling is different from Layer 3 signaling, for HO/CHO, which comprises RRC reconfiguration message.

FIG. 37 shows an example of layer 1 or layer 2 based handover. For example, FIG. 37 shows an example of layer 1 or layer 2 triggered HO procedure. For example. FIG. 37 shows an example of layer 1 or layer triggered mobility. The network (e.g., a base station, a source gNB) may configure the wireless device to perform measurement reporting (possibly including the configuration of MGs) for a plurality of neighbor cells (e.g., cells from a candidate target base station 1, a candidate target base station 2, etc.). The measurement reporting may be a layer 3 reporting, different from layer 1 CSI reporting. The wireless device may transmit one or more measurement reports to the source base station (or source PCell, cell 0 in FIG. 37).

The source base station (e.g., gNB) may provide the target base station with a list of best cells on each frequency for which measurement information is available, for example, in order of decreasing RSRP, for example, based on the one or more measurement reports from the wireless device. The source base station may also include available measurement information for the cells provided in the list. The target base station may decide which cells are configured for use (as a target PCell, and/or one or more SCells) after HO, which may include cells other than the ones indicated by the source base station. The source base station may transmit a HO request to the target base station. The target base station may response with a HO message. In the HO message, the target base station may indicate access stratum configuration (e.g., RRC configurations of the target cells) to be used in the target cell(s) for the wireless device.

The source base station may transparently (e.g., by not altering values/content) forward the HO (e.g., contained in RRC reconfiguration messages of the target base station, cell group configuration IE of the target base station, and/or SpCell configuration IE of a target PCell/SCells of the target gNB) message/information received from the target base station to the wireless device.

The source base station may configure a layer 1 or layer 2 signaling based HO (PCell switching/changing, mobility, etc.) procedure different from a normal HO procedure (e.g., such as described with respect to FIG. 32, FIG. 33 and/or FIG. 34) and/or a CHO procedure (e.g., such as described with respect to FIG. 35 and/or FIG. 36), by comprising a layer 1 or layer 2 candidate PCell configuration message (e.g., a newly defined candidates-L1L2-Config IE) in RRC reconfiguration message of the source gNB. The layer 1 or layer 2 candidate PCell configuration message may comprise a list of candidate target PCells, each candidate target PCell being associated with dedicated RACH resources for the RA procedure in case a layer 1 or layer 2 signaling based HO is trigged by a layer 1 or layer 2 signaling and executed to the candidate target PCell, etc. There may be multiple options for parameter configurations of a candidate target PCell.

As a first option for the parameter configuration, for each candidate target PCell, the RRC reconfiguration message of the source gNB may comprise a (capsuled) RRC reconfiguration message (e.g., RRCReconfiguration), of a candidate target base station (e.g., gNB), received by the source base station from a candidate target base station via X2/Xn interface. The (capsuled) RRC reconfiguration message, of the candidate target gNB, may reuse the same signaling structure of the RRC reconfiguration message of the source base station, such as described with respect to FIG. 33 and/or FIG. 34.

As a second option for the parameter configuration, for each candidate target PCell, the RRC reconfiguration message of the source base station (e.g., gNB) may comprise a (capsuled) cell group configuration message (e.g., CellGroupConfig), of a candidate target base station, received by the source base station from a candidate target gNB via X2/Xn interface. The (capsuled) cell group configuration message, of the candidate target gNB, may reuse the same signaling structure of the cell group configuration message of the source gNB, such as described with respect to FIG. 33 and/or FIG. 34. The second option may reduce signaling overhead of the parameter configuration of a candidate target PCell compared with the first option.

As a third option for the parameter configuration, for each candidate target PCell, the RRC reconfiguration message of the source base station (e.g., gNB) may comprise a (capsuled) SpCell configuration message (e.g., SpCellConfig), of a candidate target base station, received by the source base station from a candidate target base station via X2/Xn interface. The (capsuled) SpCell configuration message, of the candidate target base station, may reuse the same signaling structure of the SpCell configuration message of the source base station, such as described with respect to FIG. 33 and/or FIG. 34. The third option may reduce signaling overhead of the parameter configuration of a candidate target PCell compared with the second option.

For a candidate target PCell (e.g., each candidate target PCell), the source base station may indicate cell common and/or wireless-device-specific parameters (e.g., SSBs/CSI-RSs, BWPs, RACH resources, PDCCH/PDSCH/PUCCH/PUSCH resources etc.). The wireless device, according to the received RRC reconfiguration messages comprising parameters of a layer 1 or layer 2 signaling based HO procedure, may perform layer 1 or layer 2 measurement report (CSI/beam) for the list of candidate target PCells and/or the current PCell. The layer 1 or layer 2 measurement report may comprise layer 1 RSRP, layer 1 RSRQ, PMI, RI, layer 1 SINR, CQI, etc. The layer 1 or layer 2 measurement report may be transmitted with a periodicity configured by the source gNB. The layer 1 or layer 2 measurement report may be triggered when the measurement of the CSI/beam of a candidate target PCell is greater than a threshold, or (amount of offset) greater than the current PCell, etc.

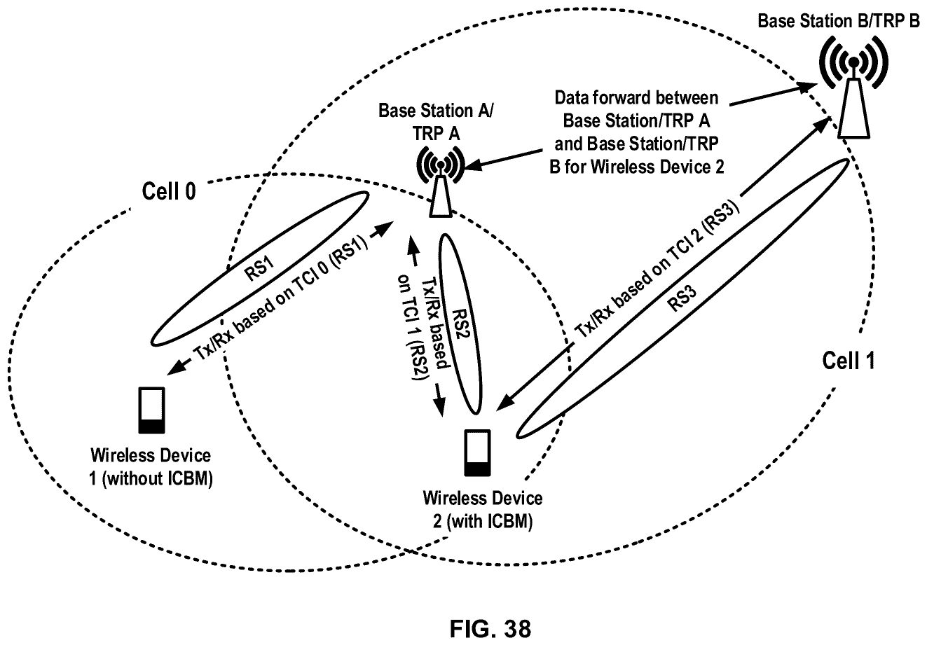

The base station may perform an inter-cell beam management (ICBM) procedure before transmitting a layer 1 or layer 2 signaling triggering the HO procedure comprising switching PCell from the source base station (e.g., gNB) to a target base station. The ICBM procedure may allow the base station and the wireless device to use resources (time/frequency/spatial) of the target base station (or a PCell/SCell of the target base station) without executing HO procedure to the target base station, therefore reducing frequently executing the HO procedure. The ICBM procedure may allow the base station and the wireless device to synchronize time/frequency/beam to a target PCell of the target base station before executing the HO, which may reduce HO latency. The ICBM may be implemented such as described herein with respect to FIG. 38.

The source gNB may transmit to the wireless device a first DCI/MAC CE configuring/indicating a first candidate target cell (e.g., Cell 1) of the candidate target cells (PCells/SCells) as a neighbor or non-serving cell, in addition to the current PCell (e.g., Cell 0), for the wireless device, for example, based on (e.g., in response to) the ICBM procedure being configured. The base station may select the first candidate target cell from the candidate target cells, based on layer 1 or layer 2 measurement report from the wireless device.

The first DCI/MAC CE (e.g., activating TCI states) may indicate that a reference RS (e.g., SSB/CSI-RS) associated with a first TCI state is from the first candidate target cell (Cell 1) (e.g., by associating the reference RS with an additional PCI, of Cell1, different from a PCI of the Cell 0), in addition to a reference RS associated with a second TCI state being from the current PCell (Cell 0). Association between a reference signal and a TCI state may be implemented based on examples described above with respect to FIG. 31B. Activating, by DCI and/or MAC CE, a TCI state with a RS of a neighbor (non-serving) cell as a reference RS, may allow the base station to use a beam of the neighbor cell to transmit downlink signals/channels or to receive uplink signals/channels, and/or use a beam of the current cell for the transmissions/receptions, without performing HO to the neighbor cell for the transmissions/receptions.

The wireless device may apply the first TCI state and the second TCI state for downlink reception and/or uplink transmission, for example, based on (e.g., in response to) receiving the first DCI/MAC CE. Applying the first TCI state and the second TCI state for downlink reception may comprise: receiving (from Cell 1) PDCCH/PDSCH/CSI-RS with a reception beam/filter same as that for receiving the reference signal, transmitted from Cell 1, according to (or associated with) the first TCI state, and receiving (from cell 0) PDCCH/PDSCH/CSI-RS with a reception beam/filter same as that for receiving the reference signal, transmitted from Cell 0, according to (or associated with) the second TCI state. Applying the first TCI state and the second TCI state for uplink transmission may comprise: transmitting (via Cell 1) PUCCH/PUSCH/SRS with a transmission beam/filter same as that for receiving the reference signal, transmitted from Cell 1, according to (or associated with) the first TCI state, and transmitting (via cell 0) PUCCH/PUSCH/SRS with a transmission beam/filter same as that for receiving the reference signal, transmitted from Cell 0, according to (or associated with) the second TCI state.

The base station may skip performing the ICBM procedure before transmitting the layer 1 or layer 2 signaling triggering the HO procedure. The base station may skip performing the ICBM procedure, for example, when beamforming is not used in the target PCell, if there is no good SSB(s) from the target PCell, if there is no available radio resources from the target PCell to accommodate the wireless device, and/or when the wireless device does not support ICBM and/or when the base station does not support ICBM.

The source base station may determine to handover the wireless device from the source base station (Cell 0) to the target base station (Cell 1). The source base station may determine the handover based on a load/traffic condition, a CSI/beam report of the target gNB, a location/trajectory of the wireless device, a network energy saving strategy (e.g., the source base station determines to turn of the Cell 0 and/or one or more SCells for power saving), etc.

The source base station may transmit a second DCI/MAC CE indicating a PCell changing from the current PCell (Cell 0) to a new cell (e.g., Cell 1). The new cell may be one of the neighbor (non-serving) cells used in the ICBM procedure (e.g., indicated by the first DCI/MAC CE). The new cell may be cell 1 in the example of FIG. 37. When the ICBM procedure is supported and/or configured, the wireless device, for example, before executing HO procedure indicated by the source base station, has already synchronized with the target base station regarding which beam should be used for transmission/reception via the target base station, which is different from layer 3 signaling based (C)HO (as shown in FIG. 32 and/or FIG. 35) where the wireless device needs to synchronize to the target base station upon executing the HO/CHO and then obtains an indication of a new beam to be used for the target gNB.

The new cell may be one of a plurality of neighbor (non-serving) cells comprised in L1 beam/CSI report, e.g., with the best measurement report, with the distance closest to the wireless device, etc., when the ICBM procedure is not configured/supported/indicated/activated for the new cell. The wireless device may change the PCell from cell 0 to cell 1, for example, based on (e.g., in response to) receiving the second DCI/MAC CE. The wireless device may apply the (stored/received) RRC parameters (comprised in RRCReconfiguration, CellGroupConfig, and/or SpCellConfig IE) of the target PCell (cell 1) as the current PCell.

The wireless device may skip downlink (time/frequency/beam) synchronization (e.g., monitoring MIB/SSB/SIBs and/or selecting a SSB as a reference for downlink reception and/or uplink transmission) in case the wireless device has already synchronized with the target PCell based on the ICBM procedure, for example, if the ICBM is configured/supported/indicated/activated before receiving the second DCI/MAC CE. The wireless device may skip performing RA procedure towards the target PCell before transmitting to and/or receiving from the target PCell, for example, when the target PCell is close to the source PCell, or the uplink TA is same or similar for the source PCell and the target PCell, or the dedicated RACH resource is not configured in the RRC reconfiguration message of the target PCell. The wireless device may perform downlink synchronization (SSB/PBCH/SIBs monitoring) and/or uplink synchronization (RA procedure) for the layer 1 or layer 2 signaling based HO (e.g., when ICBM is not configured/indicated/supported/activated) as it does for layer 3 signaling based HO/CHO such as described with respect to FIG. 32, FIG. 33, FIG. 34, FIG. 35 and/or FIG. 36.

FIG. 38 shows an example of inter-cell beam management. FIG. 38 shows an example of an ICBM procedure. A first wireless device (wireless device 1) may be in the coverage of Cell 0 deployed under a first node (e.g., base station A or TRP A). wireless device 1 is not in the coverage of Cell 1 deployed under a second node (e.g., base station B or TRP B). Cell 0 and Cell 1 have different PCIs. Wireless device 1 may use the RSs (e.g., RS1) transmitted from Cell 0 as a reference RS for a TCI state (which is used for beam/spatial domain filter determination for downlink reception and/or uplink transmission (Tx/Rx based TCI state 0 associated with RS1)). Wireless device 1 may not use RSs (e.g., RS2 and/or RS3) transmitted from Cell 1 as the reference RS for the TCI state. Wireless device 1 configured with a TCI state, associated with a RS of a serving cell with a first PCI and not associated with a RS of another cell with a second PCI different from the first PCI, may be referred to as a wireless device (e.g., UE) without (configured/activated) ICBM herein.

A second wireless device (wireless device 2) may be in the coverage of Cell 0 deployed under a first node (e.g., base station A or TRP A). Wireless device 2 is also in the coverage of Cell 1 deployed under a second node (e.g., base station B or TRP B). Cell 0 and Cell 1 have different PCIs. Wireless device 2 may use the RSs (e.g., RS2) transmitted from Cell 0 as a reference RS for a first TCI state (which is used for beam/spatial domain filter determination for downlink reception and/or uplink transmission via Cell 0 (Tx/Rx based TCI state 1 associated with RS2)). Wireless device 2 may use RSs (e.g., RS3) transmitted from Cell 1 as the reference RS for a second TCI state (which is used for beam/spatial domain filter determination for downlink reception and/or uplink transmission via Cell 1 (Tx/Rx based TCI state 2 associated with RS3)). Wireless device 2 configured with a first TCI state, associated with a RS of a serving cell with a first PCI and configured with a second TCI state associated with a RS of another cell with a second PCI different from the first PCI, may be referred to as a wireless device (e.g., UE) with (configured/activated) ICBM herein.

For example, if base station B or TRP B receives uplink signals/channels with the second TCI state, it may forward the uplink signals/channels to base station A or TRPA for processing. A base station such as base station A or TRP A may forward downlink signals/channels to base station B or TRP B to transmit with the second TCI state to the wireless device. Cell 1 with the second PCI different from the first PCI of Cell 0 may be considered/configured as a part (e.g., a second TRP with a second PCI different from a first PCI of a first TRP) of cell 0 for wireless device 2, for example, such as described with respect to FIG. 31B. Cell 0 and Cell 1 may belong to a same DU (or base station-DU (e.g., gNB0DU)) if, for example, Cell 1 is configured as the part of Cell 0. A base station-DU may be implemented, for example, based on examples described above with respect to FIG. 1A and/or FIG. 1B. The PDCCH/PDSCH/PUCCH/PUSCH resources may be shared between Cell 1 and Cell 0 in a way that is transparent to wireless device 2. SSBs/CSI-RSs of Cell 0 may not share the same resources with SSBs/CSI-RSs of Cell 1. SSBs/CSI-RSs of Cell 0 may have configuration parameters (e.g., number of beams, periodicity, transmission power, etc.) different than configuration parameters of SSBs/CSI-RSs of Cell 1.

Cell 1 with the second PCI different from the first PCI of Cell 0 may be considered/configured as a separate cell different from cell 0 for wireless device 2, for example, when Cell 1 is configured as a candidate target cell such as described with respect to FIG. 33 and/or FIG. 36. Cell 0 and Cell 1 may belong to different DUs (or base station-DUs (e.g., gNB-DUs)) associated with a same CU (or base station-CU (e.g., gNB-CU)) or different CUs if, for example, Cell 1 is configured as a sperate cell from Cell 0. A base station-DU and/or a base station-CU may be implemented, for example, based on examples described with respect to FIG. 1A and/or FIG. 1B. Cell resources (SSB/CSI-RS/PDCCH/PDSCH/PUCCH/PUSCH) may not be shared between Cell 1 and Cell 0. Cell 1 has configuration parameters, of the cell resources, different from (or independent of) configuration parameters of the cell resources of Cell 0.

In at least some technologies, a base station may configure, for a wireless device, RRC configuration parameters (SSBs, RACH resources, MAC parameters, PHY cell common and/or UE-specific parameters, as shown in FIG. 33, FIG. 34 and/or FIG. 36) of a target PCell for performing (C)HO to the target PCell from a source PCell. When performing the (C)HO to the target PCell, the wireless device may use the received/stored RRC configuration parameters. The wireless device may start to perform downlink synchronization towards the target PCell (e.g., time/frequency alignment by monitoring the SSBs configured on the target PCell, e.g., according to 3GPP TS 38.213 Section 4—Synchronization procedures). The wireless device may start to perform uplink synchronization, for example, by initiating a (CF)RA procedure based on the RACH resources configured on the target PCell, for example, based on (e.g., after) the downlink synchronization is complete. The wireless device may receive a timing advance (TA) command in a RAR corresponding to a preamble transmitted by the wireless device.

In at least some technologies, for transmitting a preamble for the CFRA procedure, when multiple beams are used for SSB transmissions (e.g., such as described with respect to FIG. 29 and/or FIG. 30) by the base station, the wireless device may select, based on a RSRP value of a first SSB being greater than a RSRP threshold, the first SSB from a plurality of candidate SSBs configured in the RACH resources (e.g., such as described with respect to FIG. 34) on the target PCell. The wireless device may determine the preamble with a preamble index associated with the selected first SSB according to RACH resource configuration parameters. The wireless device may determine a next available PRACH occasion from PRACH occasions corresponding to the selected first SSB permitted by the restrictions given by the ra-ssb-OccasionMaskIndex configured in the rach-ConfigDedicated IE (e.g., such as described with respect to FIG. 34, for example, based on (e.g., after) selecting the first SSB. The wireless device may transmit the preamble via the determined PRACH occasion to the target PCell. The wireless device may monitor a PDCCH of the target PCell for receiving a RAR corresponding to the preamble. The wireless device may receive the RAR comprising the preamble index and/or a TA command. The wireless device may complete the CFRA procedure. The CFRA procedure may be implemented such as described with respect to FIG. 13B. The wireless device may receive, from the target PCell, a beam indication (or a TCI state indication) used for PDCCH/PDSCH/CSI-RS reception and/or PUCCH/PUSCH/SRS transmission for the target PCell, for example, based on (e.g., after) completing the CFRA procedure. The wireless device may apply the beam (or the TCI state) for PDCCH/PDSCH/CSI-RS reception and/or PUCCH/PUSCH/SRS transmission for the target PCell. In at least some technologies, the wireless device may perform downlink synchronization and uplink synchronization, beam alignment/management via a target PCell, for example, based on (e.g., after) receiving a HO command (e.g., RRC reconfiguration with a ReconfigurationWithSync IE). Performing downlink synchronization, uplink synchronization and/or beam alignment may be time consuming.

Configurations (e.g., RS configurations) for reporting (e.g., CSI reporting) (e.g., layer 1 CSI reporting) may be configured within a serving cell configuration of a cell (e.g., of each cell). The configurations may be configured in a message, for example, in an RRC message (e.g., ServingCellConfig). Different serving cells may be configured differently (e.g., with different RS configurations). A similar principle may be adopted for other HOs and CHOs (e.g., layer 3 based HO and CHO) such that each candidate cell may be configured with different configurations.

Some HO procedures (e.g., LTM procedures), however, may proceed differently. For example, in some HO procedures (e.g., LTM), the wireless device may perform a first measurement/reporting (e.g., layer 1 CSI measurement/reporting) for candidate cells prior to switching to one of the candidate cells as the PCell. Additionally or alternatively, a wireless device may perform subsequent HO (e.g., LTM) procedures, for example, to switch to a new PCell, after initial HO procedures, without reconfiguration (e.g., RRC reconfiguration) of the candidate cells. Using at least some wireless communications that support early reporting (e.g., CSI reporting) for HO procedures (e.g., initial and subsequent LTM procedures), for example, by configuring each candidate cell, may increase signaling overhead.

As described herein, it may be advantageous to, instead of configuring resources (e.g., RS resources) separately in each candidate cell, resource configuration for early reporting (e.g., a layer 1/layer 2 measurement and/or reporting of a candidate cell before switching to the candidate cell as a serving cell) of a HO procedure may be jointly configured (e.g., in a reference configuration, for example, a reference cell configuration) separate from a serving cell configuration and/or a candidate cell configuration. The resource configuration (e.g., the reference configuration) may comprise one or more portions (e.g., one or more SSBs). A portion (e.g., each of the one or more SSBs) may be associated with an index (e.g., a respective SSB index per each respective SSB), a cell indication of a candidate cell, and/or one or more resources (e.g., time and/or frequency resource(s)). The resource configuration (e.g., CSI resource configuration) may be applied for all candidate cells configured for the HO procedure (e.g., LTM). Accordingly, if the wireless device switches its PCell for an HO procedure (e.g., an initial and/or subsequent LTM procedure), the wireless device may obtain configuration information (e.g., RS configuration information), for example, for reporting, from the configuration information in the reference configuration. Using such jointly configured reference configurations may reduce signaling overhead in HO procedures (e.g., initial and/or subsequent LTM procedures). Additionally or alternatively, using such reference configurations may enable quicker HO among cells and may reduce HO latency, for example, the latency introduced for uplink synchronization, based on, for example, an early acquisition scheme (e.g., TA acquisition scheme) as described herein.

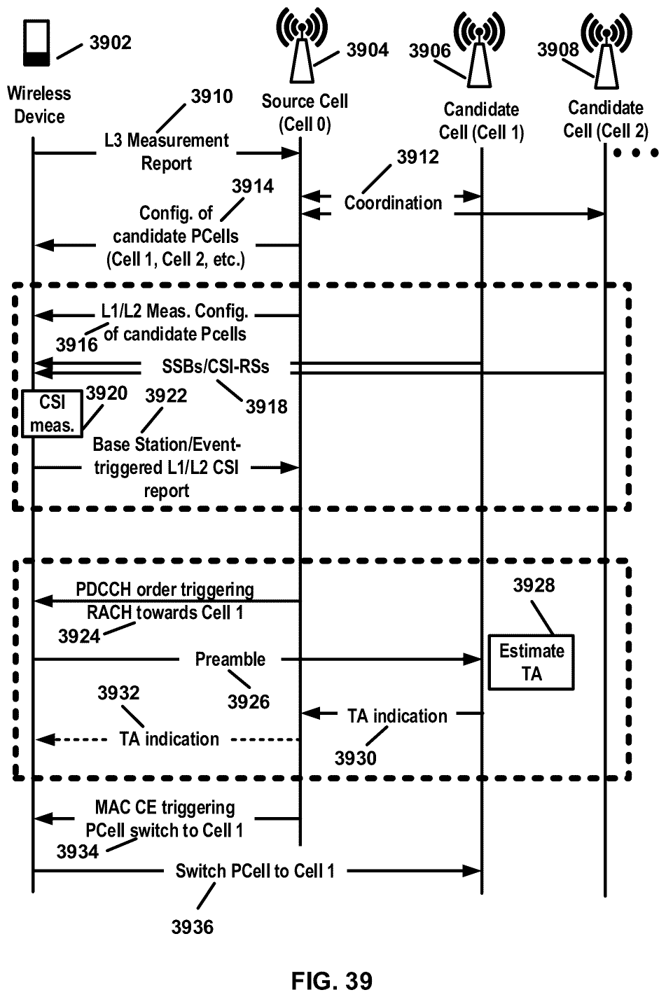

FIG. 39 shows an example of layer 1 or layer 2 triggered mobility with early CSI reporting. For example, FIG. 39 shows an example of early TA acquisition (or ETA)-based HO procedure. The network (e.g., a base station, a source gNB) may configure the wireless device 3902 to perform measurement reporting (e.g., layer 3 measurement reporting) (possibly including the configuration of MGs) for a plurality of neighbor cells (e.g., Cell 1 3906 from a candidate target base station 1, Cell 2 3908 from a candidate target base station 2, etc.), for example, as shown in FIG. 39. The measurement reporting may comprise a layer 3 reporting, different from layer 1 CSI reporting. At step 3910, the wireless device may send (e.g., transmit) one or more layer 3 measurement reports (e.g., in an RRC message) to the source base station (or source PCell, Cell 0 3904 in FIG. 39).

As shown in FIG. 39, at step 3912, the source base station may coordinate with the target base station(s). For example, the source base station may provide the target base station(s) with a list of best cells on each frequency for which measurement information is available, for example, based on the one or more measurement reports from the wireless device and in order of decreasing RSRP. The source base station may also include available measurement information for the cells provided in the list. The target base station may decide which cells are configured for use (e.g., as a target PCell, and/or one or more SCells), for example, after HO, which may include cells other than the ones indicated by the source base station.

The source base station may send (e.g., transmit) a HO request to the target base station (not shown in FIG. 39). The target base station may respond with a HO message. In the HO message, the target base station may indicate access stratum configuration (e.g., RRC configurations of the target cells) to be used in the target cell(s) for the wireless device.

At step 3914, the source base station may send (e.g., transmit), and/or the wireless device may receive, a layer 1 or layer 2 candidate PCell configuration message. For example, the source base station may configure a layer 1 or layer 2 signaling based HO (e.g., PCell switching/changing, mobility, LTM, etc.) procedure, different from a layer 3 based HO procedure (e.g., as shown in FIG. 32, FIG. 33, and/or FIG. 34) and/or a CHO procedure (e.g., as shown in FIG. 35 and/or FIG. 36), by comprising a layer 1 or layer 2 candidate PCell configuration message (e.g., a newly defined candidates-L1L2-Config IE) in an RRC reconfiguration message (e.g., config. of candidate PCells (Cell 1, Cell 2, etc.) as shown in FIG. 39) of the source base station. The layer 1 or layer 2 candidate PCell configuration message may comprise a list of candidate target PCells. Each candidate target PCell may be associated with dedicated RACH resources for the RA procedure, for example, in case a layer 1 or layer 2 signaling based HO is trigged by a layer 1 or layer 2 signaling and executed to the candidate target PCell, etc. There may be multiple options for parameter configurations of a candidate target PCell.

For example, as a first option for the parameter configuration, for each candidate target PCell, the RRC reconfiguration message sent (e.g., transmitted) from the source base station may comprise a (capsuled) RRC reconfiguration message (e.g., RRCReconfiguration), of a candidate target base station, received by the source base station from a candidate target base station, for example, via X2/Xn interface. The (capsuled) RRC reconfiguration message, of the candidate target base station, may reuse the same signaling structure of the RRC reconfiguration message of the source base station, as shown, for example, in FIG. 33 and/or FIG. 34.

As a second option for the parameter configuration, for each candidate target PCell, the RRC reconfiguration message sent (e.g., transmitted) from the source base station may comprise a (capsuled) cell group configuration message (e.g., CellGroupConfig), of a candidate target base station, received by the source base station from a candidate target base station, for example, via X2/Xn interface. The (capsuled) cell group configuration message, of the candidate target base station, may reuse the same signaling structure of the cell group configuration message of the source base station, for example, as shown in FIG. 33 and/or FIG. 34. The second option may reduce signaling overhead of the parameter configuration of a candidate target PCell compared with the first option.

As a third option for the parameter configuration, for each candidate target PCell, the RRC reconfiguration message sent (e.g., transmitted) from the source base station may comprise a (capsuled) SpCell configuration message (e.g., SpCellConfig), of a candidate target base station, received by the source base station from a candidate target base station, for example, via X2/Xn interface. The (capsuled) SpCell configuration message, of the candidate target base station, may reuse the same signaling structure of the SpCell configuration message of the source base station, for example, as shown in FIG. 33 and/or FIG. 34. The third option may reduce signaling overhead of the parameter configuration of a candidate target PCell compared with the second option.

For each candidate target PCell, the source base station may indicate, for example, in the RRC reconfiguration message, cell common and/or wireless device (e.g., UE) specific parameters (e.g., SSBs/CSI-RSs, BWPs, RACH resources, PDCCH/PDSCH/PUCCH/PUSCH resources etc.).

Cell 0, Cell 1 and/or Cell 2 may belong to a same base station-DU (e.g., gNB-DU), in which case, Cell 1 and/or Cell 2 may be configured as a part of Cell 0 (e.g., a serving cell). The radio resources (e.g., PDCCH, PDSCH etc.) of Cell 0 may be shared with Cell 1 and/or Cell 2. Cell 1 and/or Cell 2 may send (e.g., transmit) SSBs different from SSBs sent (e.g., transmitted) via Cell 0 (e.g., based on examples of FIG. 38). A base station-DU may be implemented based on examples described herein with respect to FIG. 1A and/or FIG. 1B.

Cell 0, Cell 1 and/or Cell 2 may belong to different base station-DUs (which may be associated with a same base station-CU (e.g., gNB-CU) or associated with different base station-CUs), in which case, Cell 1 and/or Cell 2 may be configured as sperate cells (non-serving cell) from Cell 0. The radio resources (e.g., PDCCH, PDSCH etc.) of Cell 0 may, in some configurations, not be shared with Cell 1 and/or Cell 2. Cell 1 and/or Cell 2 may send (e.g., transmit) SSBs different from SSBs sent (e.g., transmitted) via Cell 0 (e.g., based on examples of FIG. 38). A base station-DU and/or a base station-CU may be implemented based on examples described herein, for example, with respect to FIG. 1A and/or FIG. 1B.

The wireless device may perform layer 1 or layer 2 measurement reporting (e.g., CSI/beam) for the list of candidate target PCells and/or the current PCell. The layer 1 or layer 2 measurement report may comprise, for example, layer 1 RSRP, layer 1 RSRQ, PMI, RI, layer 1 SINR, CQI, etc., which may be different from layer 3 (e.g., L3) measurements as described herein. At step 3916, the base station may send (e.g., transmit) RRC configuration messages comprising configuration parameters of layer 1 or layer 2 measurements for one or more candidate cells, for example, in order to facilitate the wireless device to perform layer 1 or layer 2 measurements. The one or more candidate cells may be a subset of a plurality of candidate cells for which the wireless device reports L3 measurements to the base station.

The RRC configuration messages, for example, comprising configuration parameters of layer 1 or layer 2 measurements for one or more candidate cells, may be the same as the RRC messages used for L3 measurement configuration or be the same as the RRC configuration messages for the candidate PCell configuration as described herein. Additionally or alternatively, the RRC configuration messages, for example, comprising configuration parameters of layer 1 or layer 2 measurements for one or more candidate cells, may be separate and/or independent from the RRC configuration messages for the candidate PCell configuration as described herein. Additionally or alternatively, the RRC configuration messages, for example, comprising the configuration parameters of layer 1 or layer 2 measurements, may be the same as an RRC message configuring a serving cell (e.g., Cell 0 as shown in FIG. 39), which may comprise layer 1 or layer 2 measurement configurations of the serving cell.

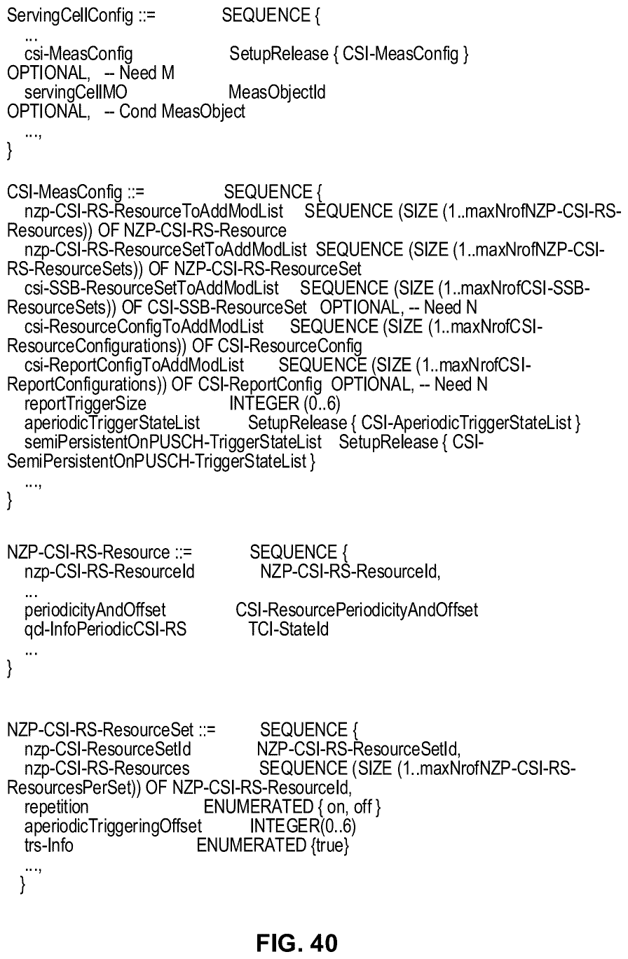

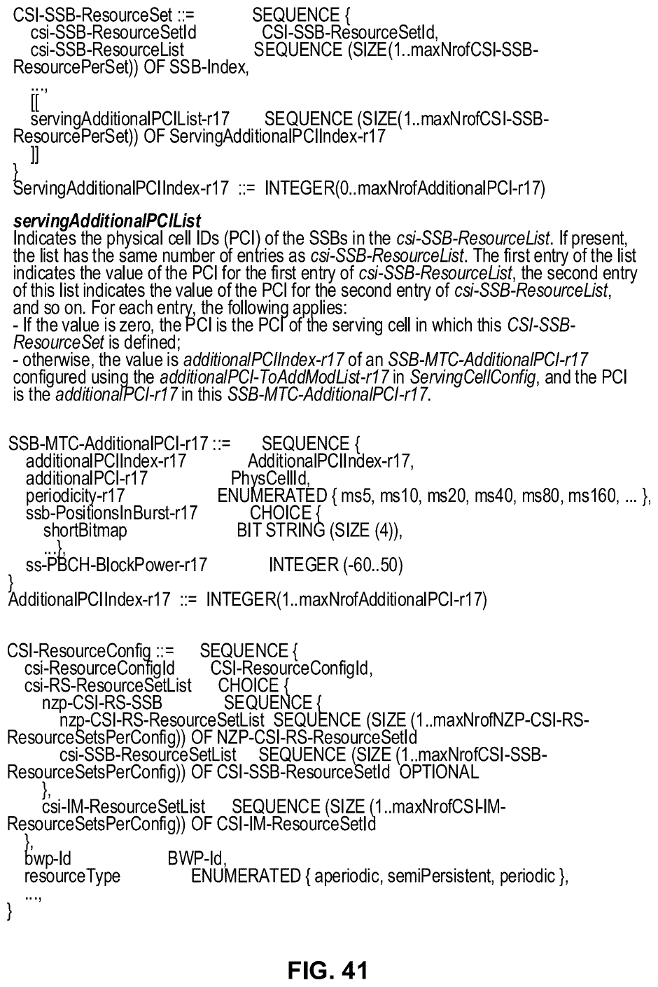

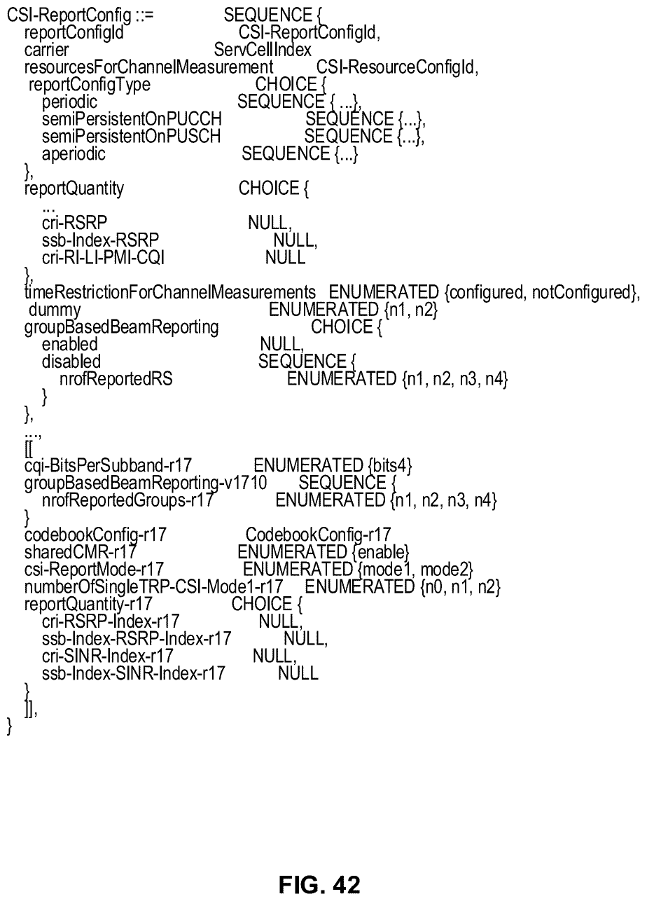

Layer 1 or layer 2 measurement configurations of a serving cell may be implemented based on, for example, examples of FIG. 40, FIG. 41, and/or FIG. 42 which are described herein. The layer 1 or layer 2 measurement configuration of the serving cell may comprise a plurality of SSB resource sets (e.g., CSI-SSB-ResourceSets) for CSI (e.g., CQI/PMI/RI/L1-RSRP/L1-SINR etc.) measurements. A CSI-SSB-ResourceSet may be identified by a CSI-SSB-Resource set identifier (ID) and may comprise a list of SSB indexes. Each SSB index may be associated with a ServingAdditionalPCIIndex indicating a physical cell ID of the SSB, among multiple SSBs associated with the ServingAdditionalPCIInex. If a value of the ServingAdditionalPCIIndex is zero, the PCI of the SSB index may be the PCI of the serving cell (e.g., Cell 0). If a value of the ServingAdditionalPCIIndex is not zero, the ServingAdditionalPCIIndex may indicate an additionalPCIIndex of an SSB-MTC-AdditionalPCI configured using the additionalPCI-ToAddModList in ServingCellConfig, and the PCI may be the additionalPCI (e.g., PCI of Cell 1, PCI of Cell 2, etc.) in the SSB-MTC-AdditionalPCI. A PCI of a cell may comprise a cell identifier uniquely identifying the cell in a wireless communication system. In an example, a CSI-SSB-Resourceset of Cell 0 may indicate SSB 0 from Cell 0, SSB 1 from Cell 1, SSB 2 from Cell 2, etc.

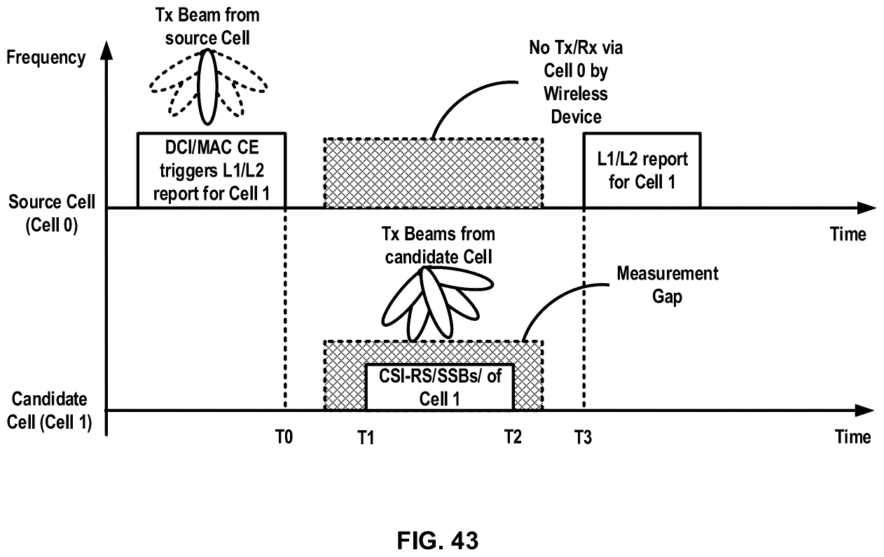

At step 3920, the wireless device may measure CSI (e.g., CQI/PMI/L1-RSRP/L1-RSRQ/L1-SINR) of each SSB of the SSBs configured in the CSI-SSB-ResourceSet of Cell 0, for example, based on the layer 1 or layer 2 measurement configurations of the serving cell (e.g., Cell 0). Each SSB may be from different cells (or different PCIs). The wireless device may measure SSB 0 from Cell 0, SSB 1 from Cell 1 and SSB 2 from Cell 2 for the L1/L2 CSI/beam measurement for the LTM procedure, for example, if a CSI-SSB-Resourceset of Cell 0 indicates SSB 0 is from Cell 0, SSB 1 is from Cell 1, SSB 2 is from Cell 2, etc. The wireless device may measure CSI based on, for example, examples of FIG. 43, which are described herein.

The wireless device may trigger a layer 1 or layer 2 measurement report, for example, based on the measuring CSI of each SSB of the SSBs configured in the CSI-SSB-ResourceSet of Cell 0. The triggering the layer 1 or layer 2 measurement report may be based on a triggering indication of the base station and/or a triggering event occurring at the wireless device.

The layer 1 or layer 2 measurement report may be triggered by a measurement event, for example, if the measurement of the CSI of a candidate target PCell (e.g., Cell 1, Cell 2 etc.) is greater than a threshold, or (amount of offset) greater than the current PCell (Cell 0), etc. Additionally or alternatively, the layer 1 or layer 2 measurement report may be triggered by receiving a triggering indication (e.g., a DCI or a MAC CE) indicating to report the layer 1 or layer 2 measurement of one or more candidate target PCells (e.g., Cell 1, Cell 2, etc.). At step 3922, the wireless device may (e.g., after performing the layer 1 or layer 2 measurement) send (e.g., transmit) the layer 1 or layer 2 measurement report indicating whether at least one candidate target PCell has better CSI measurement than the current PCell, for example, based on (e.g., after or in response to) receiving the triggering indication. The wireless device may skip sending (e.g., transmitting) the layer 1 or layer 2 measurement of candidate target PCell (e.g., Cell 1, Cell 2, etc.) or may send (e.g., transmit) only layer 1 or layer 2 CSI measurement of the serving cell (Cell 0), for example, based on (e.g., after or in response to) no candidate target PCell having better CSI measurement than the current PCell after receiving the triggering indication.

The layer 1 or layer 2 measurement report may be sent (e.g., transmitted) with a periodicity configured by the source base station. The layer 1 or layer 2 measurement report may be contained in a UCI, for example, via PUCCH/PUSCH, or a MAC CE (e.g., event-triggered, associated with a configured SR for the transmission of the MAC CE).

The layer 1 or layer 2 measurement and/or reporting of a candidate target PCell, for example, before actually switching to the candidate target PCell as a serving PCell, may be referred to as an early CSI report for a candidate target PCell, which may be different from a CSI report of a serving PCell. Early CSI reporting for a candidate target PCell, for example, before the wireless device performs a LTM procedure to switch to the candidate target PCell as the serving PCell, may enable the base station to obtain correct beam information, for example, in terms of which SSB can be used as beam reference for downlink sending (e.g., transmission) for the candidate target PCell. The latency (e.g., the HO latency) of the PCell switching may be improved, for example, if the wireless device later switches to the candidate target PCell as the serving PCell, for example, without waiting for beam management after the switching.

The wireless device may determine, for example, that Cell 1 has better channel quality (e.g., L1-RSRP/L1-SINR/L1-RSRQ, etc.) than Cell 0. The wireless device may send (e.g., transmit) the layer 1 or layer 2 measurement report indicating that Cell 1 has better channel quality than Cell 0.

The source base station and/or the target base station may determine which cell is used as the target PCell. The source base station may coordinate with the candidate target base station regarding whether Cell 1 could be used as a candidate target PCell for one or more future HOs, for example, upon receiving the layer 1 or layer 2 measurement report. This coordination (e.g., following step 3922) may be similar in some respects to the coordination described above in step 3912.

At step 3924, the source base station (e.g., according to the request of the target base station if there is no time alignment obtained before for Cell 1) may send (e.g., transmit), from Cell 0 (or, e.g., an activated SCell of the wireless device), a first layer 1 or layer 2 command (e.g., a DCI/MAC CE/RRC message comprising PDCCH order as shown, for example, in FIG. 39) triggering a preamble sending (e.g., transmission) (e.g., RACH, or other uplink signals like SRS) towards Cell 1, for example, based on a determination that Cell 1 is to be used as the target PCell for one or more future HOs. The DCI may be based on a PDCCH order in at least some technology.

At step 3926, the wireless device may send (e.g., transmit) the preamble (or SRS which is not shown in FIG. 39) to the target PCell (Cell 1), for example, based on (e.g., upon) receiving the first layer 1 or layer 2 command. At step 3928, the target base station may monitor PRACH occasion for receiving the preamble to estimate (e.g., determine) the TA used for future uplink sending (e.g., transmissions) from the wireless device, for example, after the wireless device switches the PCell from Cell 0 to Cell 1.

at step 3930, the target base station may forward the estimated TA for Cell 1 to the source base station. Further, at step 3932, the source base station may send (e.g., transmit) the forwarded TA to the wireless device, for example, via an RAR message, or via a TAC MA CE. The wireless device may monitor PDCCH (e.g., on Cell 0) for receiving the RAR message (e.g., based on examples described herein with respect to FIG. 13A, FIG. 13B, and/or FIG. 13C). The wireless device may maintain a TAT for a TAG associated with Cell 1. The wireless device may maintain Cell 1 as a non-serving cell. The TAC MAC CE may indicate (e.g., one or more bitfields of the MAC CE) whether the TAC is for a serving cell (or a TAG associated with the serving cell) or for a non-serving cell (e.g., Cell 1).

The source base station may skip sending (e.g., transmitting) the forwarded TA to the wireless device. Instead, the source base station may indicate the TA together with a second layer 1 or layer 2 command indicating/triggering PCell switching, for example, from Cell 0 to Cell 1. In this case, the wireless device may skip monitoring PDCCH (e.g., on Cell 0) for receiving the RAR message.

The sending (e.g., transmission) of a preamble to a candidate target PCell, for example, before receiving a (P)Cell switch command (with or without comprising a TA estimated by the target base station for the target PCell) indicating to switch the PCell to the target PCell, may be referred to herein as an early TA acquisition (ETA) procedure/process/feature/scheme. By implementing the ETA, for example, before the wireless device performs the HO, the target base station may obtain the TA to be used by the wireless device, for example, after performing the HO to the target PCell. The TA for the target PCell may be sent (e.g., transmitted) in an RAR or combined together with the layer 1 or layer command, for example, indicating the PCell switching. The ETA procedure may reduce the latency for uplink synchronization with the target PCell upon performing a HO procedure (or a PCell switching procedure).

At step 3934, the wireless device may receive a second L1/L2 command (e.g., MAC CE as shown in FIG. 39) indicating the PCell switching from Cell 0 to Cell 1. The second layer 1 or layer 2 command may further indicate the TA (e.g., forwarded from the target base station to the source base station and used for the target PCell in future), for example, if the TA is not received before receiving the second layer 1 or layer 2 command. The second layer 1 or layer 2 command may further indicate a beam information (e.g., a TCI state and/or an SSB index, which may be obtained, for example, in the early CSI report as described herein) to be used for downlink reception and/or uplink sending (e.g., transmission) over Cell 1. At step 3936, the wireless device may switch the PCell from Cell 0 to Cell 1 and send (e.g., transmit) PUSCH/PUCCH via Cell 1 based on the TA, for example, based on (e.g., after or in response to) receiving the second layer 1 or layer 2 command. The wireless device may receive downlink signals and send (e.g., transmit) uplink signals based on the indicated beam information. Switching the PCell from Cell 0 to Cell 1 may comprise at least one of: using RRC configuration parameters of Cell 1, stopping use of the RRC configuration parameters of Cell 0, resetting/reconfiguring MAC entity, receiving RRC messages/MIB/SSBs/SIBs/PDCCHs/PDSCHs from Cell 1 and stopping receiving RRC messages/MIB/SSBs/SIBs/PDCCHs/PDSCHs from Cell 0. A PCell switch procedure based on an layer 1 or layer 2 command (e.g., combined with an early CSI report and/or an ETA procedure) may be referred to as an LTM procedure, for example, based on examples described herein with respect to FIG. 39.

FIG. 40, FIG. 41 and FIG. 42 show examples of RRC messages for layer 1 or layer 2 CSI measurement and/or reporting configuration. A base station may send (e.g., transmit) to a wireless device, an RRC message of a serving cell (e.g., ServingCellConfig IE in FIG. 40) comprising configuration parameters of layer 1 or layer 2 measurements (e.g., csi-MeasConfig IE) and layer 3 measurements (e.g., servingCellMO IE). A csi-MeasConfig IE may indicate a list of non-zero power CSI-RS resource (e.g., nzp-CSI-RS-ResourceToAddModList), a list of non-zero power CSI-RS resource sets (e.g., nzp-CSI-RS-ResourceSetToAddModList), a list of SSB resource sets (e.g., csi-SSB-ResourceSetToAddList), a list of CSI resource configurations (e.g., csi-ResourceConfigToAddList), a list of CSI report configurations (e.g., csi-ReportConfigToAddList) and/or etc. A non-zero power CSI resource (e.g., NZP-CSI-RS-Resource) may be identified by an NZP-CSI-RS-ResourceId and may be configured with a periodicity and offset parameter (CSI-ResourcePeriodicityAndOffset) and a QCL configuration (e.g., TCI-stateId), etc. A CSI-RS resource may be implemented based on, for example, examples described herein with respect to FIG. 11B. A non-zero power CSI resource set may be identified by an NZP-CSI-RS-ResourceSetId and may comprise a list of non-zero power CSI-RS resources.

As shown in FIG. 41, a csi-SSB-ResourceSet may be identified by a CSI-SSB-ResourceSetId and may comprise a list of SSB indexes. Each SSB index may be associated with a respective ServingAdditionalPCIIndex of a list of additional PCIs (servingAdditionalPCIList). The servingAdditionalPCIList may indicate the physical cell IDs (PCIs) of the SSBs in the csi-SSB-ResourceList. If the servingAdditionalPCIList is present in the csi-SSB-ResourceSet, the list may have the same number of entries as csi-SSB-ResourceList. The first entry of the list may indicate the value of the PCI for the first entry of csi-SSB-ResourceList, the second entry of this list may indicate the value of the PCI for the second entry of csi-SSB-ResourceList, and so on. For each entry of the servingAdditionalPCIList, if the value is zero, the PCI may comprise the PCI of the serving cell in which this CSI-SSB-ResourceSet is defined, otherwise, the value may comprise additionalPCIIndex-r17 of an SSB-MTC-AdditionalPCI-r17 configured using the additionalPCI-ToAddModList-r17 in ServingCellConfig, and the PCI may comprise the additionalPCI-r17 in this SSB-MTC-AdditionalPCI-r17.

As shown in FIG. 41, based on the list of NZP-CSI-RS-ResourceSets and the list of csi-SSB-ResourceSets, the base station may configure, for each CSI resource configuration (e.g., CSI-ResourceConfig) identified by CSI-ResourceConfigId, a list of CSI-RS resource sets (csi-RS-ResoruceSetList) comprising a list of non-zero power CSI-RS resource sets (e.g., nzp-CS-RS-ResourceSetList) and/or a list of csi-SSB-ResourceSets (e.g., csi-SSB-ResourceSetList) for CSI measurement, or comprising a list of csi-IM-Resource sets (e.g., csi-IM-ResourceSetList) for interference measurements. Each CSI resource of a CSI resource configuration may be located in the DL BWP identified by the higher layer parameter BWP-id of the CSI resource configuration, and all CSI Resource lists linked to a CSI Report Setting may have the same DL BWP.

As shown in FIG. 42, based on the CSI resource configurations described herein with respect to FIG. 40 and/or FIG. 41, the base station may configure, for each CSI report configuration (e.g., CSI-ReportConfig) identified by a CSI report configuration identifier (e.g., CSI-ReportConfigld), a serving cell index indicating the serving cell in which the CSI-ResourceConfig are to be found (if the field is absent, the resources are on the same serving cell as this report configuration), a CSI-ResourceConfigId indicating CSI resources for channel measurement, a report type indication indicating whether the CSI report is periodic, semi-persistent CSI report on PUCCH, semi-persistent CSI report on PUSCH, or aperiodic, a report quantity indication indicating a report quantity (e.g., CRI-RSRP, SSB-index-RSRP, etc.) (e.g., wherein SSB-index-RSRP may be referred to as layer 1 RSRP (L1-RSRP) herein), a time domain restriction indication for channel measurements (e.g., timeRestrictionForChannelMeasurements), etc. A semi-persistent CSI report on PUCCH may be triggered, for example, by a SP CSI activation/deactivation MAC CE. A semi-persistent CSI report on PUSCH may be triggered, for example, by a DCI with CRC being scrambled by SP-CSI-RNTI. An aperiodic CSI report may be indicated by a DCI scheduling a PUSCH transmission and comprising an aperiodic CSI request field.

The wireless device may measure and send (e.g., transmit) a CSI report, for example, based on the configurations of CSI measurement and reports via RRC messages of FIG. 40, FIG. 41, and/or FIG. 42. For beam measurements, the wireless device may send (e.g., transmit) an L1-RSRP report.

For example, a wireless device may be configured (e.g., based on examples described herein with respect to FIG. 40, FIG. 41, and/or FIG. 42) with CSI-RS resources, SS/PBCH block resources or both CSI-RS and SS/PBCH block resources, if resource-wise quasi co-located with ‘type C’ and ‘type D’ if applicable. The wireless device may be configured with CSI-RS resource setting up to 16 CSI-RS resource sets having up to 64 resources within each set. The total number of different CSI-RS resources over all resource sets may be no more than 128.

For L1-RSRP reporting, if the higher layer parameter nrofReportedRS in CSI-ReportConfig is configured to be one, the reported L1-RSRP value may be defined by a 7-bit value in the range [−140, −44] dBm with 1 dB step size. If the higher layer parameter nrofReportedRS is configured to be larger than one, or if the higher layer parameter groupBasedBeamReporting is configured as ‘enabled’, or if the higher layer parameter groupBasedBeamReporting-r17 is configured, the wireless device may use differential L1-RSRP based reporting, where the largest measured value of L1-RSRP may be quantized to a 7-bit value in the range [−140, −44] dBm with 1 dB step size, and the differential L1-RSRP may be quantized to a 4-bit value. The differential L1-RSRP value may be computed with 2 dB step size with reference to the largest measured L1-RSRP value which may comprise part of the same L1-RSRP reporting instance. If the higher layer parameter groupBasedBeamReporting-r17 in CSI-ReportConfig is configured, the wireless device may indicate the CSI Resource Set associated with the largest measured value of L1-RSRP, and for each group, CRI or SSBRI of the indicated CSI Resource Set may be present first.

If the wireless device is configured with SSB-MTC-AdditionalPCI, a CSI-SSB-ResourceSet configured for L1-RSRP reporting may include one set of SSB indices and one set of PCI indices, where each SSB index may be associated with a PCI index, for example, as described herein with respect to FIG. 41. If the wireless device is configured with a CSI-ReportConfig with the higher layer parameter reportQuantity set to ‘cri-RSRP-Capability[Set] Index’ or ‘ssb-Index-RSRP-Capability[Set] Index’, an index of wireless device capability value set, for example, indicating the maximum supported number of SRS antenna ports, may be reported along with the pair of SSBRI/CRI and L1-RSRP. If a wireless device is configured with the higher layer parameter SSB-MTC-AdditionalPCI, the wireless device may be allowed to report in a single reporting instance up to four SS/PBCH Block Resource indicators (SSBRIs) for each report setting, where SSB resources are associated with PCI indices referring to the PCI of the serving cell and PCI(s) different from the PCI of the serving cell within the set of PCIs configured.

Layer 1 CSI reporting for inter-cell multi-TRP may be supported and specified in at least some wireless communications (e.g., as shown in FIG. 31B and/or FIG. 41) (e.g., such as in 3GPP NR Release17 (Rel.17 or R17)) by configuring an SSB/CSI-RS with additional PCI different from PCI of a serving cell and configuring CSI reporting, of the serving cell, associated with the SSB/CSI-RS. In at least some wireless communications (e.g., such as in 3GPP NR Rel.17), the L1 CSI reporting for inter-cell multi-TRP specified may have limitations which comprise: the SSB of the (non-serving) cell with different PCI from a serving cell being completely contained in the active BWP or associated with initial downlink BWP of the wireless device; the SSB of the (non-serving) cell with different PCI from the serving cell having the same SCS and center frequency as the SSB of the serving cell in frequency domain; and in time domain: the SSB of the (non-serving) cell with different PCI from the serving cell having the same sfn-SSB-Offset in time domain; the timing difference of arrival at the wireless device between the SSBs of the serving cell and the (non-serving) cell with different PCI being less than CP length of the corresponding SCS; and the wireless device having sent a valid L3 measurement report within the last 5 seconds. Otherwise, the L1-RSRP measurements for a (non-serving) cell with different PCI from the serving cell is not supported by the wireless device and/or the base station in at least some wireless communications (e.g., such as in 3GPP NR Rel.17).

For L3 beam/cell measurement supported in at least some wireless communications (e.g., such as in 3GPP NR Rel. 15˜17), inter-frequency measurement and intra-frequency measurement are characterized as follow, where the intra-frequency measurement requires the center frequency of the SSB of the serving cell indicated for measurement and the center frequency of the SSB of the non-serving cell are the same, and the subcarrier spacing of the two SSBs are also the same, otherwise, the measurement is categorized as inter-frequency measurement (e.g., as specified in section 9.3 of TS38.133). The intra-frequency and inter-frequency measurement for CSI-RS based measurement are defined in section 9.10.2 and 9.10.3 of TS38.133, similarly as SSB-based measurement.

For example, for inter-frequency L3 measurement, the wireless device may be configured with a MG for measuring the non-serving cell or the candidate target cell. Additionally or alternatively, the wireless device may send (e.g., transmit) to the base station a wireless device capability parameter (e.g., interFrequencyMeas-NoGap-r16) indicating whether the wireless device can perform inter-frequency SSB based measurements without MGs if the SSB is completely contained in the active BWP of the wireless device (e.g., as specified in TS 38.133). If this parameter is indicated for FR1 and FR2 differently, each indication corresponds to the frequency range of cells to be measured. Additionally or alternatively, for intra-frequency L3 measurement, the wireless device may measure the non-serving cell or the target cell without using the MG.

The early CSI reporting for a candidate cell and a serving cell may be considered as inter-frequency measurement in at least some wireless communications (e.g., such as in 3GPP Rel.18 LTM), which may be different from inter-cell multi-TRP based measurement in at least some other wireless communications (e.g., such as in 3GPP Rel. 17). The serving cell and the non-serving cell may belong to the same DU (as examples herein with respect to FIG. 31B, and/or such as in for 3GPP Rel. 17 inter-cell multi-TRP), which may be referred to as intra-DU inter-cell deployment. However, the serving cell and the non-serving cell in at least some wireless communications (e.g., such as in 3GPP Rel.18 LTM) may belong to the same DU (which may be considered as intra-frequency deployment) or may not belong to the same DU which may be referred to as inter-DU inter-cell deployment (which may be considered as inter-frequency deployment). The examples not included in intra-frequency (e.g., such as for 3GPP Rel.18 LTM) may be regarded as inter-frequency, which may include, for example, at least the following examples: the frequency of the measured RS of a candidate cell is not covered by any of the active BWPs of SpCell and SCells configured for a wireless device, but are covered by some of the configured BWPs of SpCell and SCells configured for a wireless device; and the frequency of the measured RS of a candidate cell is not covered by any of the configured BWPs of SpCell and SCells configured for a wireless device. If the wireless device performs the layer 1 or layer 2 CSI measurement and/or reporting for a candidate target cell for at least some wireless communications (e.g., such as for 3GPP Rel.18 LTM), the time difference between the downlink signals from the serving (source) cell and the candidate target cell may be above CP which may be different from the measurements for at least some other wireless communications (e.g., such as for a 3GPP Rel.17 inter-cell multi-TRP example).

Given that the frequency deployment of a candidate target cell in at least some wireless communications (e.g., such as in 3GPP Rel.18 LTM) may be different from at least some other wireless communications (e.g., such as in 3GPP Rel.17 inter-cell multi-TRP) and the time difference of a serving cell and the candidate target cell may be above CP, an MG may be desired for L1/L2 CSI measurement and reporting for the candidate target cell in at least some wireless communications (e.g., such as in 3GPP Rel.18 LTM). The MG for L1/L2 CSI measurement and reporting may be shorter than the MG for L3 inter-frequency measurement in at least some wireless communications (e.g., such as in 3GPP Rel.18 LTM).

FIG. 43 shows an example of early CSI reporting with a measurement gap. For example, FIG. 43 shows an example of L1/L2 CSI measurement and reporting (which may comprise, for example, the early CSI report as shown in FIG. 39) for a candidate cell before a wireless device performs LTM for switching a serving PCell to the candidate cell.

For example, a base station may send (e.g., transmit), for example, via a serving/source cell (e.g., Cell 0) to a wireless device (e.g., at TO), a DCI or a MAC CE indicating/triggering a L1/L2 CSI report (e.g., L1-RSRP/RSRQ/SINR) (or an early CSI report for LTM procedure, e.g., as described in relation to FIG. 39) for one or more candidate cells (e.g., Cell 1). Additionally or alternatively, Cell 0 and Cell 1 may belong to the same DU (as explained herein, e.g., with reference to FIG. 38), in which case, Cell 0 and Cell 1 may be considered as intra-frequency deployment for the L1/L2 CSI report for the LTM procedure if the sending (e.g., transmissions) of the CSI-RS/SSB from Cell 0 and Cell 1 meet the requirements defined herein for the intra-frequency deployment. Additionally or alternatively, Cell 0 and Cell 1 may belong to different DUs (as explained herein) of the same CU or may belong to different DUs of different CUs. Cell 0 and Cell 1 may be considered as inter-frequency deployment for the L1/L2 CSI report for the LTM procedure.

A base station may configure a MG (or a layer 1 MG differentiated from a layer 3 MG) for the L1/L2 CSI measurement and/or report for the LTM. The base station may indicate one or more configuration parameters for the layer 3 MG (e.g., via RRC message comprising MeasGapConfig IE), for example, if configured with layer 3 MG (in at least some technologies). The one or more configuration parameters may comprise an FR1 MG configuration (e.g., gapFR1 IE) and/or an FR2 MG configuration (e.g., gapFR2 IE). The one or more configuration parameters may comprise a gapOffset indicating a starting point of the layer 3 MG, a measurement length (mgl), and/or a measurement periodicity (mgrp), etc.

The wireless device may setup the FR1 MG configuration, for example, indicated by the gapFR1 in accordance with the received gapOffset. The wireless device may setup the FR1 MG configuration based on (e.g., if) the gapFR1 being set to setup. Further, for example, the first subframe of each gap may occur at an SFN and subframe meeting the following condition: SFN mod T=FLOOR(gapOffset/10), subframe=gapOffset mod 10 and with T=mgrp/10.

The wireless device may setup the FR2 MG configuration indicated by the gapFR2 in accordance with the received gapOffset. The wireless device may setup the FR2 MG configuration based on (e.g., if) gapFR2 being set to setup. Further, for example, the first subframe of each gap may occur at an SFN and subframe meeting the following condition: SFN mod T=FLOOR(gapOffset/10), subframe=gapOffset mod 10 and with T=mgrp/10.

As shown in FIG. 43, the wireless device may switch to a first frequency/band where Cell 1 is deployed from a second frequency/band where Cell 0 is deployed, if, for example, Cell 0 and Cell 1 are considered/determined as inter-frequency deployment for the L1/L2 CSI report for the LTM procedure. The wireless device may use the MG for measuring the L1/L2 CSI quantities (e.g., L1-RSRP/RSRQ/SINR) of Cell 1, wherein, for example, during the MG, the wireless device may stop receiving downlink signals from Cell 0 and/or stop sending (e.g., transmitting) uplink signals via Cell 0. During the MG, the wireless device may measure CSI-RSs/SSBs of Cell 1. The wireless device may determine whether measurements of CSI-RSs/SSBs of Cell 1 have better quality than measurements of CSI-RSs/SSBs of Cell 0. The wireless device may perform L1/L2 CSI reports for Cell 1 and/or Cell 0, for example, based on examples described herein with respect to FIG. 39.

A layer 1 MG, compared to an MG used for L3 measurement, may be smaller. The inter-cell layer 1 measurement for LTM may not require the wireless device to perform blind detection for the CSI-RSs/SSBs of the candidate target cell. The serving cell and the candidate cell may have some kind of synchronization (e.g., since the wireless device has performed L3 measurement as implemented based on example of FIG. 39 before the layer 1 measurement). The layer 1 MG may be configured in symbol-level or slot-level.

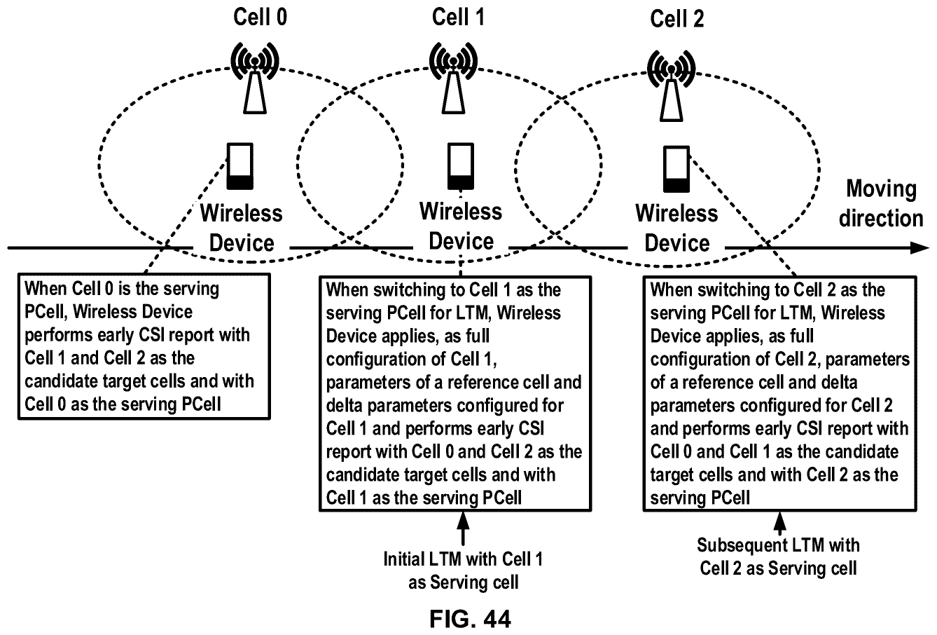

FIG. 44 shows an example of an initial LTM procedure and subsequent LTM procedure. A wireless device may receive, for an LTM procedure and from a base station, one or more RRC messages comprising configuration parameters of a serving cell (e.g., Cell 0) and a plurality of candidate (or non-serving) cells (e.g., Cell 1, Cell 2, etc.). The one or more RRC messages may be implemented, for example, based on examples described herein with respect to FIG. 39.

The wireless device may perform early CSI measurement/reporting for the LTM procedure. The early CSI measurement/reporting and/or the LTM procedure may be implemented, for example, based on examples described herein with respect to FIG. 39. The wireless device may communicate with the serving cell (Cell 0) and perform the early CSI reporting for the plurality of candidate cells (e.g., by comparing channel qualities of the plurality of candidate cells with a threshold or with the channel quality of the serving cell) for the LTM procedure.

The wireless device may perform the early CSI reporting by considering Cell 1 and Cell 2 as the candidate target cells (or PCells) and considering Cell 0 as the serving cell (or PCell). The wireless device may switch from Cell 0 to Cell 1 as the serving PCell based on (e.g., after or in response to) receiving a MAC CE indicating/triggering the switching. The MAC CE indicating/triggering the switching from Cell 0 to Cell 1 may be implemented, for example, based on examples described herein with respect to FIG. 39.

The PCell switching from Cell 0 to Cell 1, for example, after receiving the one or more RRC messages and after receiving the MAC CE indicating/triggering the switching, may be referred to as an initial LTM procedure. The wireless device may perform subsequent LTM procedures, for example, without receiving second RRC messages configuring second candidate cells (e.g., if Cell 1 is the serving PCell), for example, after receiving the one or more RRC messages comprising configuration parameters of the plurality of candidate cells. The wireless device may store (or may not release) the configuration parameters of the plurality of candidate cells (and/or the original serving PCell (Cell 0)), for example, after completing the initial LTM procedure. Storing or not releasing the configuration parameters of the plurality of candidate cells (and the original serving PCell) may allow the wireless device to quickly perform subsequent LTM procedures, for example, without waiting for RRC messages configuring candidate cells.

The one or more RRC messages (e.g., comprising the configuration parameters of the serving cell (Cell 0) and/or the plurality of candidate target cells (e.g., Cell 1 and Cell 2)) may comprise parameters of a full configuration for Cell 0, parameters of a full configuration of a reference cell (wherein the full configuration of the reference cell may be referred to as a reference configuration, or the reference cell may be referred to as a reference configuration), and/or parameters of delta configuration for each of the plurality of candidate target cells, for example, in order to support subsequent LTM procedures. Different candidate target cells may be associated with different delta configurations.

For example, the reference configuration may be implemented in the similar/same way as the full configuration of the serving cell (e.g., based on examples described herein with respect to FIG. 33). The reference configuration may be indicated (e.g., in the one or more RRC messages) independently and/or separately from the full configuration of the serving cell. Additionally or alternatively delta configuration of a candidate cell may comprise differences (e.g., different parameters, values, and/or resources, etc.) between a full configuration of the candidate cell and the reference configuration. The delta configuration of a candidate cell may be in the similar/same way as the full configuration of the serving cell (e.g., based on examples described herein with respect to FIG. 33), but may comprise less configuration parameters. The wireless device may refer to the delta configuration of the candidate cell and the reference configuration to obtain full configuration of the candidate cell. Transmitting the delta configuration of the candidate cell, instead of the full configuration of the candidate cell, may reduce signaling overhead for parameter indication of a candidate cell for the LTM procedure, for example, if different candidate cells belong to the same DU, or belong to the same CU.

The wireless device may use the reference configuration and the delta configuration of Cell 1 as full configuration of Cell 1, for example, based on (e.g., if) the wireless device switching the PCell, for example, from Cell 0 to Cell1. The wireless device may store the reference configuration and the delta configurations of the plurality of candidate cells (and/or the full configuration of Cell 0), for example, after the wireless device switches the PCell from Cell 0 to Cell 1. The wireless device may communicate with the base station via Cell 1 based on configuration parameters of the full configuration of Cell 1.

The wireless device may communicate with the base station with Cell 1 as the serving PCell, for example, after completing the initial LTM procedure. The wireless device may perform early CSI reporting, for example, based on considering Cell 1 as the serving PCell and considering Cell 0 and Cell 2 as the candidate target cells.

The base station may trigger a subsequent LTM, for example, based on the early CSI reporting which may be measured and reported by the wireless device based on Cell 1 as the serving PCell and Cell 0 and Cell 2 as the candidate target PCells. The base station may send (e.g., transmit) a second MAC CE indicating/triggering the PCell switching from Cell 1 to Cell 2. The second MAC CE may be implemented, for example, based on examples described herein with respect to FIG. 39.

The wireless device may use the reference configuration and the delta configuration of Cell 2 as full configuration of Cell 2, for example, based on (e.g., if/when) the wireless devices switching the PCell from Cell 1 to Cell 2 (e.g., based on receiving the second MAC CE). The wireless device may communicate with the base station via Cell 2, for example, based on configuration parameters of the full configuration of Cell 2.

The wireless device may store the reference configuration and the delta configurations of the plurality of candidate cells, for example, after the wireless device switches the PCell from Cell 1 to Cell 2. The wireless device may communicate with the base station via Cell 2 based on configuration parameters of the full configuration of Cell 2.

Based on examples of FIG. 44, a wireless device may perform subsequent LTM procedures if moving from an old cell to a new cell, for example, without waiting for an RRC message configuring parameters of the new cell. Examples may enable the wireless device to quickly HO among multiple cells and therefore reduce HO latency.

As described in FIG. 43, a wireless device may perform early CSI reporting for LTM procedures, where the wireless device may measure CSI quantities (e.g., L1-RSRP) of one or more candidate cells within a MG (e.g., layer 1 MG). The MG may be implemented, for example, based on examples described herein with respect to FIG. 43. The MG may be long or short based on whether the candidate cell and the serving cell are in the same frequency range/band. If the candidate cell and the serving cell are in the same frequency range/band, the MG may be several slots/symbols, or reduced to zero. If the candidate cell and the serving cell are in the different frequency range/band, the MG may be hundreds of slots/symbols.

In at least some technologies, the MG may be configured in an RRC message for the serving cell and/or the candidate cell(s), or the MG may be indicated associated with a CSI measurement configuration which may, for example, be indicated/activated by layer 1 signaling. However, given the wireless device is allowed to perform subsequent LTM procedure (as shown in FIG. 44), a candidate cell (e.g., Cell 2) at a first time (e.g., after initial LTM procedure) may be (or switched to as) a serving cell at a second time (e.g., after a subsequent LTM procedure). A serving cell (e.g., Cell 1) at a first time (e.g., after the initial LTM procedure) may be (or switched to as) a candidate cell at a second time (e.g., after a subsequent LTM procedure). If subsequent LTM procedures are performed, the role of a cell, as a candidate cell or a serving cell, may be dynamically changed. In at least some technologies, layer 1 MG configuration, for example, by an RRC message may not accommodate the PCell switching if subsequent LTM procedures are performed. It may be beneficial to improve layer 1 MG configuration/indication for supporting subsequent LTM procedures.

An example may comprise indicating, for example, by a base station, an MG (e.g., layer 1 MG), of a plurality of MGs, in a PCell switching MAC CE for an LTM procedure. The PCell switching MAC CE comprises an indication of a candidate target cell of a plurality of candidate target cells, an MG indication indicating the MG of the plurality of MGs, a RS (or a TCI state associated with the RS) of the candidate target cell for beam indication, a TA indication for uplink sending (e.g., transmission) via the candidate target cell, etc. Based on receiving the PCell switching MAC CE, the wireless device may switch to the candidate target cell as the PCell and may use the indicated MG for early CSI reporting/measurement over one or more candidate target cells (e.g., comprising the original PCell which is now a candidate cell after the PCell switching). Indicating the layer 1 MG in the PCell switching MAC CE, instead of, for example, a separate DCI/MAC CE different from the PCell switching MAC CE, may enable the wireless device to quickly start early CSI measurement/reporting over candidate target cells. Otherwise, the wireless device may need to wait for a new DCI/MAC CE comprising the MG indication which may increase latency of the early CSI report. Indicating the layer 1 MG in the PCell switching MAC CE, instead of, for example, indicating it in an RRC message, may enable the wireless device to adapt measurement timing according to the indicated PCell, since candidate cell and serving cell are changed frequently/dynamically if subsequent LTM procedure is supported (e.g., based on examples described herein with respect to FIG. 44).

An example may comprise configuring, for example, by a base station and in RRC messages, configuration parameters of a plurality of MGs and indicating/activating in a DCI/MAC CE, one of the plurality of MGs for early CSI reporting for an LTM procedure. The wireless device may determine a default/initial/first MG from the plurality of MGs for the early CSI report for the LTM procedure, for example, based on (e.g., after or in response to) receiving the RRC messages and before receiving the DCI/MAC CE indicating/activating one of the plurality of MGs. The DCI/MAC CE indicating/activating the MG may be the same DCI/MAC CE indicating the PCell switching. Alternatively, the DCI/MAC CE indicating/activating the MG may not be the same DCI/MAC CE indicating the PCell switching. The default/initial/first MG may be determined as an MG with lowest MG index/ID from the plurality of MGs, where each MG of the plurality of MGs is associated with or identified by a MG index/ID.

The default/initial/first MG may be indicated by the base station in the RRC messages. For example, the plurality of MGs may comprise a MG explicitly indicated as the default/initial/first MG which may be used by the wireless device for a time period, for example, after the wireless device receives the RRC messages and before the wireless device receives the DCI/MAC indicating/activating one of the plurality of MGs.

The default/initial/first MG may be determined as a disabled MG, or a MG with length zero, in which case, the wireless device may perform the early CSI measurement/reporting without MG, for example, if the candidate cells and the serving cell are determined as intra-frequency deployment for the early CSI measurement/reporting for the LTM procedure. Examples may allow the wireless device to determine an applicable MG for early CSI reporting, for example, after receiving RRC messages configuring MGs and before receiving a DCI/MAC activating/indicating one of the MGs.

An example may comprise configuring, for example, by a base station and in RRC messages, configuration parameters of a plurality of MGs and indicating/activating in a DCI/MAC CE, one of the plurality of MGs for early CSI reporting for an LTM procedure. Based on (e.g., after or in response to) receiving the RRC messages, the wireless device may not perform the early CSI measurement/reporting for a candidate cell until receiving the DCI/MAC CE indicating/activating one of the plurality of MGs. The DCI/MAC CE indicating/activating the MG may be the same DCI/MAC CE indicating the PCell switching. Alternatively, the DCI/MAC CE indicating/activating the MG may not be the same DCI/MAC CE indicating the PCell switching.

An example may comprise receiving, for example, by a wireless device and/or sending (e.g., transmitting) by a base station, a DCI/MAC CE indicating PCell switching and comprising one or more CSI report/MG indications. The one or more CSI report/MG indications may indicate the following: candidate cell(s) of a plurality of candidate cells for which the wireless device performs early CSI measurement/reporting, for example, after performing the PCell switching based on the DCI/MAC CE; and for each candidate cell of the candidate cell(s) to be measured, an MG (e.g., cell specific indication indicating an applicable MG value of a plurality of MG values configured in RRC messages. Indicating (e.g., dynamically together with PCell switching indication) a subset of candidate cells from a plurality of candidate cells (e.g., configured by the base station in RRC messages) may allow the wireless device to avoid measuring each of the plurality of candidate cells and/or reduce power consumption or communication interrupt with the serving cell if the serving cell is switched dynamically (e.g., if subsequent LTM procedure is supported as shown in FIG. 44). Indicating (e.g., dynamically together with PCell switching indication) a per-cell MG may allow the wireless device to use an appropriate MG for early CSI measurement/reporting for a candidate cell if, for example, the candidate cell and the serving PCell are in different frequency bands. Examples may improve CSI measurement/reporting latency and/or PCell switching latency for LTM if the wireless device supports subsequent LTM procedures.

An example may comprise receiving, for example, by a wireless device and/or sending (e.g., transmitting) by a base station, a DCI/MAC CE indicating PCell switching and comprising a single MG indication. The single MG indication may indicate an applicable MG value of a plurality of MG values configured in RRC messages, which may be used for early CSI measurement/reporting for all candidate cells.

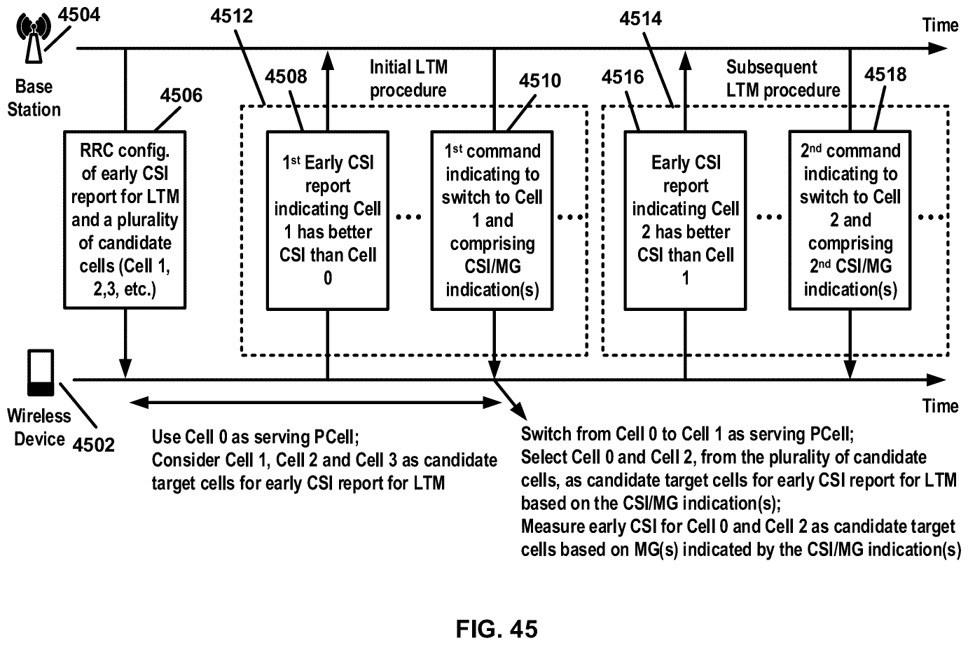

FIG. 45 shows an example of early CSI reporting with an MG. For example, FIG. 45 shows an example of MG indication for early CSI reporting for LTM. Referring to FIG. 45, at step 4506, a base station 4504 may send (e.g., transmit), and/or a wireless device 4502 may receive, one or more RRC messages, for example, comprising configuration parameters of a serving cell (e.g., Cell 0), configuration parameters of early CSI reporting for an LTM procedure and configuration parameters of a plurality of candidate cells (e.g., Cell 1, Cell 2, Cell 3, etc.). The configuration parameters of the serving cell may be implemented, for example, based on examples described herein with respect to FIG. 33. The configuration parameters (e.g., MG configurations, RS configurations, report configurations, etc.) of the early CSI report may be implemented, for example, based on examples described herein with respect to FIG. 39. The configuration parameters of the plurality of candidate cells may be implemented, for example, based on examples described herein with respect to FIG. 39.

The wireless device 4502 may communicate with the base station 4504 via Cell 0 as the serving PCell and via one or more SCells, for example, based on the one or more RRC messages. The wireless device 4502 may perform early CSI measurement/reporting over RSs of the plurality of candidate cells (Cell 1, Cell 2, Cell 3, etc.). The early CSI measurement/reporting may be implemented, for example, based on examples described herein with respect to FIG. 39. At step 4508, the wireless device 4502 may send (e.g., transmit) a first early CSI report (e.g., 1^{st} early CSI report in FIG. 45) (e.g., triggered by a measurement event or by receiving a DCI/MAC comprising a CSI request as described herein with respect to FIG. 39) indicating Cell 1 has better CSI (e.g., L1-RSRP, L1-RSRQ, and/or SINR etc.) than Cell 0. At step 4512, the base station 4504 and the wireless device 4502 may perform an initial LTM procedure based on the first early CSI report (e.g., based on examples described herein with respect to FIG. 39).

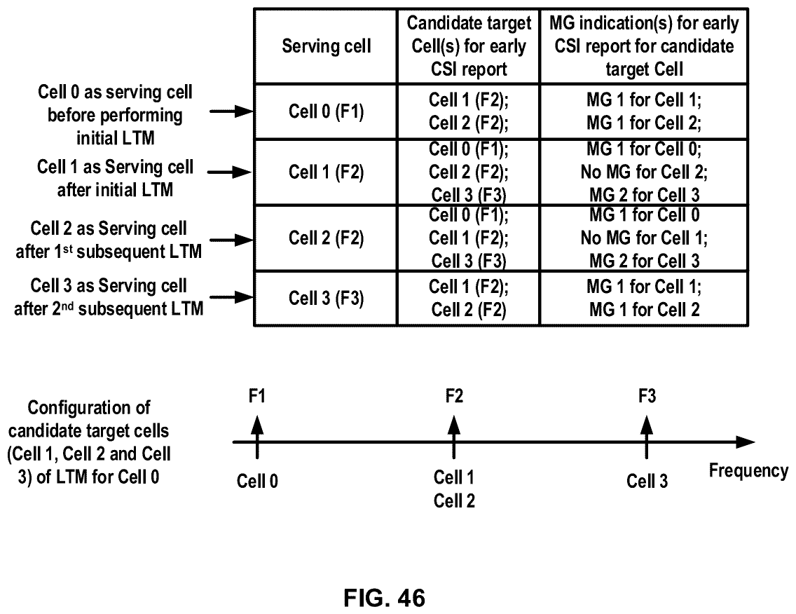

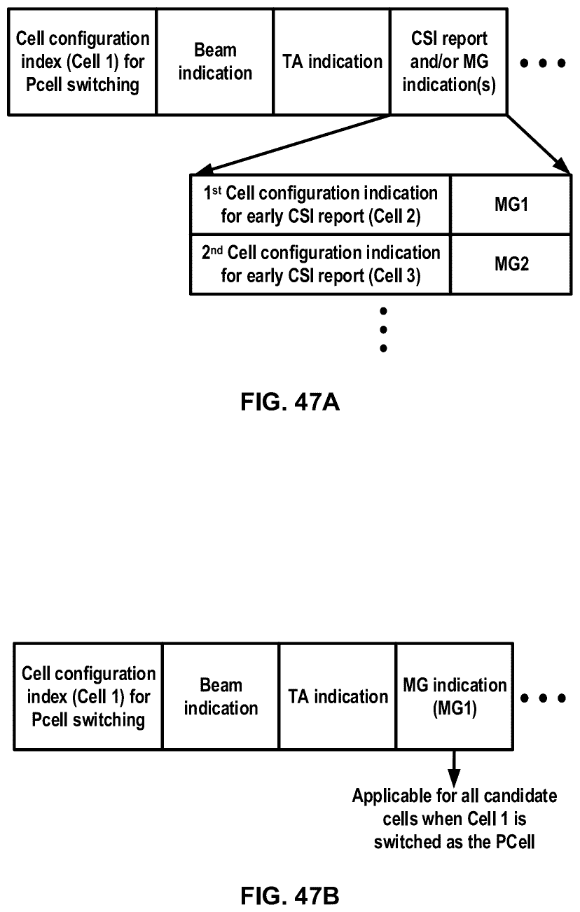

At step 4510, the base station 4504 may send (e.g., transmit), and/or the wireless device 4502 may receive a first command (e.g., 1^{st} command in FIG. 45) (e.g., a DCI/MAC CE, wherein the MAC CE may be implemented as the MAC CE triggering PCell switching to Cell 1 in FIG. 39) indicating to switch from Cell 0 to Cell 1 as the PCell and comprising one or more CSI/MG indications. The one or more CSI/MS indications may be implemented, for example, based on examples of FIG. 46, FIG. 47A, and/or FIG. 47B as described herein.

The one or more CSI/MG indications may indicate one or more cells, of the plurality of candidate cells, configured in the one or more RRC messages, for which the wireless device 4502 may perform early CSI measurement/reporting. The one or more cells may be a subset of the plurality of candidate cells. Neighbor cells may change if, for example, the wireless device 4502 is moving around in an area covered by the plurality of candidate cells. Indicating (dynamically or semi-persistently together with PCell switching indication) a subset of the plurality of candidate cells for the early CSI measurement/report may reduce power consumption of the wireless device 4502 and/or reduce communication interruption on the serving PCell.

The one or more CSI/MG indications may indicate Cell 0 and Cell 2 (and/or may indicate Cell 3 is not used/measured) for the early CSI measurement/report, for example, after the wireless device 4502 switches the PCell from Cell 0 to Cell 1. The one or more CSI/MG indications may not explicitly indicate Cell 0 for the early CSI measurement/report after the wireless device 4502 performs the PCell switching from Cell 0 to Cell 1. The wireless 4502 device may (e.g., automatically) consider Cell 0, which may comprise the last PCell before the wireless device 4502 performs the PCell switching, as a candidate cell for the early CSI measurement/report, for example, after the wireless device 4502 performs the PCell switching from Cell 0 to Cell 1.

The one or more CSI/MG indications may indicate for each indicated Cell (Cell 0 and Cell 2 in the example of FIG. 45) which is to be measured, an applicable MG value selected from a plurality of MG values configured in the one or more RRC messages. A first MG value for Cell 0 may be different from a second MG value for Cell 2. Indicating (e.g., dynamically or semi-persistently together with the PCell switching indication) per-cell MG values may allow the wireless device 4502 to use appropriate MG length for CSI measurement/reporting of the candidate cell based on whether the candidate cell and the serving cell are considered as inter-frequency operation or intra-frequency operation. Per-cell MG value indication may be implemented, for example, based on examples of FIG. 47A described herein.

The wireless device 4502 may switch the PCell from Cell 0 to Cell 1, for example, after receiving the first command. The wireless device 4502 may select, from the plurality of candidate cells (e.g., Cell 1, Cell 2, Cell 3), for example, configured in the one or more RRC messages, one or more candidate cells for the early CSI measurement/report, for example, based on (e.g., when/if) the wireless device 4502 communicating with the base station 4504 via Cell 1 as the PCell. The wireless device 4502 may select the one or more candidate cells (e.g., Cell 0 and Cell 2) for CSI measurement based on the one or more CSI/MG indications in the first command as described herein. The wireless device 4502 may determine for each of the one or more candidate cells, a per-cell MG value, for example, based on the one or more CSI/MG indications in the first command as described herein. The wireless device 4502 may determine a first MG value for Cell 0 and a second MG value for Cell 2 if/when performing early CSI measurement/reporting based on Cell 1 being the PCell. The wireless device 4502 may perform early CSI measurement/reporting for Cell 0 and Cell 2 with the indicated MG values, for example, based on examples described herein with respect to FIG. 39 and/or FIG. 43.

The wireless device 4502 may apply/use the MG associated with Cell 0, for example, based on (e.g., if/when) measuring CSI of RSs of Cell 0). The wireless device 4502 may apply/use the MG associated with Cell 2, for example, based on (e.g., if/when) measuring CSI of RS of Cell 2. The CSI measurement based on a MG may be implemented, for example, based on examples described herein with respect to FIG. 43.

The first early CSI report, the first command, the PCell switching from Cell 0 to Cell 1, etc. (e.g., further comprising early TA acquisition based on examples described herein with respect to FIG. 39) may be referred to as an initial LTM procedure 4512. The wireless device 4502 may perform a subsequent LTM procedure 4514, for example, after the initial LTM procedure 4512. The subsequent LTM procedure 4514 may be implemented, for example, based on examples described herein with respect to FIG. 44.

The wireless device 4502 may perform early CSI measurement/reporting over RSs of the indicated cells (e.g., Cell 0, Cell 2) for a subsequent LTM procedure, for example, after completing the initial LTM procedure comprising, for example, switching PCell from Cell 0 to Cell 1. The early CSI measurement/report may be implemented, for example, based on examples described herein with respect to FIG. 39. At step 4516, the wireless device 4502 may send (e.g., transmit) a second early CSI report (e.g., 2^{nd} early CSI report in FIG. 45) (e.g., triggered by a measurement event or by receiving a DCI/MAC comprising a CSI request as described herein with respect to FIG. 39), for example, indicating Cell 2 has better CSI (e.g., L1-RSRP, L1-RSRQ, and/or SINR etc.) than Cell 1. The base station 4504 and/or the wireless device 4502 may perform subsequent LTM procedures based on the second early CSI report (e.g., based on examples described herein with respect to FIG. 39 and FIG. 44).

At step 4518, the base station 4504 may send (e.g., transmit), and/or the wireless device 4502 may receive a second command (e.g., 2^{nd} command in FIG. 45), e.g., a DCI/MAC CE, wherein the MAC CE may be implemented as the MAC CE triggering PCell switching to Cell 1 as described herein, for example, in relation to FIG. 39) indicating to switch from Cell 1 to Cell 2 as the PCell and comprising one or more second CSI/MG indications. The one or more second CSI/MS indications may be implemented, for example, based on examples of FIG. 46, FIG. 47A, and/or FIG. 47B described herein.

The one or more second CSI/MG indications may indicate one or more cells, of the plurality of candidate cells configured in the one or more RRC messages, for which the wireless device 4502 performs early CSI measurement/reporting if, for example, the wireless device 4502 uses Cell 2 as the serving PCell. The one or more cells may be a subset of the plurality of candidate cells. Neighbor cells may change if, for example, the wireless device 4502 is moving around in an area covered by the plurality of candidate cells. Indicating (e.g., dynamically or semi-persistently together with PCell switching indication) a subset of the plurality of candidate cells for the early CSI measurement/report may reduce power consumption of the wireless device 4502 and/or reduce communication interruption on the serving PCell.

The one or more second CSI/MG indications may indicate Cell 1 and Cell 3 (and/or may indicate Cell 0 is not used) for the early CSI measurement/report, for example, after the wireless device 4502 switches the PCell from Cell 1 to Cell 2. The one or more CSI/MG indications (e.g., first CSI/MG indication) comprised in the first command and the one or more second CSI/MG indications comprised in the second command may indicate different cells for early CSI measurement/reporting. The one or more second CSI/MG indications may indicate for each indicated Cell (e.g., Cell 1 and Cell 3), an applicable MG value selected from a plurality of MG values configured in the one or more RRC messages, for example, in a similar way as the one or more CSI/MG indications (e.g., first CSI/MG indications) comprised in the first command.

The wireless device 4502 may switch the PCell from Cell 1 to Cell 2, for example, after receiving the second command. The wireless device 4502 may select the one or more candidate cells (e.g., Cell 1 and Cell 3) based on the one or more second CSI/MG indications in the second command as described herein. The wireless device 4502 may determine for each of the one or more candidate cells, a per-cell MG value, for example, based on the one or more second CSI/MG indications in the second command as described herein. The wireless device 4502 may perform early CSI measurement/reporting for Cell 1 and Cell 3 with the indicated MG values, for example, based on examples described herein with respect to FIG. 39 and/or FIG. 43.

The wireless device 4502 may receive PCell switching commands together with MG indication(s) and/or CSI indication(s) of a subset of candidate cells from a plurality of candidate cells for early CSI measurement/reporting, for example, based on examples of FIG. 45. The wireless device 4502 may use one or more MG values indicated by the MG indication(s) for early CSI measurement over the subset of the candidate cells indicated by the CSI indications. Examples may allow the base station 4504 and/or the wireless device 4502 to adapt MG and/or candidate cells for early CSI measurement/reporting if, for example, LTM procedures and/or subsequent LTM procedures are supported. Examples described may reduce power consumption of the wireless device 4502 (e.g., for CSI measurement/reporting) and/or reduce communication interruption (e.g., due to MG for CSI measurement/reporting of a candidate cell inter-frequency deployed with the serving PCell) on the serving PCell.

FIG. 46 shows an example of dynamic indication of an MG for early CSI. For example, FIG. 46 shows an example of MG indication for early CSI reporting for LTM based on, for example, examples of FIG. 45. Referring to FIG. 46, a base station may send (e.g., transmit), and/or a wireless device may receive, one or more RRC messages, for example, comprising configuration parameters of a plurality of cells (e.g., Cell 0, Cell 1, Cell 2, and Cell 3) of an LTM procedure. The one or more RRC messages may be implemented, for example, based on examples described herein with respect to FIG. 45.

Cell 0, which may comprise an initial PCell, may be deployed in a first frequency (location, point, band) (F1), Cell 1 and Cell 2, configured as candidate target cells, may be deployed in a second frequency (F2). Cell 1 and Cell 2 may be considered as intra-frequency deployment if, for example, Cell 1 is the serving PCell and Cell 2 is a candidate cell for Cell 1. Cell 3, configured as a candidate target cell, may be deployed in a third frequency (e.g., F3).

If Cell 0 is the serving PCell (e.g., after receiving the one or more RRC messages and before performing the initial LTM procedure), the wireless device may determine/select candidate cells from the plurality of candidate cells (e.g., Cell 1, Cell 2, Cell 3, etc.) for early CSI measurement/reporting, for example, based on receiving the one or more RRC messages and/or receiving CSI/MG indications (e.g., in DCI or MAC CE). The wireless device may determine Cell 1 and Cell 2 as the selected candidate cells for the early CSI measurement/reporting if, for example, Cell 0 is the PCell. The wireless device may determine to use an MG value for the early CSI measurement of Cell 1 and Cell 2. The MG value may be indicated in the CSI/MG indications (e.g., based on examples described herein with respect to FIG. 45). The wireless device may determine to use MG1 for Cell 1 and Cell 2 based on Cell 1 and Cell 2 being configured in F2 and being considered as inter-frequency deployment relative to Cell 0 configured in F1. The wireless device may use MG1 for the early CSI measurement/report of Cell 1 and Cell 2 (e.g., based on examples described herein with respect to FIG. 39, FIG. 43, and/or FIG. 45).

The wireless device may determine/select candidate cells from the plurality of candidate cells (e.g., Cell 0, Cell 2, Cell 3, etc.) for early CSI measurement/reporting (e.g., based on receiving CSI/MG indications (e.g., in DCI or MAC CE or the first command as shown in FIG. 45)), for example, based on (e.g., if/when) Cell 1 being the serving PCell (e.g., after performing the initial LTM procedure). The wireless device may determine Cell 0, Cell 2, and Cell 3 as the selected candidate cells for the early CSI measurement/report if, for example, Cell 1 is the PCell. The wireless device may determine to use one or more MG values for the early CSI measurement of Cell 0, Cell 2, and Cell 3. The MG values may be indicated in the CSI/MG indications (e.g., based on examples described herein with respect to FIG. 45). The wireless device may determine to use MG1 for Cell 0, for example, based on Cell 0 being configured in F1 and being considered as inter-frequency deployment relative to Cell 1 configured in F2. The wireless device may determine to use MG2 for Cell 3 based on Cell 3 being configured in F3 and being considered as inter-frequency deployment relative to Cell 1 configured in F2. The wireless device may not use MG for the early CSI measurement of Cell 2 based on Cell 2 being configured in F2 and being considered as intra-frequency deployment relative to Cell 1 configured in F2. The wireless device may perform early CSI measurement/reporting of Cell 0, Cell 2, and Cell 3 with the determined MGs (e.g., based on examples described herein with respect to FIG. 39, FIG. 43 and FIG. 45).

The wireless device may determine/select candidate cells from the plurality of candidate cells (e.g., Cell 0, Cell 1, Cell 3, etc.) for early CSI measurement/reporting (e.g., based on receiving CSI/MG indications (e.g., in DCI or MAC CE or the first command as shown in FIG. 45)), for example, based on (e.g., if/when) Cell 2 being the serving PCell (e.g., after performing a first subsequent LTM procedure (e.g., 1^{st} subsequent LTM procedure in FIG. 46) (e.g., based on examples described herein with respect to FIG. 44)). The wireless device may determine Cell 0, Cell 1, and Cell 3 as the selected candidate cells for the early CSI measurement/report if, for example, Cell 2 is the PCell. The wireless device may determine to use one or more MG values for the early CSI measurement of Cell 0, Cell 1, and Cell 3. The MG values may be indicated in the CSI/MG indications (e.g., based on examples described herein with respect to FIG. 45). The wireless device may determine to use MG1 for Cell 0 based on Cell 0 being configured in F1 and being considered as inter-frequency deployment relative to Cell 2 configured in F2. The wireless device may determine to use MG2 for Cell 3, for example, based on Cell 3 being configured in F3 and being considered as inter-frequency deployment relative to Cell 2 configured in F2. The wireless device may not use MG for the early CSI measurement of Cell 1 based on Cell 1 being configured in F2 and being considered as intra-frequency deployment relative to Cell 2 configured in F2. The wireless device may perform early CSI measurement/reporting of Cell 0, Cell 1, and Cell 3 with the determined MGs (e.g., based on examples described herein with respect to FIG. 39, FIG. 43 and FIG. 45).

The wireless device may determine/select candidate cells from the plurality of candidate cells (e.g., Cell 0, Cell 1, Cell 2, etc.) for early CSI measurement/reporting (e.g., based on receiving CSI/MG indications (e.g., in DCI or MAC CE or the first command as shown in FIG. 45)), for example, based on (e.g., if/when) Cell 3 being the serving PCell (e.g., after performing a second subsequent LTM procedure (e.g., 2^{nd} subsequent LTM procedure in FIG. 46) (e.g., based on examples described herein with respect to FIG. 44)). The wireless device may determine Cell 1 and Cell 2 as the selected candidate cells for the early CSI measurement/report if, for example, Cell 3 is the PCell. The wireless device may determine to use one or more MG values for the early CSI measurement of Cell 1 and Cell 2. The MG values may be indicated in the CSI/MG indications (e.g., based on examples described herein with respect to FIG. 45). The wireless device may determine to use MG1 for both Cell 1 and Cell 2 based on Cell 1 and Cell 2 being configured in F2 and being considered as inter-frequency deployment relative to Cell 3 configured in F3. The wireless device may perform early CSI measurement/reporting of Cell 1 and Cell 2 with the determined MG(s) (e.g., based on examples described herein with respect to FIG. 39, FIG. 43 and FIG. 45).

Based on examples of FIG. 46 (e.g., and/or combination with FIG. 45), for example, a subset of candidate cells associated with corresponding MGs may be dynamically or semi-persistently indicated to a wireless device for early CSI measurement/reporting, for example, based on at least one of: a frequency band of a serving PCell; frequency band of a candidate cell; and a geographical location of the wireless device (e.g., on which location the (initial/subsequent) LTM procedure is performed). Examples may allow the base station and/or the wireless device to adapt MG(s) and/or candidate cells for early CSI measurement/reporting if, for example, LTM procedure and/or subsequent LTM procedure are supported. Examples may reduce power consumption of the wireless device (e.g., for CSI measurement/reporting) and/or reduce communication interruption (e.g., due to MG for CSI measurement/reporting of a candidate cell inter-frequency deployed with the serving PCell) on the serving PCell.

FIG. 47A and FIG. 47B show examples of dynamic indication of an MG for early CSI. For example, FIG. 47A and FIG. 47B show examples of CSI reporting and MG indications for an LTM procedure, based on, for example, examples of FIG. 45 and/or FIG. 46.

Referring to FIG. 47A, the MAC CE (or a command), indicating the PCell switching for an LTM procedure as shown in FIG. 39 and FIG. 45, may be implemented, for example, based on examples of FIG. 47A. The MAC CE (or the command) indicating the PCell switching may comprise one or more fields comprising: a cell configuration index for the PCell switching; a beam indication; a TA indication; and/or one or more CSI reports and/or MG indications. The cell configuration index may indicate one of the plurality of candidate cells configured in the one or more RRC messages (e.g., RRC config. as shown in FIG. 39 and/or FIG. 45). The one or more RRC messages may comprise a cell configuration index for each candidate cell of the plurality of candidate cells.

Value 0 of a cell configuration index may be reserved, for example, for the initial serving PCell (e.g., Cell 0 in FIG. 39, FIG. 44, FIG. 45, and/or FIG. 46) in which case the wireless device switched to Cell 0 as the serving PCell. Non-zero value of a cell configuration index may indicate one of the plurality of candidate cells (e.g., Cell 1, Cell 2, Cell 3 etc.) configured in the one or more RRC messages. Using cell configuration index (which may be configured, e.g., as 3 bits to at most support 8 candidate cells), instead of PCI value (which may be, e.g., 10 bits), to indicate a cell for the PCell switching and/or CSI/MG indication(s) may reduce signaling overhead of the MAC CE.

In examples of FIG. 47A, the cell configuration index indicated in the MAC CE may indicate a candidate cell (e.g., Cell 1), of the plurality of candidate cells, to which the wireless device may switch from the current PCell (e.g., Cell 0). Further in examples of FIG. 47A, the beam indication may comprise an RS index or a TCI index indicating an RS of the candidate cell (e.g., Cell 1) which may be used by the wireless device as a reference of Tx beam or Rx beam for communicating with the base station via Cell 1, for example, after switching to Cell 1 as the PCell. The RS of the candidate cell may be determined based on an RS index reported in an early CSI report (e.g., first early CSI report as shown in FIG. 45) before receiving the MAC CE indicating the PCell switching.

The TA indication may comprise a TA value which may be used by the wireless device to determine uplink sending (e.g., transmission) timing if communicating with the base station via Cell 1, for example, after switching to Cell 1 as the PCell. The TA value may be determined based on an early TA acquisition procedure as shown in FIG. 39.

Further, in examples of FIG. 47A, the one or more CSI reports and/or MG indications may comprise: a first cell configuration indication indicating a first candidate cell (e.g., Cell 2 from the plurality of candidate cells) for early CSI measurement/reporting if, for example, Cell 1 is switched to as the PCell, a first MG (e.g., MG1) associated with the first candidate cell; a second cell configuration indication indicating a second candidate cell (e.g., Cell 3), a second MG (e.g., MG2) associated with the second candidate cell.

At least some technologies may not allow the base station to indicate Cell 0 (which is the initial PCell before the initial LTM) as a candidate cell for early CSI measurement/reporting in the MAC CE, since the initial PCell does not have a cell configuration index associated with the initial PCell (Cell 0). Existing technologies may not allow the wireless device to switch back to the initial PCell (Cell 0).

The one or more CSI reports and/or MG indications may comprise a value 0 of a cell configuration indication indicating Cell 0 as one of the candidate cells and an MG associated with Cell 0 for early CSI measurement/reporting for Cell 0, for example, based on (e.g., if/when) the base station needing to indicate Cell 0 (which may be, for example, the initial PCell before the initial LTM) as a candidate cell for early CSI measurement/reporting in the MAC CE. If Cell 1 is switched to as the PCell, for example, after initial LTM procedure, one of the one or more CSI reports and/or MG indications in the MAC CE indicating the PCell switching from Cell 0 to Cell 1 may comprise a first cell configuration indication field being set to 0 indicating Cell 0, a first MG (e.g., MG 1) associated with Cell 0; a second cell configuration indication field being set to a first non-zero value indicating Cell 2, a second MG (or no MG) associated with Cell 2; a third cell configuration indication field being set to a second non-zero value indicating Cell 3, a third MG (e.g., MG 2) associated with Cell 3 (e.g., based on examples of FIG. 47A). Allowing the base station to configure/indicate the initial PCell as a candidate cell for early CSI measurement/reporting, for example, after performing initial/subsequent LTM procedure, may enable the wireless device to switch back to the initial PCell if, for example, the wireless device is moving back and towards the initial PCell. Reusing the cell configuration indication field of the MAC CE by setting its value to a predefined value (e.g., 0) may reduce signaling overhead for the indication.

Adaptively indicating a subset of a plurality of candidate cells for early CSI measurement/reporting and/or MGs associated with the subset of candidate cells may increase MAC CE payload. Per-cell configuring MG may also increase complexity of the wireless device in terms of adjusting the MG length for measuring different cells. FIG. 47A may be simplified as FIG. 47B to reduce complexity of the wireless device and also signaling overhead of the MAC CE.

In examples of FIG. 47B, the MAC CE indicating the PCell switching for the LTM may be simplified for CSI reporting and/or MG indication. Except the CSI report and/or MG indication, the rest of fields of the MAC CE may be the same as the corresponding fields of the MAC CE shown in FIG. 47A.

The CSI report and/or MG indication may not comprise candidate cell indication for early CSI measurement/reporting (e.g., the CSI report and/or MG indication may comprise other than candidate cell indication for early CSI measurement/reporting). The wireless device may measure all configured candidate cells (e.g., without down selection of candidate cells for CSI measurement), for example, based on (e.g., after or in response to) no candidate cell indication for early CSI measurement/reporting. The wireless device may measure all candidate cells (e.g., Cell 1, Cell 2, and Cell 3, if e.g., Cell 0 is the serving PCell) for early CSI reporting, for example, based on (e.g., if/when) Cell 0 being configured as a serving PCell and Cell 1, Cell 2, and Cell 3 being configured as candidate cells (e.g., for LTM procedure). After an initial/subsequent LTM procedure, the wireless device may measure all candidate cells (e.g., Cell 0, Cell 2, Cell 3, if, e.g., Cell 1 is the serving PCell) for early CSI reporting. After another LTM procedure, the wireless device may measure all candidate cells (e.g., Cell 0, Cell 1, Cell 3, if, e.g., Cell 2 is the serving PCell) for early CSI reporting, etc. Measuring all candidate cells, without and/or prior to receiving indication of down-selection of a subset of the candidate cells, may reduce signaling overhead for the down-selection indication (as shown in FIG. 47A), for example, if the one or more RRC message does not comprise a large number (e.g., greater than 8, or 16) of candidate cells.

The MAC CE may comprise a single MG value applicable for all candidate cells, for example, instead of indicating a per-candidate-cell MG value. The single MG value may be selected from a plurality of MG values, for example, configured in the one or more RRC messages. The single MG value may be indicated/selected to be long enough to make sure the wireless device is able to measure RSs of a candidate cell (or obtain valid CSI measurements/reports), of the candidate cells, which may be deployed farthest in frequency domain from the serving PCell. Taking FIG. 46 as an example, if Cell 2 is the serving PCell, a MAC CE indicating PCell switching from Cell 2 to Cell 3 for an initial/subsequent LTM procedure may comprise a single MG value which is big enough to not only allow the wireless device to measure RSs of Cell 1 and/or Cell 2 configured in F2, but also allow the wireless device to measure RSs of Cell 0 configured in F1 (wherein the frequency difference between F3 and F1 is bigger than the frequency different between F3 and F2, which may require longer MG for measuring Cell 0 than measuring Cell 1 or Cell 2). Examples may simplify signaling overhead of the base station and/or CSI measurement processing complexity of the wireless device.

In at least some technologies, the RSs (e.g., CSI-RSs/SSBs) for layer 1 CSI measurement/reporting may be configured in an RRC message (e.g., in ServingCellConfig IE as shown in FIG. 40) of a serving cell (e.g., based on examples described herein with respect to FIG. 40, FIG. 41, and/or FIG. 42). One or more of the RSs may be from the serving cell, or from a cell identified with a PCI different from the serving cell. If the wireless device supports subsequent LTM procedures (as shown in FIG. 44), the base station may send (e.g., transmit) RRC messages comprising a full configuration of the serving cell, a reference configuration and/or delta configurations of one or more candidate target cells, based on examples described herein with respect to FIG. 44. However, it is unclear where and how the wireless device obtains the configuration of the RSs (e.g., time/frequency domain resources, periodicity, power, etc.) when performing subsequent LTM procedure. There is a need to improve RS configuration/indication for supporting subsequent LTM procedure.

A base station may send (e.g., transmit) to a wireless device one or more RRC messages, of an LTM procedure (which may comprise an initial LTM procedure and/or a subsequent LTM procedure), comprising first configuration parameters of a serving (P)cell (e.g., an initial serving (P)cell), second configuration parameters of a reference cell and third configuration parameters of delta configuration of a candidate cell of a plurality of candidate (P)cells. The serving (P)cell may be referred to as the initial serving (P)cell, for example, if receiving the one or more RRC messages and before performing the initial/first LTM procedure. The first configuration parameters may be implemented in RRC reconfiguration messages as shown in FIG. 33. The second configuration parameters may be implemented in RRC reconfiguration messages, CellGroupConfig messages and/or ServingCellConfig messages, as shown in FIG. 33. The third configuration parameters may be implemented in CellGroupConfig messages as shown in FIG. 33.

The first configuration parameters may comprise one or more CSI resource/measurement configurations (e.g., based on examples described herein with respect to FIG. 40, FIG. 41, and/or FIG. 42). The wireless device may perform CSI measurement/reporting, for example, based on examples described herein with respect to FIG. 39. The one or more CSI resource configurations may indicate a plurality of RS (e.g., SSB/CSI-RS) resource sets. Each RS resource set of the plurality of RS resource sets may comprise a plurality of RSs for the CSI measurement/report, wherein one or more first RSs of the plurality of RSs are from the serving (P)cell and/or one or more second RSs of the plurality of RSs are from a non-serving (P)cell with a PCI different from a PCI of the serving (P)cell. The wireless device may use one or more of the plurality of RS resources sets to perform early CSI measurement/reporting if, for example, the wireless device is communicating with the base station via the serving (P)cell (e.g., the initial serving (P)cell) (e.g., based on examples described herein with respect to FIG. 39).

A plurality of RSs in an RS resource set may comprise a first RS (e.g., SSB/CSI-RS) associated with a first PCI (or a PCI index), a second RS associated with a second PCI (or a PCI index), etc. The second configuration parameters may comprise a plurality of PCI indexes, each PCI index being associated with a PCI value identifying a (P)cell (e.g., the initial serving (P)cell, a candidate (P)cell of the plurality of candidate (P)cells).

Different from the first configuration parameters of the serving (P)cell, a non-zero value of a PCI index of the plurality of PCI indexes in the second configuration parameters of the reference cell may indicate the serving (P)cell, while in in at least some technologies, a zero value of a PCI index of the plurality of PCI indexes in the first configuration parameters of the serving (P)cell is reserved for the serving (P)cell. The base station, by not using zero value for PCI index in the second configuration parameters of the reference cell and using non-zero value for PCI index indicating a cell of the serving (P)cell (e.g., the initial serving (P)cell) or the plurality of candidate (P)cells, may enable the wireless device correctly to identify the cell from which an RS for an early CSI measurement/report came, for example, if performing subsequent LTM procedure which involves dynamic changes of a serving cell (or PCell).

The second configuration parameters of the reference cell may comprise a plurality of CSI report configurations. Each CSI report configuration may be associated with a CSI report configuration ID and an RS resource set index of an RS resource set of the plurality of RS resource sets.

The base station may send (e.g., transmit) a DCI/MAC (e.g., the PCell switching DCI/MAC CE, or a DCI/MAC CE different from the PCell switching DCI/MAC CE) indicating/triggering a CSI report by comprising a CSI report configuration ID associated with the CSI report.

The wireless device, for example, upon (e.g., after and/or subsequent to) receiving the DCI/MAC CE, may perform early CSI measurement/report, for example, based on the RS resource set associated with the CSI report (e.g., based on examples described herein with respect to FIG. 39, FIG. 44, and/or FIG. 45).

The third configuration parameters of the delta configuration of the candidate cell may comprise one or more CSI resource configurations (e.g., based on examples described herein with respect to FIG. 40, FIG. 41, and/or FIG. 42) which may be applied/used, for example, if the wireless device switches to the candidate cell as the PCell, for example, after performing an LTM procedure (e.g., an initial and/or subsequent LTM procedure). The wireless device may perform CSI measurement/reporting, for example, based on examples described herein with respect to FIG. 39. The one or more CSI resource configurations may indicate a plurality of RS (e.g., SSB/CSI-RS) resource sets. Each RS resource set of the plurality of RS resource sets may comprise a plurality of RSs for the CSI measurement/report, wherein one or more first RSs of the plurality of RSs are from the serving (P)cell and/or one or more second RSs of the plurality of RSs are from a non-serving (P)cell with a PCI different from a PCI of the serving (P)cell. The wireless device may use one or more of the plurality of RS resources sets to perform early CSI measurement/reporting if, for example, the wireless device is communicating with the base station via the serving (P)cell (e.g., the initial serving (P)cell) (e.g., based on examples described herein with respect to FIG. 39).

The wireless device may use the one or more CSI resource configurations configured in the third configuration parameters of the delta configuration of the candidate cell by ignoring the one or more CSI resource configurations configured in the second configuration parameters of the reference cell, for example, if both the second configuration parameters and the third configuration parameters comprise CSI resource configurations. The wireless device may use the one or more CSI resource configurations configured in the second configuration parameters of the reference cell for early CSI measurement/reporting for LTM procedure, for example, if the second configuration parameters comprise CSI resource configurations and the third configuration parameters does not comprise CSI resource configurations (or the CSI resource configurations are absent in the third configuration parameters).

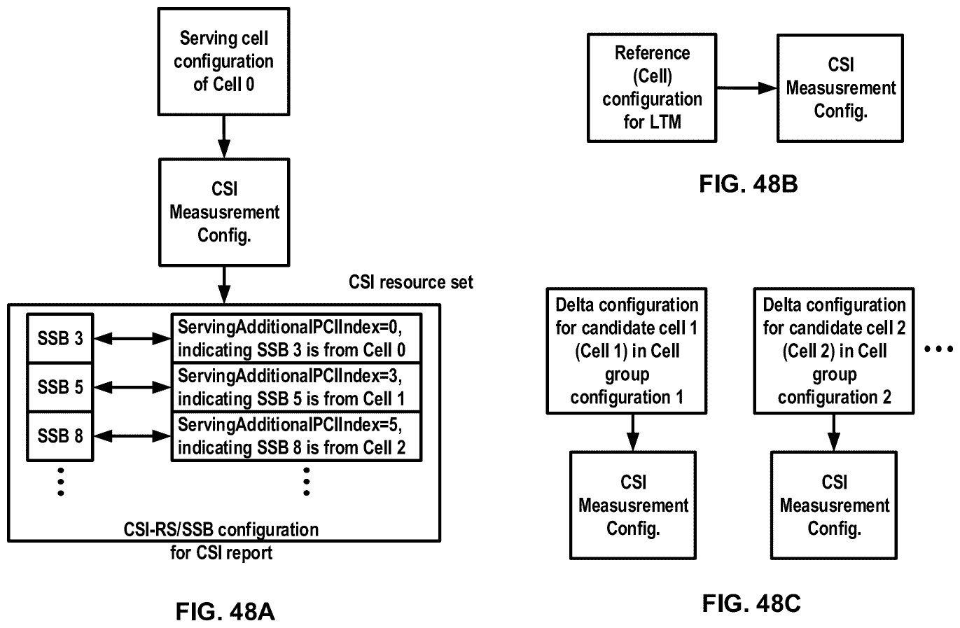

FIG. 48A, FIG. 48B, and FIG. 48C, show examples of CSI resource configurations for early CSI reporting. For example, FIG. 48A, FIG. 48B and FIG. 48C show examples of RS configuration for early CSI reporting for an LTM (e.g., an initial and/or subsequent LTM).

FIG. 48A shows an example of CSI resource configuration of a serving (P)cell. Referring to FIG. 48A, a base station may send (e.g., transmit) to a wireless device one or more RRC messages (e.g., RRC reconfiguration message as shown in FIG. 40, FIG. 41, and/or FIG. 42) comprising configuration parameters of a serving cell (e.g., Cell 0 in FIG. 48A). The configuration parameters of Cell 0 may indicate a CSI measurement configuration (e.g., based on examples described herein with respect to FIG. 40, FIG. 41, and/or FIG. 42).

The configuration parameters of Cell 0 may indicate a plurality of RSs (e.g., in a CSI resource set) for CSI measurement/reporting. The plurality of RSs may comprise a first RS (e.g., SSB 3), a second RS (e.g., SSB 5) and/or a third RS (e.g., SSB 8), etc. Each RS of the plurality of RSs may come from the same cell or from different cells. For example, referring to FIG. 48A, SSB 3 may be associated with a PCI index (e.g., ServingAddtionalPCIIndex) set to 0 indicating SSB 3 is from Cell 0. SSB 5 may be associated with PCI index value 3 indicating SSB 5 is from Cell 1. SSB 8 may be associated with PCI index value 5 indicating SSB 8 is from Cell 2, etc. The association between a PCI index and a PCI value identifying a cell (e.g., Cell 0, Cell 3, Cell 2 in the example of FIG. 48A) may be indicated in an SSB-MTC-AdditionalPCI IE, for example, based on examples described herein with respect to FIG. 41. The SSB-MTC-AdditionalPCI IE may comprise a list of PCI indexes (e.g., additionalPCIIndex). Each PCI index may be associated with a PCI value (e.g., PhysCellId) of a cell, a periodicity value (e.g., periodicity) of the SSBs, position indication (e.g., ssb-PositionslnBurst) of the SSBs, and/or a transmission power indication (e.g., ss-PBCH-BlockPower) of the SSBs, etc. Note that each PCI index of the list of PCI indexes may comprise a non-zero value equal to or greater than 1. The zero value of the PCI index may be reserved for Cell 0 in the CSI resource set of Cell 0. The wireless device may perform CSI measurement/reporting based on the CSI resource set if, for example, Cell 0 is the serving PCell (e.g., based on examples described herein with respect to FIG. 39).

The base station may configure CSI measurements/resources for early CSI reports in configuration parameters of a reference cell (or configuration), for example, to support subsequent LTM. Configuration parameters of the reference cell may be referred to as a full configuration of the reference cell. The wireless device may use the CSI measurement/report configured in the reference cell for early CSI measurement/reporting for example, if the wireless device is communicating with the base station with a PCell (which may have previously been a candidate cell before an LTM procedure) after completing the LTM procedure and switching to the PCell.

FIG. 48B shows an example of a CSI measurement/RS/report configuration of a reference cell/configuration for LTM procedure. A base station may send (e.g., transmit) to a wireless device one or more RRC messages (e.g., RRC reconfiguration message as shown in FIG. 33) comprising configuration parameters of a reference cell (e.g., a virtual cell, a serving/non-serving cell, etc.). The configuration parameters of the reference cell may indicate a CSI measurement configuration (e.g., based on examples described herein with respect to FIG. 40). The configuration parameters of the reference cell may be separate/independent from Cell 0 or any one of a candidate cell. The CSI measurement configuration may indicate a plurality of RS resource sets and a plurality of PCI indexes (e.g., non-zero values). Each PCI index of the plurality of PCI indexes may indicate a PCI value identifying a cell (either Cell 0 or one of the plurality of candidate cells). Each RS resource set may comprise one or more RS resources. Each RS resource may be associated with a PCI index. Different from FIG. 48A, an RS resource of the one or more RS resources configured for the reference cell may be associated with a non-zero PCI index value, of the plurality of PCI indexes, indicating one of Cell 0 and the plurality of candidate cells.

The base station may not configure CSI measurement/resource configuration in parameters of a delta configuration of a candidate cell, for example, based on (e.g., after or in response to) configuring the CSI measurement/resource configuration in the reference cell. The base station may trigger one or more of the CSI measurement/resource configurations of the reference cell in a DCI/MAC CE indicating to switch PCell to a candidate cell from Cell 0 (e.g., for initial LTM) or from another cell (e.g., for subsequent LTM).

The wireless device may use the delta configuration of the candidate cell and the full configuration of the reference cell as RRC configuration parameters of the candidate cell as the PCell, for example, if receiving the DCI/MAC indicating to switch the PCell to the candidate cell. After switching to the candidate cell as the PCell, the wireless device may use the one or more CSI measurement/resource configuration, for example, trigged by the DCI/MAC CE for early CSI measurement/reporting for a next/subsequent LTM procedure (e.g., based on examples described herein with respect to FIG. 44).

By using examples of FIG. 48B, a base station may configure parameters of CSI measurements/RSs/reports for early CSI reporting of an LTM procedure in an RRC configuration (e.g., a full RRC configuration) of a reference cell, for example, instead of configuring parameters of CSI measurements/RSs/reports in a delta RRC configuration for each candidate cell of a plurality of candidate cells, which may improve signal overhead for CSI configuration. The wireless device may use the parameters of CSI measurements/RSs/reports configured in the full RRC configuration of the reference cell for early CSI reporting, for example, if the wireless device performs LTM procedure(s) (e.g., initial and/or subsequent LTM procedures) among a plurality of candidate cells.

The examples of FIG. 48B may require the base station to configure a relatively large number (e.g., 16, 32, 64, 128, etc.) of RS resources or resource sets (e.g., which may comprise RS(s) of same or different candidate cell of the plurality of candidate cells) in the configuration parameters of the reference cell/configuration, for example, if the total number of the plurality of candidate cells are relatively large (e.g., more than 8). Further configuration over FIG. 48B may be implemented, for example, based on examples of FIG. 48C.

FIG. 48C shows an example of a CSI measurement/RS/report configuration of a candidate cell (e.g., Cell 1, Cell 2) for an LTM procedure. Referring to FIG. 48C, a base station may send (e.g., transmit) to a wireless device one or more RRC messages (e.g., CellGroupConfig IE as shown in FIG. 33) comprising configuration parameters of a candidate cell of a plurality of candidate cells. The configuration parameters of the candidate cell may be referred to, for example, as parameters of a delta configuration, compared to full configuration of a serving cell or a reference cell. A wireless device may obtain the full configuration of the candidate cell based on the delta configuration of the candidate cell and the full configuration of the reference cell, if, for example, the wireless device switches to the candidate cell as the PCell triggered by receiving a DCI/MAC CE indicating the switching for an LTM procedure. If a value of a configuration parameter is absent in the delta configuration of the candidate cell, the wireless device may refer to the same configuration parameter in the full configuration of the reference cell.

In examples of FIG. 48C, the configuration parameters of the candidate cell (e.g., Cell 1) may indicate a CSI measurement configuration (e.g., based on examples described herein with respect to FIG. 40). The CSI measurement configuration may indicate a plurality of RS resource sets and a plurality of PCI indexes (e.g., non-zero values). Each PCI index of the plurality of PCI indexes may indicate a PCI value identifying a cell (either Cell 0 or one of the plurality of candidate cells). Each RS resource set may comprise one or more RS resources. Each RS resource may be associated with a PCI index. An RS resource of the one or more RS resources configured for the candidate cell may be associated with a zero PCI index value, of the plurality of PCI indexes, indicating that the RS resource is from the candidate cell itself. Different from FIG. 48A, a zero value of PCI index may indicate that an RS resource is from the candidate cell (e.g., Cell 1), not the serving cell (e.g., the current serving cell) (e.g., Cell 0).

The wireless device may switch to a candidate cell (e.g., Cell 1 or Cell 2 in FIG. 48C) based on (e.g., after or in response to) receiving a DCI/MAC CE indicating the switching for an LTM procedure (e.g., based on examples described herein with respect to FIG. 45). The wireless device may use the CSI measurement configuration of the candidate cell, for example, for early CSI reporting for a next LTM procedure (e.g., based on examples described herein with respect to FIG. 44 and/or FIG. 45). By using examples of FIG. 48C, a base station may configure parameters of CSI measurements/RSs/reports for early CSI reporting of an LTM procedure in an RRC configuration (e.g., a delta RRC configuration) of a candidate cell, instead of configuring parameters of CSI measurements/RSs/reports in an RRC configuration (e.g., a full RRC configuration) for a reference cell, which may improve accuracy of RS resource configuration.

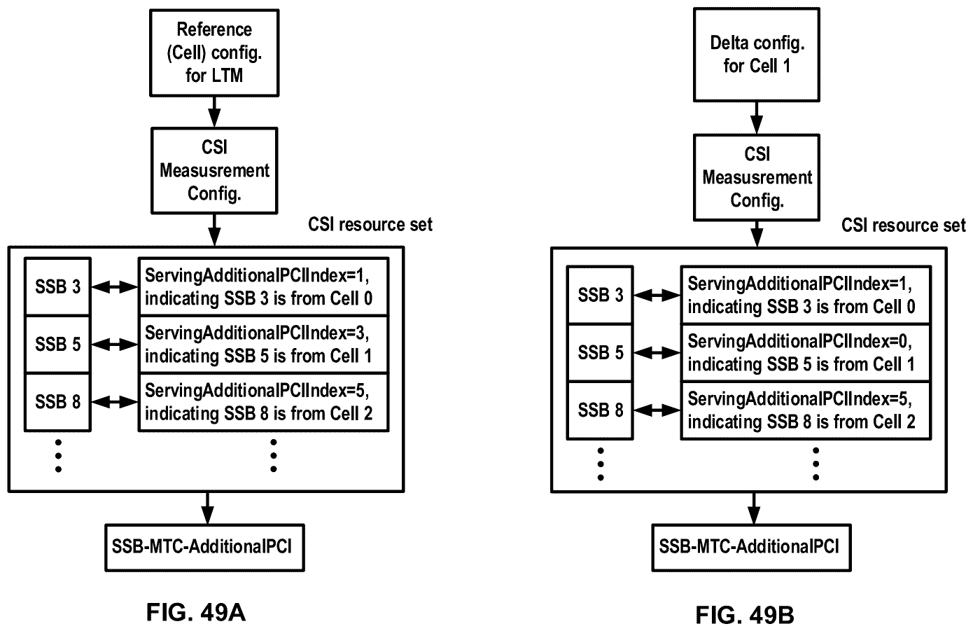

FIG. 49A shows an example of CSI resource configurations for early CSI reporting. For example, FIG. 49A shows an example of RS configuration for early CSI reporting for LTM based on, for example, examples of FIG. 48B. Referring to FIG. 49A, a base station may send (e.g., transmit) to a wireless device one or more RRC messages (e.g., RRC reconfiguration message as shown in FIG. 33) comprising configuration parameters of a reference cell (e.g., a virtual cell, a serving/non-serving cell, etc.). The configuration parameters of the reference cell may indicate a CSI measurement configuration (e.g., based on examples described herein with respect to FIG. 40). The configuration parameters of the reference cell may be separate/independent from Cell 0 (or any one of a candidate cell).

The CSI measurement configuration may indicate RS resource set, of a plurality of RS resource sets, comprising a plurality of RSs (e.g., SSB 3, SSB 5, SSB 8, etc.). Further, the configuration parameters of the reference cell may comprise a list of PCI indexes. Each PCI index (which may be, e.g., a 3-bit value or 4-bit value depending on the total number of candidate cells plus one) may be associated with a PCI value identifying a cell (e.g., either a current PCell or one of a plurality of candidate cells). A PCI index may be a non-zero value, for example, if configured for the reference cell. A PCI index value of 1 may be associate with a first PCI value (e.g., a 10-bit value) identifying Cell 0 (which is the current/serving PCell before performing LTM procedure comprising switching from Cell 0 to a candidate cell as the serving PCell). A PCI index value of 3 may be associated with a second PCI value identifying Cell 1. A PCI index value of 5 may be associated with a third PCI value identifying Cell 2. The association between a PCI index and a PCI value may be indicated in a PCI association message (e.g., SSB-MTC-AdditionalPC IE as shown in FIG. 41, or a new message).

The CSI measurement configuration may indicate, for each RS of the plurality of RSs in an RS resource set, a corresponding PCI index indicating that the RS is from a cell with a PCI value associated with the PCI index. For example, as shown in FIG. 49A, SSB 3 may be associated with a PCI index value 1 indicating that SSB 3 is from Cell 0. SSB 5 may be associated with a PCI index value 3 indicating that SSB 5 is from Cell 1. SSB 8 may be associated with a PCI index value 5 indicating that SSB 8 is from Cell 2, etc.

FIG. 49B, shows an example of a CSI resource configuration for early CSI reporting. For example, FIG. 49B shows an example of an RS configuration for early CSI reporting for LTM based on, for example, examples of FIG. 48C. Referring to FIG. 49B, a base station may send (e.g., transmit) to a wireless device one or more RRC messages (e.g., CellGroupConfig IE as shown in FIG. 33) comprising configuration parameters of a candidate cell (e.g., Cell 1) of a plurality of candidate cells. The configuration parameters of the candidate cell may be referred to as parameters of a delta configuration, compared to full configuration of a serving cell or a reference cell. A wireless device may obtain the full configuration of the candidate cell based on the delta configuration of the candidate cell and the full configuration of the reference cell, for example, if the wireless device switches to the candidate cell as the PCell triggered by receiving a DCI/MAC CE indicating the switching for an LTM procedure. The wireless device may refer to the same configuration parameter in the full configuration of the reference cell, for example, if a value of a configuration parameter is absent in the delta configuration of the candidate cell.

The configuration parameters of the candidate cell (e.g., Cell 1) may indicate a CSI measurement configuration (e.g., based on examples described herein with respect to FIG. 40). Additionally, the CSI measurement configuration may indicate an RS resource set, of a plurality of RS resource sets, comprising a plurality of RSs (e.g., SSB 3, SSB 5, SSB 8, etc.).

The configuration parameters of Cell 1 may comprise a list of PCI indexes. Each PCI index (which may comprise, e.g., a 3-bit value or 4-bit value depending on the total number of candidate cells plus one) may be associated with a PCI value identifying a cell (e.g., either a current PCell or one of a plurality of candidate cells). A PCI index value of 1 may be associate with a first PCI value (e.g., a 10-bit value) identifying Cell 0 (which may comprise the current/serving PCell before performing LTM procedure comprising switching from Cell 0 to a candidate cell as the serving PCell). A PCI index value of 0 may be reserved for the candidate cell (e.g., Cell 1 in the example of FIG. 49B). A PCI index value of 5 may be associated with a second PCI value identifying Cell 2. The association between a PCI index (except for value 0) and a PCI value may be indicated in a PCI association message (e.g., SSB-MTC-AdditionalPCI IE as shown in FIG. 41, or a new message).

The CSI measurement configuration may indicate, for each RS of the plurality of RSs in an RS resource set, a corresponding PCI index indicating that the RS is from a cell with a PCI value associated with the PCI index. For example, as shown in FIG. 49B, SSB 3 may be associated with a PCI index value of 1 indicating that SSB 3 is from Cell 0. SSB 5 may be associated with a PCI index value of 0 indicating that SSB 5 is from Cell 1. SSB 8 may be associated with a PCI index value of 5 indicating that SSB 8 is from Cell 2, etc.

The wireless device may switch to a candidate cell (e.g., Cell 1 in FIG. 49B) based on (e.g., after or in response to) receiving a DCI/MAC CE indicating the switching for an LTM procedure (e.g., based on examples described herein with respect to FIG. 45). The wireless device may use the CSI measurement configuration of the candidate cell, for example, for early CSI reporting for a next LTM procedure (e.g., based on examples described herein with respect to FIG. 44 and/or FIG. 45).

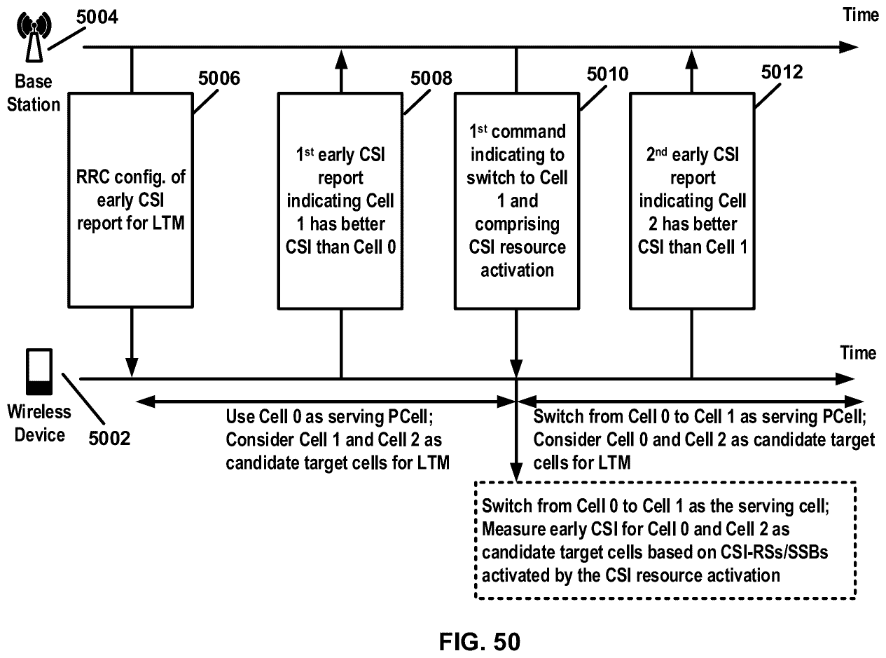

FIG. 50 shows an example of early CSI reporting for an LTM procedure. For example, FIG. 50 shows an example of RS indication for early CSI reporting for LTM, based on, for example, one or more examples of FIG. 48A, FIG. 48B, FIG. 48C, FIG. 49A, and/or FIG. 49B. Referring to FIG. 50, at step S006, a base station 5004 may send (e.g., transmit), and/or a wireless device 5002 may receive, one or more RRC messages comprising configuration parameters of a serving cell (e.g., Cell 0), configuration parameters of an early CSI report for a LTM procedure, and configuration parameters of a plurality of candidate cells (e.g., Cell 1, Cell 2, Cell 3, etc.). The configuration parameters of the serving cell may be implemented, for example, based on examples described herein with respect to FIG. 33. The configuration parameters (e.g., RS resource configurations, CSI report configurations etc.) of the early CSI report may be implemented, for example, based on one or more examples described herein with respect to FIG. 39, FIG. 48A, FIG. 48B, FIG. 48C, FIG. 49A, and/or FIG. 49B. The configuration parameters of the plurality of candidate cells may be implemented, for example, based on one or more examples described herein with respect to FIG. 39, FIG. 48A, FIG. 48B, FIG. 48C, FIG. 49A, and/or FIG. 49B.

The wireless device 5002 may communicate with the base station 5004, for example, via Cell 0 as the serving PCell and via one or more SCells, for example, based on the one or more RRC messages. The wireless device 5002 may perform early CSI measurement/reporting over RSs of the plurality of candidate cells (e.g., Cell 1, Cell 2, Cell 3, etc.). The early CSI measurement/reporting may be implemented, for example, based on examples described herein with respect to FIG. 39 and/or FIG. 45. The one or more RRC messages may indicate a plurality of CSI resource sets for early CSI reporting for an LTM procedure, in a reference cell or in a candidate cell, for example, based on examples described herein with respect to FIG. 48A, FIG. 48B, FIG. 48C, FIG. 49A, and/or FIG. 49B.

At step S008, the wireless device 5002 may send (e.g., transmit) a first early CSI report (e.g., 1^{st} early CSI report in FIG. 50) (e.g., triggered by a measurement event or by receiving a DCI/MAC comprising a CSI request as described herein with respect to FIG. 39 and/or FIG. 45) indicating Cell 1 has better CSI (e.g., L1-RSRP, L1-RSRQ, and/or SINR etc.) than Cell 0. The base station 5004 and the wireless device 5002 may perform an initial LTM procedure based on the first early CSI report (e.g., based on examples described herein with respect to FIG. 39 and/or FIG. 45).

At step S010, the base station 5004 may send (e.g., transmit), and/or the wireless device 5002 may receive a first command (e.g., 1^{st} command in FIG. 50) (e.g., a DCI/MAC CE, wherein the MAC CE may be implemented as the MAC CE triggering PCell switching to Cell 1 in FIG. 39 and/or FIG. 45) indicating to switch from Cell 0 to Cell 1 as the PCell and comprising one or more CSI resource indications (e.g., triggering indications and/or activation indications).

The one or more CSI resource indications may indicate one or more of the plurality of CSI resource sets configured for the reference cell or for the candidate cell (e.g., Cell 1) which may be used by the wireless device 5002 for early CSI measurement/reporting for example, if the wireless device 5002 switches to Cell 1 as the PCell, for example, based on receiving the first command indicating the PCell switching from Cell 0 to Cell 1. The one or more CSI resource indications may comprise one or more CSI resource set indexes. Each CSI resource set index may identify a corresponding CSI resource set of the plurality of CSI resource sets. Indicating a subset of the plurality of CSI resource sets configured for the reference cell or the candidate cell for early CSI reporting for example, if performing LTM procedure (e.g., initial and or subsequent LTM procedures), may enable the wireless device 5002 to reduce power consumption for CSI measurements for one or more candidate cells (which may be, e.g., non-serving cells). Otherwise, the wireless device 5002 may blindly measure all RS resource sets for the early CSI reporting which my increase power consumption of CSI measurement over a non-serving cell and/or increase interruption of communication with the base station 5004 on a serving cell.

The wireless device 5002 may switch the PCell from Cell 0 to Cell 1, for example, after receiving the first command. The wireless device 5002 may start to measure an early CSI report for a next potential LTM procedure (which may be referred to as a subsequent LTM procedure), for example, based on (e.g., after) switching to Cell 1 as the PCell. The wireless device 5002 may measure the early CSI report based on the one or more CSI resource set indicated by the first command. The early CSI measurement/report may be implemented, for example, based on examples described herein with respect to FIG. 39 and/or FIG. 45.

At step S012, the wireless device 5002 may send (e.g., transmit) a second early CSI report (e.g., 2^{nd} early CSI report in FIG. 50) (e.g., triggered by a measurement event or by receiving a DCI/MAC comprising a CSI request as described herein with respect to FIG. 39) indicating Cell 2 has better CSI (e.g., L1-RSRP, L1-RSRQ, and/or SINR etc.) than Cell 1. The base station 5004 and the wireless device 5002 may perform subsequent LTM procedure based on the second early CSI report (e.g., based on examples described herein with respect to FIG. 39, FIG. 44, and/or FIG. 45).

The wireless device 5002 may receive PCell switching commands together with CSI resource indication(s) for early CSI measurement/reporting, for example, based on examples of FIG. 50. The wireless device 5002 may use one or more CSI resource set(s) indicated by the CSI resource indication(s) for early CSI measurement. Examples described may allow the base station 5004 and/or the wireless device 5002 to adapt CSI resources (or CSI resource sets) for early CSI measurement/reporting if, for example, LTM procedures and/or subsequent LTM procedures are supported. Examples described may reduce power consumption of the wireless device 5002 (e.g., for CSI measurement/reporting) and/or reduce communication interruption (e.g., due to performing CSI measurement/reporting of a candidate cell inter-frequency deployed with the serving PCell) on the serving PCell.

A wireless device 5002 may receive RRC configurations of CSI resources (or sets) for early CSI reporting. Before receiving a DCI/MAC CE activating/selecting one or more CSI resources (or sets) from the CSI resources (or sets), the wireless device 5002 may not start to perform early CSI measurement/reporting for an LTM procedure. The wireless device 5002 may start to perform the early CSI measurement/report for the LTM procedure, for example, after receiving the DCI/MAC CE activating/selecting the one or more CSI resources (or sets) from the CSI resources (or sets). Not starting the early CSI measurement/report until receiving the DCI/MAC CE (e.g., starting the early CSI measurement/report after and/or based on receiving the DCI/MAC CE) may improve power consumption of the wireless device 5002.

The wireless device 5002 may receive RRC configuration of CSI resources (or sets) for early CSI reporting. Before receiving a DCI/MAC CE activating/selecting one or more CSI resources (or sets) from the CSI resources (or sets), the wireless device 5002 may perform early CSI measurement/reporting, for an LTM procedure, based on first/initial/default CSI resources (or sets) from the CSI resources (or sets).

The wireless device 5002 may determine the first/initial/default CSI resources for the early CSI report based on the first/initial/default CSI resources being indicated, for example, by the RRC messages, as the RS resources used in a time gap, for example, after receiving the RRC messages and before receiving the DCI/MAC CEs. The wireless device 5002 may determine the first/initial/default CSI resources of a CSI resource set, for the early CSI report, having the lowest CSI resource set index from the plurality of CSI resource sets. Allowing the wireless device 5002 to perform the early CSI measurement/report based on the first/initial/default CSI resource/set before receiving the DCI/MAC CE may improve HO latency.

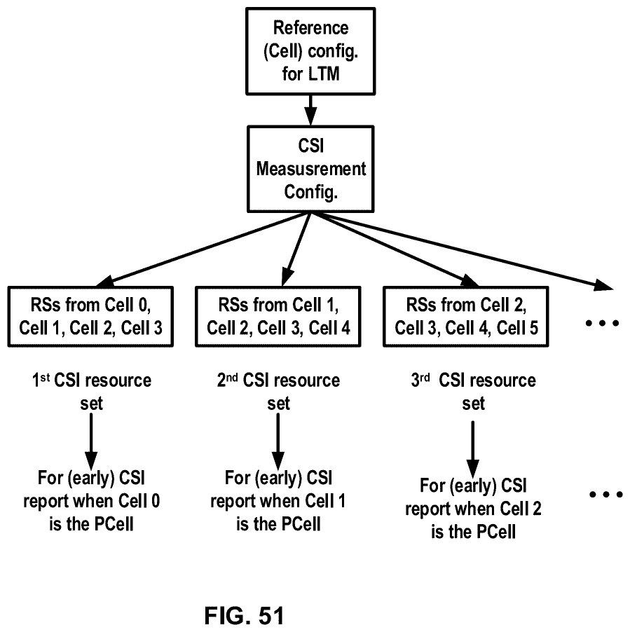

RRC messages configuring CSI resources and DCI/MAC CE indicating a subset of the CSI resources for early CSI measurement/reporting for an LTM procedure may increase signaling overhead and/or latency of CSI measurement/reporting. FIG. 51 shows an example CSI resource configuration for an LTM procedure. A CSI measurement configuration of a reference cell (e.g., based on examples described herein with respect to FIG. 48B and/or FIG. 49A) may indicate a plurality of CSI resource sets. Each CSI resource set may comprise a plurality of CSI resources (e.g., based on examples described herein with respect to FIG. 49A).

The CSI measurement configuration may indicate that one or more CSI resource sets of the plurality of CSI resource sets are associated with a cell of a plurality of candidate cells (and/or a serving cell). The wireless device may perform CSI measurement/reporting (e.g., early CSI measurement/reporting). The wireless device may perform CSI measurement/reporting (e.g., early CSI measurement/reporting), for example, based on the one or more CSI resource sets upon switching to the cell as the PCell. Switching to the cell as the PCell may be triggered by receiving a DCI/MAC CE indicating the PCell switching to the cell. The wireless device may perform CSI measurement/reporting (e.g., early CSI measurement/reporting), for example, based on (e.g., in response to and/or upon) the one or more CSI resource sets being associated with the cell. Upon switching to the cell as the Pcell, the wireless device may not perform CSI measurement/reporting (e.g., early CSI measurement/reporting) based on the second CSI resource set for example, if the second CSI resource set is not associated with the cell. Explicitly configuring/indicating one or more CSI resource sets for a candidate cell in configuration parameters of a reference cell may reduce signaling overhead for CSI resource configuration.

The base station may indicate one or more CSI resource sets for the candidate cell in the configuration parameters of the candidate cell (e.g., in a delta RRC configuration of the candidate cell), for example, instead of explicitly indicating one or more CSI resource sets for a candidate cell in the configuration parameters of the reference cell. The delta RRC configuration of the candidate cell may comprise one or more CSI resource set indexes identifying one or more CSI resource set of the plurality of CSI resource sets of the reference cell, wherein each CSI resource set of the plurality of CSI resource sets may be identified by a corresponding CSI resource set index. The base station may flexibly indicate a per-candidate-cell CSI resource configuration which may be selected from a plurality of CSI resource configurations configured in the reference cell. Examples described may improve accuracy of CSI resource configuration for a candidate cell.

Examples of FIG. 45 and FIG. 50 may be combined to further improve signaling efficiency and reduce power consumption of a wireless device for early CSI reporting for an LTM procedure. The PCell switching command (e.g., the first command in FIG. 45 and/or FIG. 50) may comprise not only CSI/MG indications but also CSI resource indications. The wireless device, for example, based on the CSI/MG indications and the CSI resource indications, may perform early CSI reporting for the LTM procedure (e.g., based on examples described herein with respect to FIG. 45 and/or FIG. 50). Instead of sending (e.g., transmitting) a second command, comprising the CSI/MG indications and/or the CSI resource indications, separately from the first command indicating the PCell switching, sending (e.g., transmitting) a single command comprising the PCell switching indication, the CSI/MG indications and/or the CSI resource indications may improve latency of LTM procedures.

FIG. 51 may be modified to be used for MG indication (e.g., together with CSI resource indication or without CSI resource indication) for a candidate cell (e.g., based on examples of FIG. 45). The CSI measurement configuration of a reference cell may comprise a plurality of MGs. One or more MGs of the plurality of MGs may be associated with a cell. The wireless device may perform CSI measurement/reporting (e.g., early CSI measurement/reporting). The wireless device may perform CSI measurement/reporting (e.g., early CSI measurement/reporting), for example, based on the one or more MGs upon switching to the cell as the PCell. Switching to the cell as the PCell may be triggered by receiving a DCI/MAC CE indicating the PCell switching to the cell. The wireless device may perform CSI measurement/reporting (e.g., early CSI measurement/reporting), for example, in response to the one or more MGs being associated with the cell. Upon switching to the cell as the PCell, the wireless device may not perform CSI measurement/reporting (e.g., early CSI measurement/reporting), for example, based on the second MG, for example, if the second MG is not associated with the cell. Explicitly configuring/indicating one or more MGs for a candidate cell in configuration parameters of a reference cell may reduce signaling overhead for MG configuration.

A wireless device may receive via a first cell as a PCell from a base station, a command indicating switching the PCell from the first cell to a second cell of a plurality of candidate cells, a layer 1 CSI MG, and a CSI resource set comprising a first CSI resource of the second cell and one or more second CSI resources of a third cell of the plurality of candidate cells (e.g., based on one or more examples described herein with respect to FIG. 45, FIG. 46, FIG. 47A, FIG. 47B, FIG. 48A, FIG. 48B, FIG. 48C, FIG. 49A, FIG. 49B, FIG. 50, and/or FIG. 51). The wireless device may switch from the first cell to the second cell as the PCell. The wireless device may send (e.g., transmit) a layer 1 CSI report based on the layer 1 MG and the CSI resource set. The command may comprise at least one of a DCI and/or a MAC CE. A CSI resource of the CSI resource set may comprise at least one of an SSB or a CSI-RS. The layer 1 CSI report may comprise at least one of an L1-RSRP value, an indication of an RS of the CSI resource set, and/or an indication of the third cell of the plurality of candidate cell, where the L1-RSRP is measured over the RS of the third cell. The wireless device may receive RRC messages comprising configuration parameters of a reference cell, wherein the reference cell is different from the first cell and/or the second cell.

The configuration parameters of the reference cell may indicate a plurality of CSI resource sets, wherein each CSI resource set of the plurality of CSI resource sets comprise at least one of a first CSI resource associated with a first physical cell identifier (PCI) index indicating the first cell, a second CSI resource associated with a second PCI index indicating the second cell, wherein the second PCI index is different from the first PCI index, and/or a third CSI resource associated with a third PCI index indicating the third cell, wherein the third PCI index is different from the first PCI index and the second PCI index. The configuration parameters may indicate, for each CSI resource of the plurality of CSI resources: frequency resources, a periodicity in time domain, and/or a transmission power, wherein the CSI resource comprises at least one of an SSB or CSI-RS.

The layer 1 MG may indicate a number of slots (or symbols) during which, for example, the wireless device may perform CSI measurements for the layer 1 CSI report on the third cell and may stop receiving downlink signals and sending (e.g., transmitting) uplink signals via the second cell. The wireless device may receive from the base station an indication of a plurality of layer MGs comprising the layer 1 MG, wherein, for each layer 1 MG, the indication indicates at least one of a time offset of the starting position of the layer 1 MG, a periodicity of the layer 1 MG, and/or a length of the layer 1 MG.

The time offset may indicate a number of symbols/slots between the starting slot of a radio frame and the starting position of the layer 1 MG. The time offset may indicate a number of symbols/slots between the last symbol of a second slot on which the command is received and the starting position of the layer 1 MG.

The layer 1 CSI report may comprise an indication of at least one of the first RSs of the third cell, for example, based on (e.g., in response to) the at least one of the third cells having better channel quality than the second cell, or at least one of second RSs of the second cell, for example, based on (e.g., in response to) none of the one or more candidate cells having better channel quality than the second cell.

The wireless device may switch to the second cell as the PCell for an LTM procedure, wherein the LTM procedure comprises at least one of: receiving a DCI indicating to send (e.g., transmit) a preamble via the second cell of the plurality of candidate cells, sending (e.g., transmitting) the preamble to the second cell, receiving a MAC CE indicating to switch from the first cell to the second cell as the serving cell, and/or switching to the second cell as the serving cell. The second cell may not be activated if the first cell is the serving cell before receiving the MAC CE indicating to switch from the first cell to the second cell.

The sending (e.g., transmission) of the layer 1 CSI report may be via at least one of a PUCCH and/or a PUSCH. The sending (e.g., transmission) of the layer 1 CSI report may comprise at least one of: an aperiodic CSI report, a semi-persistent CSI report via a PUSCH or a PUCCH, and/or a periodic CSI report.

A wireless device may receive from a base station one or more RRC messages, for an LTM procedure, comprising first configuration parameters of a reference cell and second configuration parameters of a candidate cell of a plurality of candidate cells. The first configuration parameters may indicate a plurality CSI resource sets. Each CSI resource set may comprise a plurality of CSI resources. Each CSI resource may be associated with at least one of the plurality of candidate cells. The wireless device may receive a command indicating switching the PCell from a first cell to a second cell of the plurality of candidate cells and a first CSI resource set of the plurality of CSI resource sets. The wireless device may switch from the first cell to the second cell as the PCell. The wireless device may communicate with the base station via the second cell based on the first configuration parameters and the second configuration parameters. The wireless device may perform CSI measurement over a first plurality of CSI resources of the first CSI resource set.

A wireless device may perform a method comprising multiple operations. The wireless device may receive one or more radio resource control (RRC) messages. The one or more RRC messages may be associated with Layer 1 or Layer 2 triggered mobility (LTM). The one or more RRC messages may comprise a plurality of serving cell configurations. Each serving cell configuration of the plurality of serving cell configurations may be associated with a corresponding candidate cell of a plurality of candidate cells. The one or more RRC messages may further comprise a reference signal (RS) configuration. The RS configuration may indicate synchronization signal blocks (SSBs), associated with the plurality of candidate cells, for layer 1 reference signal received power (L1-RSRP) measurement. The wireless device may send (e.g., transmit), based on L1-RSRP measurement of at least one SSB indicated in the RS configuration and for the LTM, an L1-RSRP report associated with a candidate cell corresponding to the at least one SSB. Transmitting the L1-RSRP report may comprise transmitting an aperiodic CSI report. The wireless device may switch, based on the L1-RSRP measurement, to the candidate cell as a primary cell. The RS configuration may comprise, for each SSB of the SSB's, an identifier of one or the candidate cells. The switching may comprise switching to the candidate cell based on a command indicating primary cell switching. The command may further comprise at least one of downlink control information (DCI), or a medium access control (MAC) control element (CE). The L1-RSRP report may comprise at least one of an L1-RSRP value, an indication of an SSB, of the SSB's, that is associated with the candidate cell, or an indication of the candidate cell, wherein the L1 RSRP measurement may comprise L1-RSRP measurement of the SSB. The SSBs may comprise at least one of a first SSB that may be associated with a first physical cell identifier (PCI) index indicating a serving cell, and a second SSB that may be associated with a second PCI index, different from the first PCI index, indicating the candidate cell. The RS configuration may indicate, for each SSB of the SSBs, at least one of frequency resources, a periodicity in a time domain, or a transmission power. Transmitting the L1-RSRP report may comprise transmitting a semi-persistent CSI report via a physical uplink share channel (PUSCH) or a physical uplink control channel (PUCCH). The RS configuration indicating the SSBs may be separate from the serving cell configurations corresponding to the candidate cells. A serving cell configuration of the serving cell configurations may correspond to the candidate cell. Additionally or alternatively, a serving cell configuration of the serving cell configurations may indicate, for the L1-RSRP report associated with the candidate cell, one or more of the SSBs of the RS configuration. A wireless device may comprise one or more processors and memory storing instructions that, when executed by the one or more processors, cause the wireless device to perform the described method, additional operations, and/or include additional elements. A system may comprise a wireless device configured to perform the described method, additional operations, and/or include additional elements; and a base station may be configured to send (e.g., transmit) the RRC message, and/or additional elements. A base station may, also or alternatively, be configured to receive the L1-RSRP report. A computer-readable medium may store instructions that, when executed, cause performance of the described method, additional operations, and/or include additional elements.

A wireless device may perform a method comprising multiple operations. The wireless device may receive one or more radio resource control (RRC) messages. The one or more RRC messages may comprise a reference signal (RS) configuration. The RS configuration may indicate a first synchronization signal block (SSB). The SSB may be associated with a first candidate cell of a plurality of candidate cells for layer 1 reference signal received power (L1-RSRP) measurement of the first candidate cell. The RS configuration may, also or alternatively, indicate a second SSB. The second SSB may be associated with a second candidate cell of the plurality of candidate cells. The second SSB may be for L1-RSRP measurement of the second candidate cell. The wireless device may send (e.g., transmit) an L1-RSRP report. The sending (e.g., transmitting) and/or L1-RSRP report may be associated with and/or for a for Layer 1 or Layer 2 triggered mobility (LTM). The sending (e.g., transmitting) and/or L1-RSRP report may be based on L1-RSRP measurement of the first SSB and based on L1-RSRP measurement of the second SSB. The wireless device may switch a primary cell from a serving cell to the first candidate cell of the second candidate cell. The switching may be based on the LTM. The one or more RRC messages may further comprise serving cell configurations corresponding to candidate cells. The serving cell configurations corresponding to candidate cells may be separate from the RS configuration. The RS configuration may comprise, for example, for each SSB of the SSBs, an identifier of one of the candidate cells. The first SSB may be associated with a first physical cell identifier (PCI) index. The first PCI index may indicate the first candidate cell. The second SSB may be associated with a second PCI index. The second PCI index may be different from the first PCI index. The second PCI index may indicate the second candidate cell. The RS configuration may indicate, for example, for each SSB of the SSBs, at least one of frequency resources, a periodicity in a time domain, or a transmission power. A wireless device may comprise one or more processors and memory storing instructions that, when executed by the one or more processors, cause the wireless device to perform the described method, additional operations, and/or include additional elements. A system may comprise a wireless device configured to perform the described method, additional operations, and/or include additional elements; and a base station may be configured to send (e.g., transmit) the one or more RRC message, and/or additional elements. Additionally or alternatively, a base station may be configured to receive the L1-RSRP report. A computer-readable medium may store instructions that, when executed, cause performance of the described method, additional operations, and/or include additional elements.

A wireless device may perform a method comprising multiple operations. The wireless device may receive one or more radio resource control (RRC) messages. The one or more RRC messages may comprise a plurality of serving cell configurations. The receiving and/or the RRC messages may be associated with Layer 1 or Layer 2 triggered mobility (LTM). Each serving cell configuration of the plurality of serving cell configurations may be associated with a corresponding candidate cell of a plurality of candidate cells. The wireless device may receive a reference signal (RS) configuration. The RS configuration may indicate synchronization blocks (SSBs). The RS configuration may be separate from and/or received separate from the serving cell configurations. The RS configurations and/or the receiving may be of the LTM. The RS configuration may be associated with a plurality of candidate cells. The RS configuration and/or the receiving may be for Layer 1 reference signal received power (L1-RSRP) measurements. The wireless device may send (e.g., transmit) and L1-RSRP report. The L1-RSRP report may be associated with a candidate cell. The candidate cell may correspond to the at least one SSB. The L1-RSRP report and/or the sending (e.g., transmitting) may be based on L1-RSRP measurement of at least one SSB. The L1-RSRP measurement may be indicated in the RS configuration. The L1-RSRP measurement and/or the sending (e.g., transmitting) may be for the LTM. The wireless device may switch a primary cell from a serving cell to the candidate cell. The switching may be based on the L1-RSRP measurement. The RS configuration may comprise, for each SSB of the SSBs, an identifier of one of the candidate cells. The L1-RSRP report may comprise at least one of an L1-RSRP value, and indication of an SSB, of the SSBs, that may be associated with the candidate cell, and an indication of the candidate cell. The L1-RSRP measurement may comprise the L1-RSRP measurement of the SSB. An SSB, of the SSBs, may be associated with a physical cell identifier (PCI) index. The PCI index may indicate the candidate cell. The wireless device may further receive an indication of switching the primary cell to the candidate cell. The candidate cell may not be activated prior to the receiving the indication of switching. A wireless device may comprise one or more processors and memory storing instructions that, when executed by the one or more processors, cause the wireless device to perform the described method, additional operations, and/or include additional elements. A system may comprise a wireless device configured to perform the described method, additional operations, and/or include additional elements; and a base station configured to send (e.g., transmit) the one or more RRC messages, and/or additional elements. For example, a base station may be configured to send (e.g., transmit) the RS configuration. Additionally or alternatively, a based station may be configured to receive the L1-RSRP report. Additionally or alternatively, a base station may be configured to send the indication of switching the primary cell to the candidate cell. A computer-readable medium may store instructions that, when executed, cause performance of the described method, additional operations, and/or include additional elements.

A wireless device may perform a method comprising multiple operations. The wireless device may receive one or more radio resource control (RRC) messages. The one or more RRC messages may be for a Layer 1 or Layer 2 triggered mobility (LTM) procedure. The one or more RRC messages may comprise serving cell configurations. Each serving cell configuration may correspond to a respective candidate cell of the candidate cells. The one or more RRC messages may further comprise reference signal (RS) configurations. The RS configurations may comprise RS configurations of synchronization blocks (SSBs) of layer 1 reference signal received power (L1-RSRP) measurements. The reference cell configurations may be applicable to the candidate cells. The wireless device may send (e.g., transmit) an L1-RSRP report. The sending (e.g., transmitting) and/or the L1-RSRP report may be based on measurement of first SSBs of the SSBs. The sending (e.g., transmitting) and/or the L1-RSRP report may be for the LTM procedure. The LTM procedure, the L1-RSRP report, and/or the first SSBs of the SSBs may be associated with a first candidate cell of the candidate cells. The wireless device may switch to the first candidate cell as a primary cell. The switching may be based on the LTM procedure. The RS configuration may comprise, for each SSB of the SSBs, an identifier of one of the candidate cells. The wireless device may switch to the first candidate cell as the primary cell based on receiving a command indicating a primary cell switching. The command may comprise at least one of a downlink control information (DCI) and a medium access control (MAC) control element (CE). The L1-RSRP report may comprise at least one of an L1-RSRP value, an indication of an SSB of the SSBs, and an indication of the first candidate cell, where the L1-RSRP is measured over the SSB of the first candidate cell. The SSBs may comprise at least one of a first SSB associated with a first physical cell identifier (PCI) index. The first PCI index may indicate a serving cell. The SSBs may further comprise a second SSB. The second SSB may be associated with a second PCI index. The second PCI index may indicate a first candidate cell. The second PCI index may be different from the first PCI index. The RS configuration may indicate, for each SSB of the SSBs, at least one of frequency resources, periodicity in time domain, and a transmission power. The LTM procedure may comprise receiving a DCI indicating to transmit a preamble via the first candidate cell of the plurality of candidate cells. Additionally or alternatively, the LTM procedure may comprise transmitting the preamble to the first candidate cell. Additionally or alternatively, the LTM procedure may comprise receiving a MAC CE indicating to switch to the first candidate cell as the primary cell. Additionally or alternatively, the LTM procedure may comprise switching to the first candidate cell as the primary cell. The first candidate cell may not be activated before receiving the MAC CE indicating to switch to the first candidate cell as the primary cell. The sending (e.g., transmission) of the L1-RSRP report may be via a physical uplink shared control channel (PUSCH). Additionally or alternatively, the sending (e.g., transmission) of the L1-RSRP report may be via a physical uplink control channel (PUCCH). The sending (e.g., transmission) of the L1-RSRP report may comprise an aperiodic CSI report. The sending (e.g., transmission) of the L1-RSRP report may comprise a semi-persistent CSI report via a PUSCH or a PUCCH. The transmission of the L1-RSRP report may comprise a periodic CSI report. The RS configuration for the L1-RSRP measurements of the LTM procedure may be separate from the serving cell configurations of the candidate cells of the LTM procedure. A first serving cell configuration of the serving cell configurations, for example, corresponding to the first candidate cell, may comprise one or more indications indicating one or more SSBs of the SSBs of the RS configuration, for the L1-RSRP report of the first candidate cell. The wireless device may transmit the L1-RSRP report of the first candidate cell via a serving cell. The serving cell may be different from the first candidate cell. A wireless device may comprise one or more processors and memory storing instructions that, when executed by the one or more processors, cause the wireless device to perform the described method, additional operations, and/or include additional elements. A system may comprise a wireless device configured to perform the described method, additional operations, and/or include additional elements; and a base station configured to send (e.g., transmit) the one or more RRC messages, and/or additional elements. For example, a base station may receive the L1-RSRP report. A computer-readable medium may store instructions that, when executed, cause performance of the described method, additional operations, and/or include additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, 6G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, 6G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, one or more radio resource control (RRC) messages, associated with Layer 1 or Layer 2 triggered mobility (LTM), comprising:
a plurality of serving cell configurations, wherein each serving cell configuration of the plurality of serving cell configurations is associated with a corresponding candidate cell of a plurality of candidate cells; and
a reference signal (RS) configuration indicating synchronization signal blocks (SSBs), associated with the plurality of candidate cells, for layer 1 reference signal received power (L1-RSRP) measurement;
transmitting, based on L1-RSRP measurement of at least one SSB indicated in the RS configuration and for the LTM, an L1-RSRP report associated with a candidate cell corresponding to the at least one SSB; and
switching, based on the L1-RSRP measurement, to the candidate cell as a primary cell.

2. The method of claim 1, wherein the RS configuration comprises, for each SSB of the SSBs, an identifier of one of the candidate cells.

3. The method of claim 1, wherein the switching comprises switching to the candidate cell based on a command indicating primary cell switching and comprising at least one of:
downlink control information (DCI); or
a medium access control (MAC) control element (CE).

4. The method of claim 1, wherein the L1-RSRP report comprises at least one of:
an L1-RSRP value;
an indication of an SSB, of the SSBs, that is associated with the candidate cell; or
an indication of the candidate cell, wherein the L1-RSRP measurement comprises L1-RSRP measurement of the SSB.

5. The method of claim 1, wherein the SSBs comprise at least one of:
a first SSB associated with a first physical cell identifier (PCI) index indicating a serving cell; and
a second SSB associated with a second PCI index, different from the first PCI index, indicating the candidate cell.

6. The method of claim 1, wherein the RS configuration indicates, for each SSB of the SSBs, at least one of:
frequency resources;
a periodicity in a time domain; or
a transmission power.

7. The method of claim 1, wherein the transmitting the L1-RSRP report comprises transmitting an aperiodic CSI report.

8. The method of claim 1, wherein the transmitting the L1-RSRP report comprises transmitting a semi-persistent CSI report via a physical uplink shared channel (PUSCH) or a physical uplink control channel (PUCCH).

9. The method of claim 1, wherein the RS configuration indicating the SSBs is separate from the serving cell configurations corresponding to the candidate cells.

10. The method of claim 1, wherein a serving cell configuration of the serving cell configurations corresponds to the candidate cell and indicates, for the L1-RSRP report associated with the candidate cell, one or more of the SSBs of the RS configuration.

11. A method comprising:
receiving, by a wireless device, one or more radio resource control (RRC) messages comprising a reference signal (RS) configuration indicating:
a first synchronization signal block (SSB), associated with a first candidate cell of a plurality of candidate cells, for layer 1 reference signal received power (L1-RSRP) measurement of the first candidate cell;
a second SSB, associated with a second candidate cell of the plurality of candidate cells, for L1-RSRP measurement of the second candidate cell;
transmitting, based on L1-RSRP measurement of the first SSB and based on L1-RSRP measurement of the second SSB, an L1-RSRP report associated with Layer 1 or Layer 2 triggered mobility (LTM) and; and
switching, based on the LTM, a primary cell from a serving cell to the first candidate cell or the second candidate cell.

12. The method of claim 11, wherein the one or more RRC messages further comprise, separate from the RS configuration, serving cell configurations corresponding to candidate cells.

13. The method of claim 11, wherein the RS configuration comprises, for each SSB of the SSBs, an identifier of one of the candidate cells.

14. The method of claim 11, wherein:
the first SSB is associated with a first physical cell identifier (PCI) index indicating the first candidate cell; and
the second SSB is associated with a second PCI index, different from the first PCI index, indicating the second candidate cell.

15. The method of claim 11, wherein the RS configuration indicates, for each SSB of the SSBs, at least one of:
frequency resources;
a periodicity in a time domain; or
a transmission power.

16. A method comprising:
receiving, by a wireless device, one or more radio resource control (RRC) messages, associated with Layer 1 or Layer 2 triggered mobility (LTM) comprising a plurality of serving cell configurations, where each serving cell configuration of the plurality of serving cell configurations is associated with a corresponding candidate cell of a plurality of candidate cells;
receiving, separate from the serving cell configurations and for the LTM, a reference signal (RS) configuration indicating synchronization signal blocks (SSBs), associated with the plurality of candidate cells, for Layer 1 reference signal received power (L1-RSRP) measurements;
transmitting, based on L1-RSRP measurement of at least one SSB indicated in the RS configuration and for the LTM, an L1-RSRP report associated with a candidate cell corresponding to the at least one SSB; and
switching, based on the L1-RSRP measurement, a primary cell from a serving cell to the candidate cell.

17. The method of claim 16, wherein the RS configuration comprises, for each SSB of the SSBs, an identifier of one of the candidate cells.

18. The method of claim 16, wherein the L1-RSRP report comprises at least one of:
an L1-RSRP value;
an indication of an SSB, of the SSBs, that is associated with the candidate cell; and
an indication of the candidate cell, wherein the L1-RSRP measurement comprises L1-RSRP measurement of the SSB.

19. The method of claim 16, wherein an SSB, of the SSBs, is associated with a physical cell identifier (PCI) index indicating the candidate cell.

20. The method of claim 16, further comprising receiving an indication of switching the primary cell to the candidate cell, wherein the candidate cell is not activated prior to the receiving the indication.
